(19) United States
(12) Patent Application Publication
(10) Pub. No.: US 2013/0072598 A1
(43) Pub. Date: Mar. 21, 2013

(54) Thermoplastics from Distillers Dried Grains and Feathers

(71) Applicants: Yiqi Yang, Lincoln, NE (US); Narendra Reddy, Lincoln, NE (US); Chunyan Hu, Lincoln, NE (US); Jin Enqi, Lincoln, NE (US)

(72) Inventors: Yiqi Yang, Lincoln, NE (US); Narendra Reddy, Lincoln, NE (US); Chunyan Hu, Lincoln, NE (US); Jin Enqi, Lincoln, NE (US)

(73) Assignee: Board of Regents of the University of Nebraska, Lincoln, NE (US)

(21) Appl. No.: 13/423,983

(22) Filed: Mar. 19, 2012

Related U.S. Application Data
(60) Provisional application No. 61/454,230, filed on Mar. 18, 2011.

(51) Int. Cl. C08H 1/06; C08L 89/04; C08H 1/00

(52) U.S. Cl. 524/10; 527/101; 527/207; 527/102; 527/201; 525/54.1; 524/17

(57) ABSTRACT

A thermoplastic biobased material-containing composition comprising chemically-modified feathers and/or dried distillers grains and a process for forming the thermoplastic biobased material-containing composition. More specifically, the thermoplastic biobased material-containing composition comprises one or more of the following chemically-modified biobased materials: (a) acylated biobased material having a % Acyl Content that is at least 3% and a % Weight Gain that is at least 1%, and; (b) etherified biobased material having a % Weight Gain that is at least 2%; and (c) graft polymerized biobased material having a % Monomer Conversion that is at least 40%, a % Grafting Efficiency that is at least 30%, and a % Grafting that is at least 10%.

### CROSS-REFERENCE TO RELATED APPLICATIONS

The present application is a non-provisional application claiming the benefit of U.S. Provisional Application No. 61/454,230, filed Mar. 18, 2011, which is incorporated herein by reference in its entirety.

### BACKGROUND OF INVENTION

More than 4 billion pounds of poultry feathers are generated in the United States every year and most of that is disposed in landfills. The disposal of feathers is costly and is a loss of a potentially valuable raw material (feathers are more than 90% keratin). In view of the disposal concerns, technologies have been developed to clean poultry feathers and separate them as feather fibers (barbs) and quills on a commercial scale as a raw material for various applications. For example, feathers (feather fibers and/or quill) have been used as reinforcement for composites with natural and or synthetic matrix materials. Additionally, keratin has been extracted from feathers and used for various applications. For example, extracted feather keratin has been graft polymerized using 2-hydroxyethyl methacrylate and used as part of fertilizer compositions.

In recent years, there have been efforts to expand the industrial application of feathers involving performing physical and/or chemical modifications to turn feathers into thermoplastics. Thermoplastics have many advantages, such as being recyclable and easy to be molded into various forms. Some studies employed blending relatively large amounts of plasticizer with feathers to develop thermoplastics but such large amounts of plasticizer tended to significantly decrease the tensile properties (e.g., tensile strength and elastic modulus, and breaking elongation) to undesirable levels.

Distillers dried grains with solubles (DDGS) are the major co-product of corn ethanol production. Specifically, about 30% DDGS are generated as co-product when corn is processed for ethanol. Currently, more than 10 million tons of DDGS are generated every year in the USA with a selling price of approximately $150 per ton. Therefore, DDGS is a co-product that is available in large quantities at low price. It is believed that much more value could be realized for DDGS if they were significantly used in industrial products such as thermoplastics. For example, the current selling price of DDGS is much lower compared to common thermoplastic synthetic polymers such as high density polyethylene, polypropylene and polystyrene, which sell at about $1,400, $1,500 and $2,100 per ton, respectively. Further, biopolymers such as starch acetate, cellulose acetate, and poly (lactic acid) are considerably more expensive at about $4,800 per ton. Advantageously, DDGS is derived from a renewable resource, inevitably generated as a co-product without the need for additional land, energy, or other resources, thermoplastic products made from DDGS may be made biodegradable, and the increased value from industrial product usage will help to reduce the cost of ethanol.

Attempts have been made to develop composites and other industrial products from DDGS. For example, has been used as reinforcement in composites by mixing DDGS with phenolic resin and wood glue. Additionally, plastic fiber composites were prepared by extruding DDGS with polypropylene but the composites were reported to have inferior mechanical properties compared to other fibrous materials mainly because of the hydrophylicity of DDGS and difficulties in obtaining uniform grinding and mixing of DDGS.

There have also been efforts to develop biodegradable thermoplastics from biopolymers such as starch, cellulose, and plant proteins but they have met with limited success mainly due to the poor properties and high cost of the products developed. Biothermoplastics developed from natural polymers tend to have low elongations and are considerably brittle, which limits variety of products in which they may be used. As with feathers, plasticizers have been used to increase the flexibility but at the necessary levels they also tend to considerably decrease other mechanical properties (e.g., tensile strength).

Notwithstanding, the previously known uses for feathers and dried distillers grains, a need still exists for other, preferably higher value and higher volume, applications of said materials. In particular, it would be beneficial if one could obtain higher tensile properties for thermoplastic polymers made from feather and/or dried distillers grains, especially a higher elastic modulus, as well as making such thermoplastics using less or even no plasticizer.

### SUMMARY OF INVENTION

The present invention is directed to a thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials: (a) acylated biobased material comprising acyl groups (—OCR1) where R1 is an alkyl and having a % Acyl Content that is at least 3% and a % Weight Gain that is at least 1%, and; (b) etherified biobased material comprising —R2Q groups where R2 is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and (c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

The present invention is also directed to a thermoplastic composition comprising a thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials: (a) acylated biobased material comprising acyl groups (—OCR1) where R1 is an alkyl and having a % Acyl Content that is at least 3% and a % Weight Gain that is at least 1%, and; (b) etherified biobased material comprising —R2Q groups where R2 is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and (c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

Further, the present invention is directed to an article comprising a thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials: (a) acylated biobased material comprising acyl groups (—OCR1) where R1 is an alkyl and having a % Acyl Content that is at least 3% and a % Weight Gain that is at least 1%, and; (b) etherified biobased material comprising —R2Q groups where R2 is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and (c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

Still further, the present invention is directed to a process for chemically modifying a biobased material to impart thermoplasticity to, or modify one or more thermoplastic properties of the biobased material, wherein the biobased material is selected from the group consisting of feathers, portions thereof, dried distillers grains, constituents thereof, previously chemically-modified versions of the foregoing, and combinations thereof, the process comprising performing one or more of the following chemical modifications to the biobased material: (a) acylation of the biobased material by a process comprising reacting the biobased material with an acylating agent until the acylated biobased material has a % Acyl Content that is at least 3% and a % Weight Gain that is at least 1%, wherein the acylating agent is selected from the group consisting of one or more aliphatic acid anhydrides, one or more aromatic acid anhydrides, and combinations thereof; (b) etherification of the biobased material by a process comprising a nucleophillic addition reaction in which the biobased material is reacted with an etherifying agent until the etherified biobased material has a % Weight Gain that is at least 2%, wherein the etherifying agent is one or more saturated molecules having an electron withdrawing group selected from the group consisting of a nitro group, a quaternary amine group, a trihalide group, a cyano group, a sulfonate group, a carboxylic acid group, an ester group, an aldehyde group, and a ketone group; and (c) graft polymerization of the biobased material via free radical polymerization of a monomer so that the graft polymerized biobased material has % Monomer Conversion that is at least 10%, a % Grafting Efficiency that is at least 10%, and a % Grafting that is at least 10%, wherein the monomer comprises a functional group selected from the group consisting of an alkenyl, an alkynyl, an aryl, or combinations thereof.

### BRIEF DESCRIPTION OF THE DRAWINGS

FIG. 1 is a graph showing the effects of catalyst to chicken feather ratio (% w/w) on the % acetyl content and percent weight gain of acetylated chicken feathers. The acetylation was carried out at 70° C. for 60 minutes with acetic anhydride to chicken feather ratio of 3:1. Data points with same alphabets indicate that they are not statistically different from each other.

FIG. 2 is a graph showing the effects of reaction time on acetyl content (%) and percent weight gain of the acetylated chicken feathers. The acetylation was carried out at a temperature of 70° C., acetic anhydride to chicken feather ratio of 3:1 and catalyst concentration of 10%. Data points with same alphabets indicate that they are not statistically different from each other.

FIG. 3 is a graph showing the effect of reaction temperature on % acetyl content and percent weight gain of acetylated chicken feathers. The acetylation was carried out for 60 minutes with acetic anhydride to chicken ratio of 3:1 and catalyst concentration of 10%. Data points with same alphabets indicate that they are not statistically different from each other.

FIG. 4 is a graph showing the effect of weight ratio of acetic anhydride to chicken feather on the % acetyl content and percent weight gain of acetylated chicken feathers. The acetylation was carried out at 70° C. for 60 minutes with catalyst concentration of 10%. Data points with same alphabets indicate that they are not statistically different from each other.

FIG. 5 is a pyrolysis-gas chromatography-mass spectra of the unmodified and acetylated feathers.

FIG. 6 is infrared spectrums of unmodified and acetylated chicken feathers.

FIG. 7 is a graph comparing the thermogravimetric curves for unmodified and acetylated chicken feathers.

FIG. 8 is DTG curves of unmodified and acetylated feathers.

FIG. 9 is DSC curves of unmodified and acetylated chicken feathers.

FIG. 10 is a graph showing the effect of reaction time on acetyl content (%) of the soluble and total product. The acetylation was carried out at a temperature of 90° C., acetic anhydride to oil-and-zein-free DDGS ratio of 3:1 and catalyst concentration of 5%. Data points with same alphabets indicate that they are not statistically different from each other.

FIG. 11 is a graph showing the effects of reaction time on weight percentage (%) and relative viscosity of soluble product obtained after acetylation. The acetylation was carried out at a temperature of 90° C., acetic anhydride to oil-and-zein-free DDGS ratio of 3:1 and catalyst concentration of 5%. Data points with same alphabets indicate that they are not statistically different from each other

FIG. 12 is a graph showing the effect of reaction temperature on % acetyl content. The acetylation was carried out for 30 minutes with acetic anhydride to oil-and-zein-free DDGS ratio of 3:1 and catalyst concentration of 5%. Data points with same alphabets indicate that they are not statistically different from each other.

FIG. 13 is a graph showing the effects of reaction temperature on weight percentage (%) and relative viscosity of soluble product obtained after acetylation. The acetylation was carried out for 30 minutes with acetic anhydride to oil-and-zein-free DDGS ratio of 3:1 and catalyst concentration of 5%. Data points with same alphabets indicate that they are not statistically different from each other

FIG. 14 is a graph showing the effect of concentration of catalyst (% of oil-and-zein-free DDGS) on the % acetyl content. The acetylation was carried out at 90° C. for 30 minutes with acetic anhydride to oil-and-zein-free DDGS ratio of 3:1. Data points with same alphabets indicate that they are not statistically different from each other.

FIG. 15 is a graph showing the effects of concentration of catalyst (% of oil-and-zein-free DDGS) on weight percentage (%) and relative viscosity of the soluble product obtained after acetylation. The acetylation was performed at 90° C. for 30 minutes with acetic anhydride to oil-and-zein-free DDGS ratio of 3:1. Data points with same alphabets indicate that they are not statistically different from each other.

FIG. 16 is a graph showing the effect of weight ratio of acetic anhydride to oil-and-zein-free DDGS on the % acetyl content. The acetylation was carried out at 90° C. for 30 minutes with catalyst concentration of 10%. Data points with same alphabets indicate that they are not statistically different from each other.

FIG. 17 is a 1HNMR (DMSO-d6) spectra of soluble product of acetylated DDGS.

FIG. 18 is an infrared spectrum of unmodified DDGS (A), total (B) and soluble (C) product.

FIG. 19 is a graph comparing the thermogravimetric curves for unmodified DDGS (control) and total and soluble product.

FIG. 20 is DSC curves of unmodified DDGS and the total and soluble product.

FIG. 21 is a graph showing the effect of catalyst to DDGS ratio (% w/w) on the % acetyl content. The acetylation was carried out at 90° C. for 60 minutes with acetic anhydride to oil-and-zein-free DDGS ratio of 3:1. Data points with same alphabets indicate that they are not statistically different from each other.

FIG. 22 is a graph showing the effect of reaction temperature on % acetyl content and intrinsic viscosity of DDGS acetates. The acetylation was carried out for 60 minutes with acetic anhydride to oil-and-zein-free DDGS ratio of 3:1 and catalyst concentration of 30%. Data points with same alphabets indicate that they are not statistically different from each other.

FIG. 23 is a graph showing the effect of reaction time on acetyl content (%) of the DDGS acetates. The acetylation was carried out at a temperature of 120° C., acetic anhydride to oil-and-zein-free DDGS ratio of 3:1 and catalyst concentration of 30%. Data points with same alphabets indicate that they are not statistically different from each other.

FIG. 24 is a graph showing the effect of weight ratio of acetic anhydride to oil-and-zein-free DDGS on the % acetyl content. The acetylation was carried out at 120° C. for 60 minutes with catalyst concentration of 30%. Data points with same alphabets indicate that they are not statistically different from each other.

FIG. 25 is 1H-NMR (DMSO-d6) spectra of DDGS acetates obtained using alkaline and acidic catalysts.

FIG. 26 is infrared spectrums of unmodified DDGS (control) and DDGS acetates obtained using alkaline and acidic catalysts.

FIG. 27 is a graph comparing the thermogravimetric curves for unmodified and acetylated DDGS.

FIG. 28 is DSC curves of unmodified and acid and alkali catalyzed DDGS.

FIG. 29 is a graph comparing the intrinsic viscosity and acetyl content at various alkali and acidic catalysis conditions. Curve A shows the effect of catalyst (sulfuric acid) at acetic anhydride to DDGS ratio of 2:1, reaction temperature of 90° C. and 30 minutes, curve B shows the effect of ratio of acetic anhydride using 10% catalyst and reaction temperature of 90° C. and reaction time of 30 minutes, and Curve C shows the effect of ratio of anhydride to DDGS under alkaline catalysts (30%), reaction temperature of 120° C. and reaction time of 60 minutes.

FIG. 30 is a graph showing the effect of catalyst concentration on percent weight gain of cyanoethylated chicken feathers. The cyanoethylation was carried out at 40° C. for 120 minutes with acrylonitrile to chicken feather ratio of 8:1. Data points with the same alphabets indicate that they were not significantly different from each other.

FIG. 31 is infrared spectrums of unmodified and cyanoethylated chicken feathers.

FIG. 32 is 1H NMR spectrum of the unmodified and cyanoethylated chicken feather.

FIG. 33 is pyrolysis GC-MS spectra shows the signal due to the pyrolysis of the cyano group on the modified feathers confirming cyanoethylation of the feathers.

FIG. 34 is a graph comparing the thermogravimetric curves for unmodified and cyanoethylated chicken feathers.

FIG. 35 is DSC curves of unmodified and cyanoethylated chicken feathers.

FIG. 36 is a graph showing the effect reaction time on percent weight gain of product obtained after cyanoethylation. The cyanoethylation was carried out at a temperature of 40° C., acrylonitrile DDGS ratio of 5:1 and sodium hydroxide concentration of 10%. Data points with same letters indicate that they were not statistically different from each other.

FIG. 37 is a graph showing the effect of reaction temperature on percent weight gain of cyanoethylated DDGS. The cyanoethylation was carried out for 120 minutes with acrylonitrile to DDGS ratio of 5:1 and sodium hydroxide concentration of 10%. Data points with same letters indicate that they were not statistically different from each other.

FIG. 38 is a graph showing the effect of concentration of sodium hydroxide on percent weight gain of DDGS obtained after cyanoethylation. The cyanoethylation was carried out at 40° C. for 120 minutes with acrylonitrile to oil-and-zein-free DDGS ratio of 5:1. Data points with same letters indicate that they were not statistically different from each other.

FIG. 39 is a graph showing the effect of weight ratio of acrylonitrile to DDGS on the percent weight gain. The cyanoethylation was carried out at 40° C. for 120 minutes with sodium hydroxide concentration of 15%. Data points with same letters indicate that they were not statistically different from each other.

FIG. 40 is infrared spectrum of unmodified DDGS and cyanoethylated DDGS with 42% Weight Gain.

FIG. 41 is 1H-NMR spectrum of the cyanoethylated DDGS.

FIG. 42 is a graph comparing the thermogravimetric curves for unmodified DDGS and cyanoethylated oil-and-zein-free DDGS with 42% Weight Gain.

FIG. 43 is a DSC thermogram of unmodified and cyanoethylated DDGS with a weight gain of 42%

FIG. 44 is reacting scheme showing graft polymerization of feather keratin with vinyl monomer through NaHSO3/K2S2O8 redox system.

FIG. 45 is a graph showing the effect of molar ratio of NaHSO3/K2S2O8 on grafting parameters.

FIG. 46 is a graph showing the effects of initiation concentration on grafting parameters.

FIG. 47 is a graph showing the effects of pH on grafting parameters.

FIG. 48 is a graph showing the effects of polymerization temperature on grafting parameters.

FIG. 49 is a graph showing the effects of polymerization time on grafting parameters.

FIG. 50 is a graph showing the effects of monomer concentration on grafting parameters.

FIG. 51 is FTIR spectra of unmodified feather (a) and feather-g-PMA (b) and 1H-NMR spectra of unmodified feather (c) and feather-g-PMA (d). The monomer concentration was 40% and the % Grafting was 35%.

FIG. 52 is TGA and DTG thermograms of unmodified feathers.

FIG. 53 is TGA and DTG thermograms of grafted feather without homopolymers.

FIG. 54 is TGA and DTG thermograms of grafted feather with homopolymers.

FIG. 55 is DSC spectra of unmodified feather and grafted feather without homopolymers.

### DETAILED DESCRIPTION OF INVENTION

### Introduction

It has been discovered that a thermoplastic biobased material-containing composition may be formed from feathers, portions of feathers, dried distillers grains, constituents of dried distillers grains, previously chemically-modified versions of the foregoing, and combinations thereof. As used herein the term “biobased material” may be used to refer to each of the foregoing, all of the foregoing collectively, and combinations of less than all of the foregoing. More particularly, it has been discovered that such thermoplastic biobased materials may be produced via a variety of methods including, for example, acylation of a biobased material, etherification of a biobased material, graft polymerization of biobased material, or a combination of the foregoing. Each of the foregoing processes may be referred to herein as a type of “chemical modification” and the resulting material as a “chemically-modified biobased material.”

### Acylated Biobased Material

Specifically, it has been discovered that a biobased material may be made thermoplastic to a degree believed to be sufficient for use in industrial applications as a substitute, in whole or in part, for conventional thermoplastic polymers. To achieve said degree of thermoplasticity via acylation, it is has been discovered that the biobased material is acylated such that it comprises acyl groups (—OCR1) where R1 is an alkyl, and has a % Acyl Content that is at least 3% and a % Weight Gain that is at least 1%. The % Acyl Content is defined as the weight percentage of acyl groups on the initial weight of biobased material used. The % Weight Gain is the % increase in the weight of the chemically-modified (in this case acylated) biobased material compared to the weight of unmodified biobased material and is a way to quantitatively determine the efficiency of the chemical modification process (in this case acylation). In one embodiment, R1 is selected from the group consisting of methyl, ethyl, propyl, butyl, and combinations thereof. In another embodiment, R1 is methyl.

The determination of % Acyl Content for acylated feather material is based on the fact that O-acetyl can be hydrolyzed by cold dilute NaOH, while the N-acyl groups are be removed only by boiling in dilute acid solution. Hendrix et al., The Effect of alkali treatment upon acetyl proteins, J. Biol. Chem., 1938, 124, 135-145. The method used to analyze the total acyl is similar to that reported by Blackburn for acetylation of wool. Blackburn et al., Experiments on the methylation and acetylation of wool, silk fibroin, collagen and gelatin, Biochem. J., 1944, 38 (2), 171-178. A sample of acylated biobased material (about 0.3 g) is boiled under reflux with for 4 hours with 10 mL of 2.5 mol/L H2SO4. The hydrolysate obtained was distilled and water was added as necessary until 200 mL of the distillate had been collected. The distillate obtained was titrated using 0.02 mol/L NaOH, and values obtained were subtracted from the values for the blank titration obtained by the similar hydrolysis and distillation of the unacetylated chicken feathers. The % Acyl Content is determined using titration with a NaOH solution according to the Equation 1.

$$\% Acyl Content = ( A - B ) \times M \times ( \frac{F}{W} ) \qquad ( 1 )$$

Where A was the amount (mL) of NaOH solution required for titration of the sample; B was the amount (mL) of NaOH solution required for titration of the blank; M was 0.02, the molar concentration of NaOH used for titration; W was the weight of feathers obtained after acetylation in grams; and F is related to the molecular weight of the acyl group, the unit conversion from liters to milliliters, and fraction to percentage according

$$F = \frac{Molecular Weight}{1000 mL \text{/} L} \times 100 \qquad ( 2 )$$

For more specific application of these equations regarding the acetylation of feathers and dried distillers grains, please see the Examples.

For DDGS, the extent of acylation of DDGS acetates obtained using alkaline and acidic catalysts is determined according to ASTM method D 871-96 with some minor modifications. To determine the % acyl content, the acylated products are first hydrolyzed using 0.5M NaOH. The NaOH that is not consumed during the hydrolysis is over-titrated using a known quantity of excess 0.5 M HCl. The solution is then back titrated using 0.5 M NaOH to eventually determine the amount of NaOH consumed to neutralize the acetic acid generated by the DDGS acetates. The % Acyl Content is calculated using Equation 3.

% Acetyl content=[(A−B)+(D−C)]×M×(F/W) (3)

Where A is the amount (mL) of NaOH solution required for titration of the sample; B is the amount (mL) of NaOH solution required for titration of the blank; C is the amount (mL) of HCl solution required for titration of the sample; D is the amount (mL) of HCl solution required for titration of the blank; M is 0.5, the molar concentration of NaOH and HCl used for titration; W is the sample weight in grams; and F is determined using Equation 2. Equation 3 provides the % Acyl Content for the soluble and insoluble portions of acylated DDGS. The following Equation 4 is used to calculate the acyl content of the total product obtained after acylation.

Aₜ=Wₛ×Aₛ+Wᵢ×Aᵢ (4)

Where Aₜ is the % Acyl Content of the total product; Wₛ and Aₛ are the weight and % Acyl Content of the soluble product; and Wᵢ and Aᵢ are the weight and % Acetyl Content of the insoluble product.

The % Weight Gain is determined after the acylated biobased material is thoroughly washed to remove chemicals and soluble impurities and dried in an oven at 50° C. until constant weight is obtained. The percent weight gain values were calculated according to the Equation 5

Percent Weight Gain=((W_{mod}−W_{unmod})/W_{unmod})×100 (5)

Where W_{unmod} was the initial oven-dried weight of the chicken feather before chemical modification and W_{mod} was the oven-dried weight of the acetylated chicken feathers.

### Acetylated Feathers

In one embodiment the biobased material is selected from the group consisting of feathers, portions thereof, and previously chemically-modified versions of the foregoing wherein, and R1 is methyl, the % Acyl Content that is in the range of 3-10% and the % Weight Gain is in the range of 2-10%. In another embodiment, the biobased material is selected from the group consisting of feathers, portions thereof, and previously chemically-modified versions of the foregoing, and R1 is methyl, the % Acyl Content that is in the range of 3-8% and the % Weight Gain is in the range of 4-10%.

Acylated DDGS

In one embodiment the biobased material is selected from the group consisting of dried distillers grains, constituents thereof, and previously chemically-modified versions of the foregoing, and R1 is methyl, the % Acyl Content in the range of 10-50%, and the % Weight Gain is in the range of 10-60%. In another embodiment, the biobased material is selected from the group consisting of dried distillers grains, constituents thereof, and previously chemically-modified versions of the foregoing, and R1 is methyl, the % Acyl Content that is in the range of 20-40% and the % Weight Gain is in the range of 20-50%.

Acylation Process

The following description of the acylation process is focused on a species of acylation, in particular acetylation, but it is believed to be equally applicable to other acyls. Acetylation is one of the most common chemical modifications used to develop thermoplastics from biopolymers. Acetylation is simple, provides products with good properties, uses green chemicals, is relatively inexpensive compared to other chemical modifications and acetylated products tend to be biodegradable and environmentally friendly.

It is believed the possible reactions between acetic anhydride and the proteins are shown below. It is believed that acetylation occurs on both the hydroxyl and amine groups in feather proteins. The first of the following reaction schemes represents the reaction between the hydroxyl groups in the feather proteins and acetic anhydride. The second of the following reaction schemes depicts the reaction between the primary and secondary amines in the proteins and acetic anhydride. The reaction between the acetic anhydride and the hydroxyl and amine groups results in the formation of the acetylated feathers.

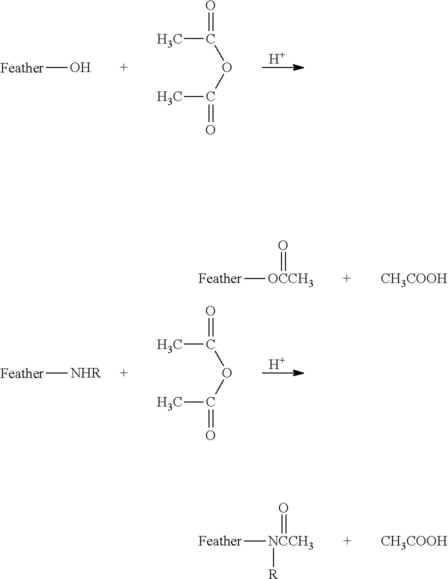

Cellulose and starch, two of the most common biopolymers have been acetylated and used to develop fibers, films, composites and many other products. Similarly, proteins have also been acetylated to develop thermoplastics and other products. The conditions of acetylation such as concentration of chemicals and catalysts, time, temperature and pH of reaction play an important role in determining the efficiency (% acetylation, degree of polymerization) of acetylation and the properties of the products obtained. Conventional processes of cellulose acetylation are performed under acidic conditions using acetic anhydride with or without catalysts and high temperatures (e.g., 80-120° C.) and/or long reaction times (e.g., 15 hours). In contrast, starch acetates are typically prepared under alkaline conditions using acetic anhydride and high temperatures. Protein acetylation is typically performed under mild alkaline (e.g., pH 8-8.5) conditions using acetic anhydride at room temperature. Because carbohydrate and protein acetylations use vastly different conditions, conventional methods of acetylating cellulose and proteins are not suitable for acetylating DDGS, which is a mixture of oil (8-11%), proteins (25-30%) and carbohydrates (35-50%). It is believed that the proteins in DDGS would be damaged if acetylated at high temperatures used for cellulose and starch acetylation and the carbohydrates in DDGS would not be efficiently acetylated using conventional protein acetylation methods. In addition, current methods of acetylating cellulose and starch require large amounts of acetic anhydride, which is an expensive chemical. The process of acylating/acetylating of the present invention is effective and efficient on at acylating/acetylating both the proteins and carbohydrates in DDGS. Although the acylating/acetylating process of the present invention may be performed under alkaline or acidic conditions, it is believed that acidic conditions provide substantially higher % acetyl content, intrinsic viscosity and thermoplasticity even at low ratios of acetic anhydride and catalyst concentrations compared to using alkaline conditions for acetylation of oil-and-zein-free DDGS.

The possible reactions between acetic anhydride and the carbohydrates and proteins are shown in the following schemes. The first of the following schemes represents the reaction between the hydroxyl groups in the carbohydrate (cellulose, hemicellulose, starch) and proteins and acetic anhydride. The second of the following schemes depicts the reaction between the primary and secondary amines in the proteins and acetic anhydride. The reaction between the acetic anhydride and the hydroxyl and amine groups results in the formation of the DDGS acetates.

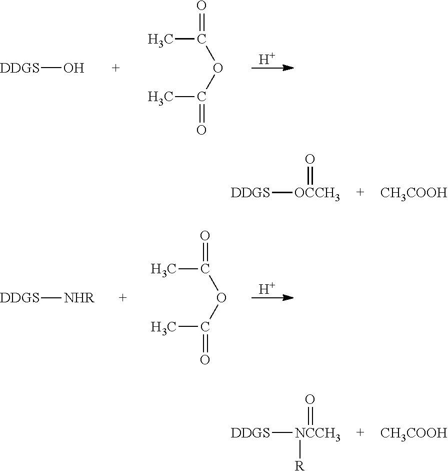

In view of the foregoing, one embodiment of the present invention is directed to a process for chemically modifying a biobased material to impart thermoplasticity via acylation, wherein the acylation process comprises reacting the biobased material with an acylating agent until the acylated biobased material has a % Acyl Content that is at least 3% and a % Weight Gain that is at least 1%, wherein the acylating agent is selected from the group consisting of one or more aliphatic acid anhydrides, one or more aromatic acid anhydrides, and combinations thereof. In one embodiment, the acylation reaction is carried out in the presence of a acylation catalyst at an amount that is in the range of 0.5-25% by weight of the biobased material at an acylation temperature that is in the range of 0-120° C. for an acylation duration that is in the range of 10-150 minutes using a weight ratio of acylating agent to biobased material that is in the range of 1:1 to 10:1, wherein the acylation catalyst is selected from the group consisting of one or more mineral acids, acetic acid, and combinations thereof, and wherein the acylating agent is one or more organic acid anhydrides. In a further embodiment, said mineral acids are selected from the group consisting of sulfuric acid, hydrochloric acid, nitric acid, phosphoric acid, boric acid, hydrofluoric acid, hydrobromic acid, perchloric acid, and combinations thereof. In yet another embodiment, said organic acid anhydrides are selected from the group consisting of acetic anhydride, succinic anhydride, maleic anhydride, and combinations thereof. In still another embodiment, the organic acid anhydride is acetic anhydride.

In an embodiment, the biobased material is selected from the group consisting of feathers, portions thereof and previously chemically-modified versions of the foregoing, and the acylating agent is acetic anhydride, the amount of acylation catalyst is in the range of 5-20% by weight of the biobased material, the acylation temperature is in the range of 50-90° C., the acylation duration is in the range of 10-60 minutes, the weight ratio of acylating agent to biobased material that is in the range of 2:1 to 5:1, the % Acyl Content that is in the range of 3 10% and the % Weight Gain of the acylated biobased material that is in the range of 2-10%.

In another embodiment, the biobased material is selected from the group consisting of feathers, portions thereof, and previously chemically-modified versions of the foregoing, and the acylating agent is acetic anhydride, the amount of acylation catalyst is in the range from 7-10% by weight of the biobased material, the acylation temperature is in the range of from 60-70° C., the acylation duration is in the range from 30-60 minutes, the weight ratio of acylating agent to biobased material that is in the range of 3:1 to 4:1, the % Acyl Content is in the range of 3-8%, and the % Weight Gain of the acylated biobased material is in the range of 4-10%.

Etherified Biobased Material

Specifically, it has been discovered that a biobased material may be made thermoplastic to a degree believed to be sufficient for use in industrial applications as a substitute, in whole or in part, for conventional thermoplastic polymers. To achieve said degree of thermoplasticity via etherification, it is has been discovered that the biobased material is etherified such that it comprises —R2Q groups where R2 is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%. In one embodiment, R2 is selected from the group consisting of methyl, ethyl, propyl, butyl, and combinations thereof and Q is a cyano group. In another embodiment, R2 is ethyl.

Acetylated Feathers

In one embodiment the biobased material is selected from the group consisting of feathers, portions thereof, and previously chemically-modified versions of the foregoing, and R2 is ethyl, Q is a cyano group, and the etherified biobased material has a % Weight Gain that is in the range of 2-4%.

Etherified DDGS

In one embodiment the biobased material is selected from the group consisting of dried distillers grains, constituents thereof, and previously chemically-modified versions of the foregoing, and R2 is ethyl, Q is a cyano group, and the % Weight Gain is in the range of 10-45%. In another embodiment, the biobased material is selected from the group consisting of dried distillers grains, constituents thereof, and previously chemically-modified versions of the foregoing, and R2 is ethyl, Q is a cyano group, and the % Weight Gain is in the range of 25-45%.

Etherification Process

The following description of the etherification process is focused on a species of etherification, in particular cyanoethylation with acrylonitrile as the etherifying agent, but it is believed to be equally applicable to other forms of etherification. It is believed that etherification has several advantages over acetylation. Etherification uses relatively milder conditions (low temperatures and pH) than acetylation and therefore will cause lesser damage to polymers, especially proteins that are easily hydrolyzed under high temperatures and strong alkaline or strong acidic conditions. In addition, ethers are more flexible than esters and therefore ethers could provide thermoplastics with better elongation than esters. Cyanoethylation using acrylonitrile is desirable because it is common method of etherification and it is relatively low cost and simple.

Cyanoethylation of the chicken feathers may be carried out, for example, using acrylonitrile and sodium carbonate as both the swelling agent and catalyst. The reaction between the hydroxyl groups of the proteins in chicken feathers and acrylonitrile in the presence of sodium carbonate is believed to be a typical nucleophilic addition reaction. The possible mechanism of the reactions between acrylonitrile and the hydroxyl groups in the feathers is given in the following scheme. The reaction between the acrylonitrile and the hydroxyl groups in chicken feather results in the formation of the cyanoethylated chicken feathers.

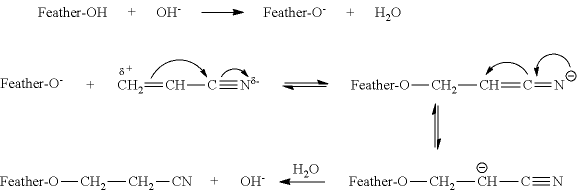

The chemical modification of DDGS is challenging since DDGS is a mixture of carbohydrates and proteins. Conventional processes for modifying carbohydrates in DDGS may damage proteins whereas the protein modification conditions may not provide the desired level of modification to the carbohydrates. For instance, cyanoethylation of cellulose is typically performed under alkaline conditions at high temperatures 40-60° C., which is believed to hydrolyze the proteins in DDGS. The process of etherification as disclosed herein allows for cyanoethylation of DDGS at conditions believed to cause minimum damage to the proteins and carbohydrates and at the same time provide a desired level of thermoplasticity such that the resulting etherified DDGS may be used to make thermoplastic products.

The reaction between carbohydrates and proteins (DDGS-OH) in oil-and-zein-free DDGS and acrylonitrile in the presence of sodium hydroxide is believed to be a typical nucleophilic addition reaction. The possible mechanism of the reactions between acrylonitrile and the hydroxyl groups in the carbohydrates and proteins in DDGS is set forth in the following scheme. This scheme represents the reaction between the hydroxyl groups in the carbohydrate (cellulose, hemicellulose, starch) and proteins and acrylonitrile. The reaction between the acrylonitrile and the hydroxyl groups in DDGS results in the formation of the cyanoethylated DDGS.

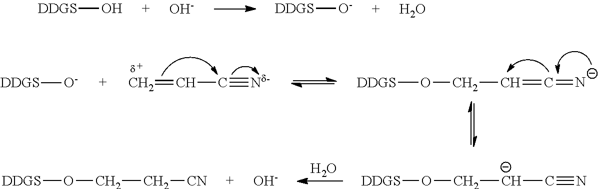

In view of the foregoing, one embodiment of the present invention is directed to a process for chemically modifying a biobased material to impart thermoplasticity via etherification, wherein the etherification process comprises a nucleophillic addition reaction in which the biobased material is reacted with an etherifying agent until the etherified biobased material has a % Weight Gain that is at least 2%, wherein the etherifying agent is one or more saturated molecules having an electron withdrawing group selected from the group consisting of a nitro group, a quaternary amine group, a trihalide group, a cyano group, a sulfonate group, a carboxylic acid group, an ester group, an aldehyde group, and a ketone group.

In one embodiment, etherification reaction is carried out in the presence of an etherification catalyst at an amount that is in the range of 1-25% by weight of the biobased material at an etherification temperature that is in the range of 10-120° C. for an etherification duration that is in the range 10-180 minutes using a weight ratio of etherifying agent to biobased material that is in the range of 1:1 to 15:1, wherein the etherification catalyst is selected from the group consisting of carbonates, hydroxides, and combinations thereof, and wherein the etherifying agent is selected from the group consisting of acrylonitrile, benzyl chloride, propyl bromide, and combinations thereof. In one embodiment, the carbonates are selected from the group consisting of sodium carbonate, potassium carbonate, ammonium carbonate, and combinations thereof and the hydroxides are selected from the group consisting of sodium hydroxide, ammonium hydroxide, and combinations thereof.

In an embodiment, the biobased material is selected from the group consisting of feathers, portions thereof and previously chemically-modified versions of the foregoing, and the etherifying agent is acrylonitrile, the amount of etherification catalyst is in the range of 5-20% by weight of the biobased material, the etherification temperature is in the range of 10-50° C., the etherification duration is in the range of 20-60 minutes, the weight ratio of etherifying agent to biobased material that is in the range of 5:1 to 10:1, and the % Weight Gain of the etherified biobased material is in the range of 2-4%. In still another embodiment, the biobased material is selected from the group consisting of feathers, portions thereof and previously chemically-modified versions of the foregoing, and the etherifying agent is acrylonitrile, the amount of etherification catalyst is in the range of 10-20% by weight of the biobased material, the etherification temperature is in the range of 30-50° C., the etherification duration is in the range of 30-40 minutes, the weight ratio of etherifying agent to biobased material is in the range of 6:1 to 8:1, and the % Weight Gain of the etherified biobased material is in the range of 2-4%.

In another embodiment, the biobased material is selected from the group consisting of feathers, portions thereof, and previously chemically-modified versions of the foregoing, and the etherifying agent is acrylonitrile, the amount of the etherification catalyst is in the range of 5-20% by weight of the biobased material, the etherification temperature is in the range of 10-50° C., the etherification duration is in the range of 20-80 minutes, the weight ratio of etherifying agent to biobased material is in the range of 4:1 to 8:1, and % Weight Gain of the etherified biobased material is in the range of 10-45%. In still another embodiment, the biobased material is selected from the group consisting of feathers, portions thereof, and previously chemically-modified versions of the foregoing, and the etherifying agent is acrylonitrile, the amount of etherification catalyst is in the range of 10-20% by weight of the biobased material, the etherification temperature is in the range of 30-50° C., the etherification duration is in the range of 100-120 minutes, the weight ratio of etherifying agent to biobased material is in the range of 3:1 to 5:1, and the % Weight Gain of the etherified biobased material is in the range of 25-45%.

Graft Polymerized Biobased Material

Specifically, it has been discovered that a biobased material may be made thermoplastic to a degree believed to be sufficient for use in industrial applications as a substitute, in whole or in part, for conventional thermoplastic polymers. To achieve said degree of thermoplasticity via graft polymerization, it is has been discovered that the graft polymerized biobased material comprises a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%. In one embodiment, the monomer is one or more acrylates. In another embodiment, the monomer is selected from the group consisting of methyl methacrylate, ethyl methacrylate, butyl methacrylate, methyl acrylate, ethyl acrylate, and butyl acrylate, and combinations thereof. It should be noted that % Monomer Conversion and % Grafting Efficiency indicate the amount of the monomer converted to polymer and the weight ratio of grafted branches grafted onto the backbone of substrate to the sum of grafted branches and un-grafted homopolymers, respectively. These two grafting parameters are major factors that influence the cost of grafting. The grafting process as disclosed herein may be used to produce materials that have a relatively high % Grafting, high % Monomer Conversion, and % Grafting Efficiency.

The % Monomer Conversion is determined first determining the amount of residual monomer remaining after the reaction by titrating the double bonds of the residual monomer in the filtrate. The % Monomer Conversion is then calculated using Equation 6.

$$\% Monomer Conversion = \frac{{W}_{1} - {W}_{2}}{{W}_{1 }} \times 100 \qquad ( 6 )$$

Where W₁ and W₂ denoted the weight of the total and the residual monomer, respectively. The % Grafting describes the weight percentage of polymer grafted onto functional groups on the surfaces of the biobased material. The % Grafting Efficiency describes the weight percentage of polymer grafted onto functional groups on the surfaces of the bioproduct to the total polymer, including grafted polymer and un-grafted homopolymers. The % Grafting and % Grafting Efficiency are determined using Equations 7-9.

$$\begin{matrix}{W}_{3} = {W}_{b} - {W}_{a} & ( 7 ) \\ \% Grafting = \frac{{W}_{1} - {W}_{2} - {W}_{3}}{{W}_{0}} \times 100 & ( 8 ) \\ \begin{matrix}\% Grafting Efficiency = \frac{{W}_{1} - {W}_{2} - {W}_{3}}{{W}_{1} - {W}_{2 }} \times 100 \\ = \frac{\% Grafting}{\% Monomer Conversion} \times \\ \frac{{W}_{0}}{{W}_{1}} \times 100\end{matrix} & ( 9 )\end{matrix}$$

where W_{b} and Wₐ were the weight of the biobased material before and after the extraction, respectively; W₃ and W₀ were the weight of the homopolymer and biobased material, respectively.

Graft Polymerized Feathers

In one embodiment the biobased material is selected from the group consisting of feathers, portions thereof, and previously chemically-modified versions of the foregoing wherein, and the monomer is methyl methacrylate, the % Monomer Conversion that is at least 75%, the % Grafting Efficiency is in the range of 50-80%, and the % Grafting is in the range of 20-50%. In another embodiment, the biobased material is selected from the group consisting of feathers, portions thereof, and previously chemically-modified versions of the foregoing, and the monomer is methyl methacrylate, the % Monomer Conversion that is at least 85%, the % Grafting Efficiency is in the range of 50-80%, and the % Grafting is in the range of 25-35%.

Graft Polymerized DDGS

In one embodiment the biobased material is selected from the group consisting of dried distillers grains, constituents thereof, and previously chemically-modified versions of the foregoing, and the monomer is methyl methacrylate, the % Monomer Conversion that is at least 40%, the % Grafting Efficiency is in the range of 50-90%, and the % Grafting is in the range of 10-70%. In another embodiment, the biobased material is selected from the group consisting of dried distillers grains, constituents thereof, and previously chemically-modified versions of the foregoing, and the monomer is methyl methacrylate, the % Monomer Conversion that is at least 50%, the % Grafting Efficiency is in the range of 40-90%, and the % Grafting is in the range of 10-70%.

Graft Polymerization Process

Graft polymerization is an efficient chemical modification to develop thermoplastics. Graft polymerization introduces one or more kinds of polymers onto molecular chains of another polymer as a substrate. Graft polymerization can be initiated through three ways, i.e., redox, oxidation, and radiation. Using redox system is the most common method for initiation of graft polymerization because free radicals can be generated efficiently under mild conditions. In a redox system, persulfates are commonly used as oxidant. A redox system of persulfate exhibits high initiation efficiency and reproducibility. In addition, the temperature does not change drastically during graft polymerization using a redox system. Thus the polymerization process can be easily controlled. Moreover, persulfate is inexpensive and non-toxic. Common reductants for the redox system of persulfate are generally sodium bisulfite and ferrous ammonium sulfate, which are capable of substantially decreasing the activation energy of decomposition of persulfate. Therefore, we adopted potassium persulfate and sodium bisulfite as oxidant and reductant, respectively, in this paper.

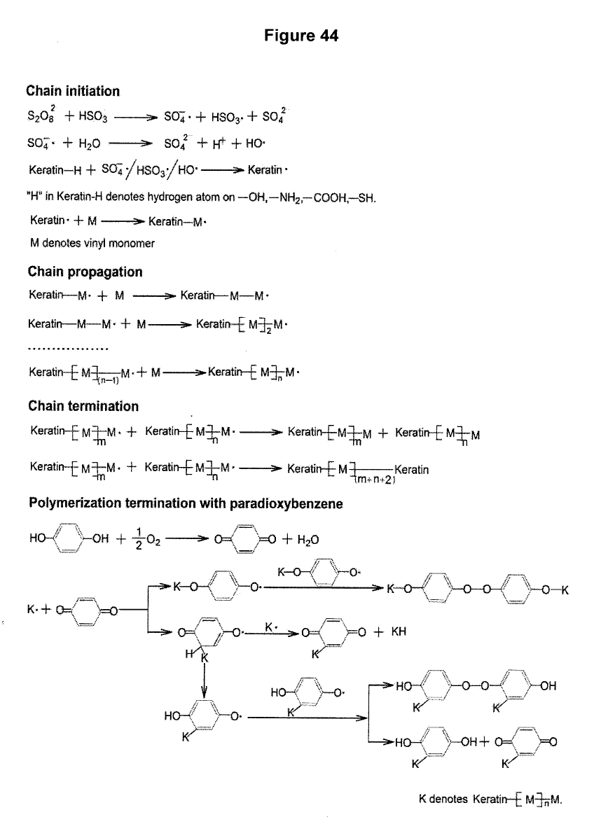

The following description of the graft polymerization process is focused on a species of redox graft polymerization, in particular one that utilizes a vinyl monomer, but it is believed to be equally applicable to other monomers. It should not, however, be construed as limiting the manner in which graft polymerized biobased materials as disclosed herein may be produced. FIG. 44 shows a graft polymerization process utilizing methyl acrylate (MA) as a monomer that is grafted onto chicken feathers through a K2S2O8/NaHSO3 redox system to form feather graft polymerized with poly(methyl acrylate) (feather-g-PMA). Although PMA by itself is not biodegradable, biodegradability of starch-g-PMA has been reported using starch assisted microorganisms to attack PMA when the % Grafting was low. Referring to FIG. 44, chain initiation shows that free radicals are produced by redox reaction of S2O82- and HSO3-. There were many pendant functional groups such as —OH, —NH2, —COOH, and —SH along the molecular chains of feather keratin. The active sites are formed on one or all types of these functional groups and thus monomers. The chain propagation shows that the propagation of grafted branches during polymerization. The last section shows the process of chain termination.

In view of the foregoing, one embodiment of the present invention is directed to a process for chemically modifying a biobased material to impart thermoplasticity using graft polymerization via free radical polymerization of a monomer so that the graft polymerized biobased material has % Monomer Conversion that is at least 10%, a % Grafting Efficiency that is at least 10%, and a % Grafting that is at least 10%, wherein the monomer comprises a functional group selected from the group consisting of an alkenyl, an alkynyl, an aryl, or combinations thereof. In one embodiment, the graft polymerization reaction is carried out at a polymerization temperature that is in the range of 20-120° C. and at a pH that is in the range of 2-13 for a polymerization duration that is in the range 0.1-24 hours, wherein the unsaturated monomer is a concentration that is in the range of 10-200% based on the weight of the biobased material, and wherein the graft polymerization reaction is initiated by reacting an oxidant and a reductant, wherein the molar ratio of reductant to oxidant is in the range of 0.1-5.0, and the concentration of oxidant is in the range of 0.1-10 mol/L, wherein the oxidant is selected from the group consisting of persulfates, permanganates, and combinations thereof, and the reductant is selected from the group consisting of sulfates, sulfites, peroxides, and combinations thereof, and wherein the monomer is one or more acrylates. In a further embodiment, the monomer is selected from the group consisting of methyl methacrylate, ethyl methacrylate, butyl methacrylate, methyl acrylate, ethyl acrylate, butyl acrylate, and combinations thereof.

In an embodiment, the biobased material is selected from the group consisting of feathers, portions thereof and previously chemically-modified versions of the foregoing, and the monomer is methyl methacrylate, the oxidant is potassium persulfate, and the reductant is sodium bisulfite, and the polymerization temperature is in the range of 40-70° C., pH is in the range of 4.5-6.5, the polymerization duration that is in the range of 1-5 hours, the concentration of the unsaturated monomer is in the range of 10-60% based on the weight of the biobased material, the molar ratio of reductant to oxidant is in the range of 0.01:1 to 1:10, the oxidant concentration is in the range of 0.005-0.020 mol/L, the % Monomer Conversion is at least 75%, the % Grafting Efficiency is in the range of 50-80%, and the % Grafting is in the range of 20-50%. In another embodiment, the biobased material is selected from the group consisting of feathers, portions thereof and previously chemically-modified versions of the foregoing, and the monomer is methyl methacrylate, the oxidant is potassium persulfate, and the reductant is sodium bisulfite, polymerization temperature is in the range of 50-70° C., the pH is in the range of 5.0-5.5, the polymerization duration is in the range of 2-4 hours, the concentration of the unsaturated monomer is in the range of 30-60% based on the weight of the biobased material, the molar ratio of reductant to oxidant is in the range of 0.1:1.5 to 1.5:5.0, the oxidant concentration is in the range of 0.005-0.015 mol/L, the % Monomer Conversion is at least 85%, the % Grafting Efficiency is in the range of 50-80%, and the % Grafting is in the range of 25-35%.

In an embodiment, the biobased material is selected from the group consisting of feathers, portions thereof, and previously chemically-modified versions of the foregoing, and the monomer is methyl methacrylate, the oxidant is potassium persulfate, and the reductant is sodium bisulfite, and wherein the polymerization temperature that is in the range of 50-90° C., the pH is in the range of 4.0-7.0, the polymerization duration is in the range of 0.5-8 hours, the concentration of the unsaturated monomer is in the range of 10-75% based on the weight of the biobased material, the molar ratio of reductant to oxidant is in the range of 0.1:1 to 1:5, the oxidant concentration is in the range of 0.005-0.015 mol/L, the % Monomer Conversion is at least 80%, the % Grafting Efficiency is in the range of 50-90%, and the % Grafting is in the range of 20-40%. In another embodiment, the biobased material is selected from the group consisting of feathers, portions thereof, and previously chemically-modified versions of the foregoing, and the monomer is methyl methacrylate, the oxidant is potassium persulfate, and the reductant is sodium bisulfite, and wherein the polymerization temperature that is in the range of 40-90° C., the pH is in the range of 4.5-6.5, the polymerization duration is in the range of 0.5-12 hours, the concentration of the unsaturated monomer is in the range of 20-70% based on the weight of the biobased material, the molar ratio of reductant to oxidant is in the range of 0.1:1.5 to 1.5:4.0, the oxidant concentration is in the range of 0.005-0.1 mol/L, the % Monomer Conversion is at least 90%, the % Grafting Efficiency is in the range of 50-90%, and the % Grafting is in the range of 40-80%.

Presence of Homopolymer

The polymerization process also results in the formation of homopolymer. While this can be separated from the graft polymerized biobased material, its presence may, depending upon the ultimate application, be desirable. The amount of the homopolymer is selected to attain desired properties of the products. For example, as the amount of homopolymer increases there tends to be an increase in plasticity such that elongation increases and strength decreases. The amount of homopolymer can be controlled during the grafting process. In addition or alternatively, the homopolymer could be removed by extracting with an appropriate solvent (e.g., acetone for PMA).

As such, in one embodiment, in addition to the graft polymerized biobased material, the thermoplastic bio-based material-containing composition further comprises a homopolymer of said monomer at an amount that is greater than 10% by weight of the graft polymerized biobased material. In another embodiment, the thermoplastic bio-based material-containing composition further comprises a homopolymer of said monomer at an amount that is in the range of 20-80% by weight of the graft polymerized biobased material. In yet another embodiment, the thermoplastic bio-based material-containing composition further comprises a homopolymer of said monomer at an amount that is in the range of 25-55% by weight of the graft polymerized biobased material.

In view of the foregoing, the thermoplastic biobased material-containing composition comprises one or more of the following chemically-modified biobased materials:
(a) acylated biobased material comprising acyl groups (—OCR₁) where R₁ is an alkyl and having a % Acyl Content that is at least 3% and a % Weight Gain that is at least 1%, and;
(b) etherified biobased material comprising —R₂Q groups where R₂ is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and
(c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

Combinations of Chemically-Modified Biobased Material

As indicated above, in certain embodiments of the present invention the thermoplastic biobased material-containing composition comprises more than one of the above-described types of chemically-modified biobased materials. Specifically, the thermoplastic composition may comprise two or more of the above-described acylated biobased material, the etherified biobased material, and the graft polymerized biobased material. This combination may be attained through a physical mixture of multiple types of chemically-modified biobased materials, through performing multiple types of chemical modification of the biobased material, or a combination thereof.

In one embodiment, the thermoplastic biobased material-containing composition comprises a physical mixture of at least two of the acylated biobased material, the etherified biobased material, and the graft polymerized biobased material. In another physical mixture embodiment, the acylated biobased material, if present, is at amount that is in the range of 10-90% by weight of the thermoplastic biobased material, the etherified biobased material, if present, is at amount that is in the range of 10-90% by weight of the thermoplastic biobased material, and the graft polymerized biobased material, if present, is at amount that is in the range of 10-90% by weight of the thermoplastic biobased material.

In one embodiment, the thermoplastic biobased material-containing composition comprises at least two of the acylated biobased material, the etherified biobased material, and the graft polymerized biobased material, and each of which that is present is a portion of the same chemically-modified biobased material. In another multiple chemically-modified embodiment, the acylated biobased material, if present, is at amount that is in the range of 10-90% by weight of the thermoplastic biobased material, the etherified biobased material, if present, is at amount that is in the range of 10-90% by weight of the thermoplastic biobased material, and the graft polymerized biobased material, if present, is at amount that is in the range of 10-90% by weight of the thermoplastic biobased material.

Plasticizer

The thermoplastic biobased material-containing composition may also comprise a plasticizer depending on the properties of the product desired. In one embodiment, the thermoplastic biobased material-containing composition further comprises plasticizer at an amount that is in the range of 5-30% by weight of the one or more chemically-modified biobased materials present. Exemplary plasticizers, include glycerol, sorbitol, glycols, mineral oils, synthetic resins (e.g., epoxy, phenol-formaldehyde, polysilicones), and combinations thereof.

Thermoplastic Composition Comprising Biomaterial

In an embodiment, the present invention is directed to a thermoplastic composition that comprises the above-described thermoplastic biobased material-containing composition. The thermoplastic composition may further comprise thermoplastics selected from the group consisting of conventional, non-biodegradable thermoplastics, biodegradable thermoplastics, and combinations thereof. Examples of conventional non-biodegradable thermoplastics include polyethylene, polypropylene, Polybutylene succinate (PBS), polycaprolactone (PCL). Examples of biodegradable thermoplastics include poly(lactic acid) (PLA), cellulose acetate, and starch acetate. Additionally, the thermoplastic composition may comprise plasticizers as set forth above.

Articles

Another embodiment of the present invention is an article comprising a thermoplastic biobased material-containing composition. The article may further comprise one or more thermoplastics selected from the group consisting of conventional, non-biodegradable thermoplastics, biodegradable thermoplastics, and combinations thereof. Examples of such articles include films, fibers, matrix materials for composites, extrudates (packing peanuts), etc.

### EXAMPLES

### Materials

Chicken feathers (whole feathers with quill and barbs) were obtained from Feather Fiber Corporation, Nixa, Mo. The feathers were washed, cleaned and mechanically processed to cut the feathers. Chicken feathers were finely ground in a laboratory scale Wiley mill to pass through a 20 mesh dispenser. The DDGS was supplied by Abengoa BioEnergy Corporation located in York, Nebr. Acetic acid, acetic anhydride (98% ACS grade) and other chemicals (reagent grade) used for acetylating the feathers were purchased from VWR International, Bristol, Conn. Methyl acrylate (99%) and paradioxybenzene (99%) purchased from Alfa Aesar were used as monomer and terminator, respectively. Potassium persulfate as oxidant (99%) and sodium bisulfite as reductant (99%) were supplied by Spectrum and J.T. Baker, respectively. Acrylonitrile, sodium carbonate, sodium hydroxide were reagent grade chemicals (98% ACS grade) purchased from VWR International (Bristol, Conn.). All other chemicals were of analytical grade. All the chemicals were used as received without further purification.

Preparation of Oil-and-Zein-Free DDGS

The DDGS was powdered in a laboratory scale Wiley mill to pass through a 20 mesh dispenser to facilitate better reaction with the chemicals. The oil and zein in the powdered DDGS were extracted since oil and zein are expensive and could be used for other high value applications. Oil and zein were extracted from DDGS using a novel procedure developed in our previous research. Xu, W.; Reddy, N.; Yang, Y. An acidic method of zein extraction from DDGS. J. Agric. Food Chem. 2007, 55(15): 6279-6284. Briefly, DDGS was treated with anhydrous ethanol in a Soxhlet extractor to remove oil until the DDGS was colorless. The DDGS obtained after removing the oil was treated again with 70% ethanol (4:1 ethanol to DDGS ratio) and 0.125% sodium sulfite on weight of DDGS at pH 2 at 70° C. for 30 minutes to remove zein. The extracted zein was collected and the oil-and-zein-free DDGS washed using 70% ethanol to remove any residual zein and later with hot water to remove any soluble substances. The oil-and-zein-free DDGS had an approximate composition of 31.6% hemicellulose, 26.4% cellulose, 22.5% protein, 8.6% starch and ash and lignin accounting for the remaining constituents, based on the composition of unmodified DDGS and the oil and zein obtained after extraction. The amount of cellulose and hemicellulose in the oil-and-zein-free DDGS was determined in terms of the acid detergent (ADF) and neutral detergent fiber (NDF) based on of AOAC method 973. Xu, W.; Reddy, N.; Yang, Y. Extraction, characterization and potential applications of cellulose in corn kernels and distillers dried grains with solubles, Carb. Polym., 2009, 76(4): 521-52. Lignin in the samples was determined as Klason lignin according to ASTM standard D1106-96 and ash was determined according to ASTM standard E1175-01.

Compression Molding

Unmodified and chemically-modified forms of feathers and DDGS were compression molded in a CARVER press (Carver, Wabash, Ind.) to evaluate their thermoplasticity and potential for various thermoplastic applications. Up to 20% by weight of glycerol was used as a plasticizer for films made from feathers. Amounts of samples were evenly spread on aluminum sheets and places inside the two hot plates and compressed at an elevated temperature and pressure for a duration set forth below. Then the press was cooled down by running cold water and the films formed were collected. Digital pictures were taken and are presented to compare the thermoplasticity of the modified and unmodified forms.

| | Sample size | Temperature | Pressure | Duration |
|---|---|---|---|---|
| Example | (g) | (° C.) | (MPa) | (minutes) |
| Example 1 - | 10 | 170 | 138 | 15 |
| Acetylation of | | | | |
| Feathers | | | | |
| Example 2 - | 5 | 138 | 138 | 2 |
| Acetylation of | | | | |
| DDGS | | | | |
| Example 3 - | 5 | 138 | 208 | 5 |
| Acetylation of | | | | |
| DDGS | | | | |
| Example 4 - | 10 | 180 | 103 | 2 |
| Cyanoethylation of | | | | |
| Feathers | | | | |
| Example 5 - | 10 | 150 | 275 | 2 |
| Cyanoethylation of | | | | |
| DDGS | | | | |
| Example 6 - Graft | 10 | 170 | 138 | 18 |
| Polymerization of | | | | |
| Feathers | | | | |

Determination of Acetyl Content

The extent of acetylation of the feathers and DDGS were quantitatively determined in terms of the % acetyl content based on the number of acetyl groups thereon. The acetyl content is defined as the weight percentage of acetyl (CH3CO—) groups on the initial weight of feathers used.

For feathers, the determination of acetyl groups was based on the fact that O-acetyl can be hydrolyzed by cold dilute NaOH, while the N-acetyl groups can be removed only by boiling in dilute acid solution. Approximately 0.3 g of the acetylated feather was boiled under reflux for 4 hours with 10 mL of 2.5 mol/L H2SO4. The hydrolysate obtained was distilled and water was added as necessary until 200 mL of the distillate had been collected. The distillate obtained was titrated using 0.02 mol/L NaOH, and values obtained were subtracted from the values for the blank titration obtained by the similar hydrolysis and distillation of the unacetylated chicken feathers. The % acetyl content was calculated using Equation 10.

% Acetyl content=(A−B)×M×(F/W) (10)

Where A is the amount (mL) of NaOH solution required for titration of the sample; B is the amount (mL) of NaOH solution required for titration of the blank; M is 0.02, the molar concentration of NaOH used for titration; W is the weight of feathers obtained after acetylation in grams; and F is 4.305 as calculated using Equation 11 for acetyl, which is related to the molecular weight of the acetyl group (CH₃CO), the unit conversion from liters to milliliters, and fraction to percentage.

$$F = \frac{Molecular Weight}{1000 mL \text{/} L} \times 100 = \frac{43.05}{10} = 4.305 \qquad ( 11 )$$

For DDGS, the extent of acetylation of DDGS acetates obtained using alkaline and acidic catalysts were determined in terms of the % acetyl content by titration according to ASTM method D 871-96 with some minor modifications. Commercial cellulose triacetate with a degree of substitution (DS) of 2.91-2.96 corresponds to acetyl content of 44.0%-44.4%. To determine the % acetyl content, the acetylated products were first hydrolyzed using 0.5M NaOH. The NaOH that was not consumed during the hydrolysis was over-titrated using a known quantity of excess 0.5 M HCl. The solution was then back titrated using 0.5 M NaOH to eventually determine the amount of NaOH consumed to neutralize the acetic acid generated by the DDGS acetates. The % acetyl content was calculated using Equation 12.

% Acetyl content=[(A−B)+(D−C)]×M×(F/W) (12)

Where A is the amount (mL) of NaOH solution required for titration of the sample; B is the amount (mL) of NaOH solution required for titration of the blank; C is the amount (mL) of HCl solution required for titration of the sample; D is the amount (mL) of HCl solution required for titration of the blank; M is 0.5, the molar concentration of NaOH and HCl used for titration; W is the sample weight in grams; and F is 4.305 as calculated using Equation 13 for acetyl, which was related to the molecular weight of the acetyl group (CH₃CO), the unit conversion from liters to milliliters, and fraction to percentage.

$$F = \frac{Molecular Weight}{1000 mL \text{/} L} \times 100 = \frac{43.05}{10} = 4.305 \qquad ( 13 )$$

Equation 12 provides the % acetyl content for the soluble and insoluble portions of acetylated DDGS. The following Equation 14 was used to calculate the acetyl content of the total product obtained after acetylation.

A_{t′}=Wₛ×Aₛ+Wᵢ×Aᵢ (14)

Where Aₜ is the % acetyl content of the total product; Wₛ and Aₛ are the weight and % acetyl content of the soluble product; and Wᵢ and Aᵢ are the weight and % acetyl content of the insoluble product.

Determination of Relative Viscosity for Acetylated DDGS

The relative viscosity of the soluble product in the supernatant obtained after acetylation was determined according to ASTM standard D 871-96 using 50% (w/w) acetone, 40% (w/w) formic acid and 10% (w/w) ethanol at 25±0.1° C. The relative viscosity was calculated according Equation 15

Relative Viscosity=t₁/t₂ (15)

Where t₁ is flow time of solution and t₂ was flow time of solvent. The insoluble products did not dissolve in the solvents used to measure the relative viscosity and therefore only the soluble product was used to measure the relative viscosity.

### Determination of Intrinsic Viscosity for Acetylated DDGS

The intrinsic viscosity of the DDGS acetate was determined according to ASTM standard D 871-96 with some minor modifications. Briefly, the DDGS acetate was dissolved in DMSO/DMF (1:1 v/v). The DDGS solution was then centrifuged at 6000 rpm for 10 minutes and the supernatant formed was collected. The solution was evaporated to collect the DDGS acetates dissolved in the supernatant. The DDGS acetate obtained was redissolved in DMSO/DMF (1:1, v/v) at various known concentrations. The flow rate of the DDGS acetate solutions was measured in a viscometer maintained at 25±0.1° C. The solvent flow time t0 and the solution flow time t for different concentrations of DDG acetates were measured. For each concentration, the corresponding inherent viscosity was calculated. For solution viscosity measurements, inherent viscosity is the ratio of the natural logarithm of the relative viscosity to the concentration of the polymer. The intrinsic viscosity was obtained by extrapolating the curve of inherent viscosity to zero concentration. The intrinsic viscosity, (η), was calculated using Equation 16.

[η]=(ln ηᵣ/C)_{C→0}, mL/g (16)

Where ηᵣ was the relative viscosity and ηᵣ=t/t₀, t was solution flow time, t₀ was the solvent flow time, and C was the concentration of the DDGS acetate solution in grams per milliliter.

### Determination of Percent Weight Gain

Percent weight gain values which describe the % increase in the weight of acylated or etherified biobased materials compared to the weight of the material before being modified in order to quantitatively determine the efficiency of reaction. The acetylated or etherified material was thoroughly washed to remove chemicals and soluble impurities and later dried in an oven at 50° C. until constant weight was obtained. The percent weight gain values were calculated according to the Equation 17.

Percent Weight Gain=((W_{mod}−W_{unmod})/W_{unmod})×100 (17)

Where W_{unmod} was the initial oven-dried weight before chemical modification and W_{mod} was the oven-dried weight after chemical modification.

### Fourier Transform Infrared (FTIR) Spectrum Analysis

FTIR spectra of unmodified and modified chicken feather were measured on a Nicolet NEXUS 670 (Thermo-Nicolet, Waltham, Mass.) FTIR spectrometer using KBr powder at room temperature. The samples were thoroughly washed in distilled water to remove the solvent and catalysts prior to mixing with KBr. Samples in the form of thin films were placed in the cell and measured from 400 to 4000 cm-1 with a resolution of 4 cm-1 and 64 scans were collected. The FTIR spectrums obtained were analyzed using OMNIC software (Thermo Electron Corporation).

FTIR spectra of the unmodified and modified oil-and-zein-free DDGS were collected on an attenuated total reflectance ATR spectrophotometer (Nicolet 380; Thermo-Fisher, Waltham, Mass.). The samples were thoroughly washed in distilled water and placed on a germanium plate and 64 scans were collected for each sample at a resolution of 32 cm-1.

FTIR was also used to verify the grafting of polymer onto the feathers. The feather-g-PMA was extracted by acetone for 24 hours and the homopolymer (PMA) which adhered on the feather-g-PMA was removed completely. Measurements were taken on Thermo Nicolet (Avatar 380) spectrophotometer through the diffuse reflectance technique with a spectral resolution of 32 cm-1 for 64 scans.

### Pyrolysis-Gas Chromatography-Mass Spectrometry Analysis

For acetylated and etherified feathers, pyrolysis was performed in a Chemical Data Systems Pyroprobe 120 pyrolyzer equipped with a platinum coil and quartz sample tube interfaced to a Shimadzu QP 2010 (Japan) GC-MS device. In order to carry out the analysis, samples of 10-15 mg were pyrolyzed at 200-300° C. for 10 s. A helium carrier gas at a 48.2 mL/min flow rate purged the pyrolysis chamber into a fused silica capillary gas chromatographic column (25 m×0.2 mm) coated with a bonded methyl silicone phase (0.33 μm). The temperature was 40° C. for 3 minutes with a temperature ramp of 10° C./min. The carrier gas was helium and the split ratio was 50:1. The injector and mass spectrometer interface temperatures were 280 and 300° C., respectively. The mass spectrometer was operated in electron impact (EI) mode at 70 eV, scanning in the mass range from 33 to 400 atomic mass unit (amu). The temperature of the GC-MS interface was held at 300° C. The acceleration voltage was turned on after a solvent delay of 80 s. The detector voltage was 1100 V. Mass spectral similarity searches were performed using the NIST MS Search 2.0 (NIST/EPA/NIH Mass Spectral Library.

### Nuclear Magnetic Resonance

1H-NMR spectroscopy was used to analyze the cyanoethylated and acetylated materials. The samples were dissolved in DMSO-d6 and the concentration of material was adjusted to 20-30 mg/mL for 1H-NMR measurements. 1H-NMR spectra were recorded at temperature using spectrometer operating at a frequency with standard programs as set forth in Table A, below. Chemical shifts were reported using DMSO-d6 (δH 2.50) as an internal reference. Typically, 64 scans were collected into 64K data points over the spectra width, relaxation delay, acquisition time, and flip angle set forth in Table A. All free induction decays (FID) were multiplied by an exponential function with a 1 Hz line broadening factor prior to Fourier transformation (FT). The spectra were phase corrected interactively using TOPSPIN. Baseline correction was carried out manually using each time the appropriate factors. Chemical shifts were reported using DMSO-d6 (δH 2.50) as an internal reference.

Proton nuclear magnetic resonance (1H-NMR) was also used to characterize polymerized feathers. The feather-g-polymethyl methacrylate was separated from homopolymer by being extracted with acetone for 24 hours. The polymerized feather was dissolved in DMSO-d6 at a concentration of about 1 wt %.

TABLE A

| | Example 2 | Example 4 | Example 5 | Example 6 Graft |
|---|---|---|---|---|
| | Acetylation of | Cyanoethylation | Cyanoethylation | Polymerization of |
| | DDGS | of Feathers | of DDGS | Feathers |
| Spectrometer | Bruker Advance | Bruker | Bruker | Bruker Advance |
| | DRX-400 | Advance | Advance | DRX-600 |
| | | DRX-400 | DRX-600 | |
| Frequency | 400.13 | 400.13 | 600.18 | 600.18 |
| (MHz) | | | | |
| Temp (° K.) | 295 | 295 | 313 | 313 |
| Spectra | 11990 | 11990 | 12376 | 12376 |
| Width (Hz) | | | | |
| Relaxation Delay | 6 | 6 | 5 | 1 |
| (seconds) | | | | |
| Acquisition | 2.7 | 2.7 | 2.6 | 3 |
| Time (seconds) | | | | |
| Flip Angle | 90° | 90° | 90° | 90° |

### Thermal Analysis

Thermogravimetric analysis (TGA) was performed on the unmodified and acetylated and etherified materials. Samples from Examples 1, 2, 3, and 5 were tested with a Perkin Elmer STA 6000 calibrated with nickel. These samples (18-26 mg) were placed under nitrogen atmosphere and heated from 50 to 650° C. at a heating rate of 20° C. min-1.

TGA was performed on the Example 4 samples with a Netzsch 209 F1 calibrated with nickel. The samples (10-15 mg) were placed under nitrogen atmosphere and heated from 50 to 550° C. at a heating rate of 10° C. min-1. Differential scanning calorimetry (DSC) was also used to study the thermal behavior of the unmodified and cyanoethylated chicken feathers using a Netzsch instrument (204 F1, Germany).

TGA was also performed on samples from Example 6 (unmodified feather and feather-g-PMA) The feather-g-PMA was separated from homopolymer as set forth above. TGA was performed to determine the degradation temperature (Td) of the unmodified and grafted samples using Universal V4.4A thermogravimetric analyzer (TA Instruments). About 10 mg of the sample was heated at 10° C./min in a temperature range of 30° C. to 600° C. under nitrogen atmosphere.

A Mettler Toledo (Model: DSC822e) DSC was also used to study the thermal behavior of the materials of Examples 1-6. The Example 1, 2, and 3 samples (about 10 mg) oven dried at 105° C. for 5 hours were placed in the DSC and heated at a rate of 20° C. min-1 after holding at 50° C. for 10 minutes to remove moisture in the samples. The samples were then heated up to 180° C. at a rate of 20° C. min-1 under a nitrogen atmosphere. The Example 6 samples were treated identically to samples of Examples 1-3 except they were heated at a rate of 40° C. min-1. The Example 5 samples were treated identically to the samples of Examples 1-3 except they were heated to 160° C. The Example 4 samples were treated identically to the samples of Examples 1-3 except that a Netzsch 204 F1 was used and the final temperature was 200° C.

### Tensile Properties of Thermoplastic Films

The tensile properties of the cyanoethylated material and graft polymerized material films were determined. Strips of the films (80 mm×15 mm) were conditioned for at least 24 hours at 21° C. and 65% relative humidity. The films were tested for their tensile strength, % breaking elongation and Young's modulus according to ASTM standard 882 on a MTS (Model Q test 10; MTS Corporation, Eden Prairie, Minn.) tensile tester equipped with a 50 N load cell using a gauge length of 2 inches and crosshead speed of 10 mm/min. At least five samples were tested for each condition and the average and ±one standard deviation is reported.

### Morphology of Modified and Unmodified DDGS

The surface morphology of the modified and unmodified DDGS of Example 3 were observed using a variable pressure scanning electron microscope (VP-SEM) (Model: Hitachi S 3000N, Hitachi High Technologies America, Inc., Schaumburg, Ill.). Samples were fixed using conductive adhesive tape and sputter coated with gold-platinum before observing in the SEM at a voltage of 20 kV.

### Statistics

All the experiments were repeated three times unless specified. The data reported are mean±one standard deviation. Fisher's Least Significant Difference (LSD) was used to test the effect of various conditions on the properties of products using SAS (SAS Institute Inc., Cary, N.C.). Statistical significance was considered at p<0.05. Any two data points with the same alphabet indicate that the data was not statistically different.

### Example 1

### Acetylation of Chicken Feather

The powdered feathers were acetylated using acetic anhydride as the acylation agent, acetic acid as solvent and sulfuric acid as the catalyst. Initially, glacial acetic acid was added into the chicken feather at a weight ratio of 10:1 at room temperature under constant stirring. Acetic anhydride (1:1 to 5:1 acetic anhydride to feather weight ratio) was added into the acetic acid feather mixture. Later, sulfuric acid was added (3 to 20% based on the weight of the feather) and the mixture was stirred at a temperature below 30° C. The acetylation was completed by heating the mixture containing feather, acetic acid, acetic anhydride and sulfuric acid for a specified time (10 to 120 minutes) at a specified temperature (50 to 90° C.). After completion of the reaction, 10% (w/w) aqueous sodium hydroxide was added to neutralize the acid remaining after reaction. The acetylated feathers obtained were thoroughly washed in distilled water at 50° C. for 30 minutes under constant stirring 5 times to ensure complete removal of the unreacted chemicals. The feathers were later dried at 40-50° C. for 12 h for further analysis.

Effects of Catalyst Concentration on % Acetyl Content and Percent Weight Gain of Acetylated Chicken Feathers

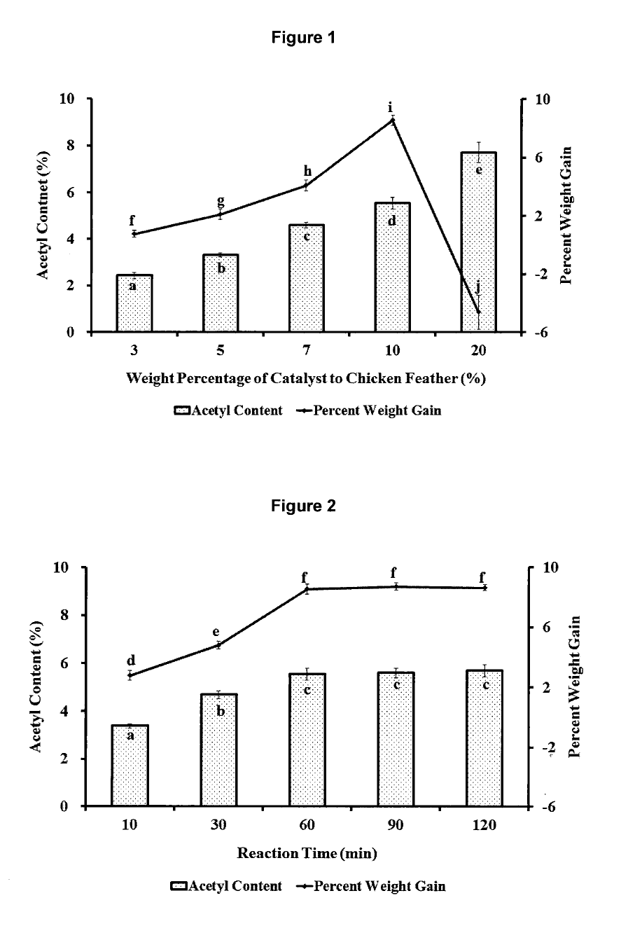

FIG. 1 depicts the effect of increasing the % of catalyst (sulfuric acid) on the acetyl content and percent weight gain of acetylated chicken feathers. As seen from FIG. 1, the increased catalyst concentration had a considerable effect on the % acetyl content and percent weight gain of feathers. The highest % acetyl content of 7.7% was obtained at a catalyst concentration of 20%. The percent weight gain also increased progressively when the catalyst concentration was increased from 3 to 10% but decreased substantially at 20% catalyst concentration. The highest weight gain obtained was about 8.6% with a catalyst concentration of 10%. Increasing the catalyst concentration above 10% increased the % acetyl content but decreased the percent weight gain due to hydrolysis of the proteins at low pH and high temperatures. Hydrolysis of the feathers lead to small molecules that are easily removed during washing. The feathers that remained after washing had molecules with higher degree of acetylation and therefore, there was an increase in the % acetyl content but a weight loss of 4.6% for the feathers acetylated using a catalyst concentration of 20%.

Effects of Reaction Time on % Acetyl Content and Percent Weight Gain of Acetylated Chicken Feathers

The changes in the % acetyl content and percent weight gain of the acetylated chicken feathers with increasing reaction time are shown in FIG. 2. Both the % acetyl content and percent weight gain showed similar trend with increasing time. Increasing time from 10 to 60 minutes increased the acetyl content and weight gain but reaction time above 60 minutes did not show any statistically significant increase in weight gain or % acetyl content. The optimum % acetyl content of 5.6% and percent weight gain of 8.5% were obtained at 60 minutes. However, an increase in reaction time above 60 minutes did not increase either the % acetyl content or percent weight gain indicating that the reaction had reached equilibrium under the conditions studied.

### Effects of Reaction Temperature on % Acetyl Content and Percent Weight Gain of Acetylated Chicken Feathers

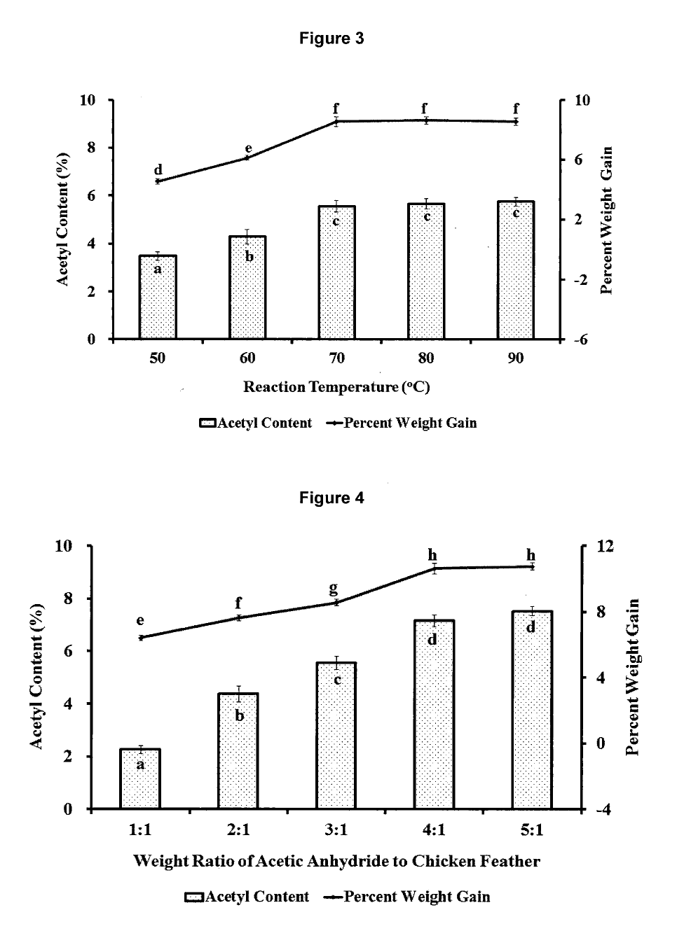

FIG. 3 shows the effect of increasing reaction temperature on the % acetyl content and percent weight gain of the acetylated chicken feather. Increasing reaction temperature from 50 to 60° C. and from 60 to 70° C. increased the acetyl content by about 22 and 30%, respectively. The corresponding increase in percent weight gain was 35 and 39%. However, further increase in temperature above 60° C. did not increase the % acetyl content or the percent weight gain. An optimum acetyl content of 5.6% was obtained when the reaction was carried out at 70° C. and the highest percent weight gain of 8.6% was also obtained at 70° C. Increasing reaction temperature increased the accessibility of the proteins to chemicals and increased the acetyl content and the weight percent. However, most of the available hydroxyl and amine groups have been reacted and the reaction reaches equilibrium at about 70° C. and we therefore did not see any further increase in the percent weight gain or % acetyl content above 70° C.

### Effects of Concentration of Acetic Anhydride on % Acetyl Content and Percent Weight Gain of Acetylated Chicken Feathers

The effect of increasing the weight ratio of acetic anhydride to chicken feather on the acetyl content and percent weight gain of acetylated chicken feathers is shown in FIG. 4. The acetyl content increased continually when the ratio of acetic anhydride was increased from 1:1 to 4:1 but did not increase above an acetic anhydride to feather ratio of 5:1. At a ratio of 1:1, there is insufficient anhydride to react with the hydroxyl and amine groups in the proteins and hence there was low level of acetylation and weight gain. It is believed that most of the accessible hydroxyl and amine groups in the proteins were acetylated at an anhydride to feather ratio of 4:1 and hence there was no increase in acetyl content upon further increase in anhydride ratio. The highest acetyl content obtained was 7.5% and the highest percent weight gain obtained was 10.8% at an acetic anhydride to feather ratio of 5:1.

The % acetyl content of 7.5% obtained was close to the theoretically possible acetylation of the hydroxyl and amine groups in feathers. The molar ratio of hydroxyl and amine groups on the side chains of the major amino acids (serine, threonine and arginine) was 219 mmol per 100 grams of feathers. We have calculated the % acetylation based on the moles of the hydroxyl and amine groups in the major amino acids in feathers and the moles of acetyl groups on the acetylated feathers based on an acetyl content of 7.5% as shown in Table B.

TABLE B
Calculation of the % acetylation based on the moles of the hydroxyl and amine groups

| | % w/w | Molecular | MW- | Moles of OH/NH₂ | |
|---|---|---|---|---|---|
| Amino | in | Weight | Water | per 100 g of | Moles of acetyl (COCH₃) per |
| acids | feather | (MW) | molecule | feather | 100 grams of feather |
| Serine | 11.44 | 105 | 87 | 11.44/87 = 0.131 | Acetylation mol (%) = 7.5/43 = 0.174 |
| Threonine | 4.66 | 119 | 101 | 4.66/101 = 0.046 | Moles of acetyl per g of |
| Arginine | 6.58 | 174 | 156 | 6.58/156 = 0.042 | feather¹ = 0.174 * 1.081 = 0.188 |
| | | | | Total = 0.219 | |

¹considering a weight gain of 7.5% due to acetylation

At a maximum acetyl content of 7.5%, before any substantial hydrolysis, the molar ratio of acetyl groups was 188 mmol per 100 grams of acetylated feathers. However, some of the hydroxyl and amine groups could be in the crystalline regions and not accessible to acetylation and therefore the highest % acetyl content obtained was lower than the maximum possible acetylation of 219 mmol per 100 grams of feathers.

### PGC-MS Analysis

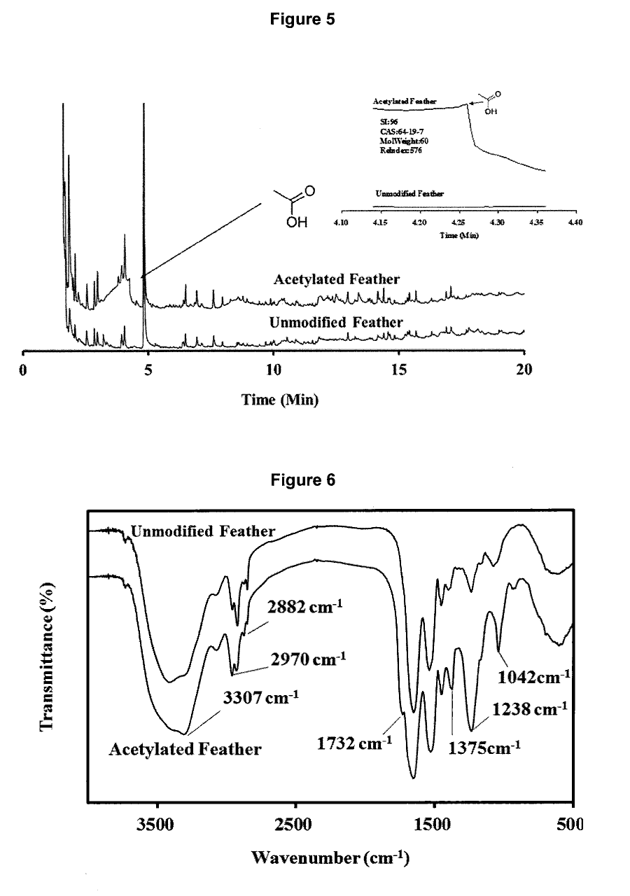

The mass spectrometer spectra in FIG. 5 showed that the acetylated chicken feather had a sharp peak at about 4.255 minutes and there was no apparent peak at this position for the unmodified feathers. Spectral match with the NIST library produced a match of 96% for acetic acid formed during the pyrolysis of the acetyl group. It is believed that this indicates that the peak in the spectrum for the modified feathers is from the acetylation of the feathers. In addition, acetylation of the amide groups introduces an extra peak at 3.950 minutes due to pyrolysis of the amide groups and removes a peak at 3.205 minutes in the acetylated feathers due to the acetylation of the imine and amine groups.

### FTIR Measurements

FIG. 6 shows the FTIR spectra of the unmodified and acetylated chicken feathers. The presence of an absorbance peak at 1732 cm-1 belonging to the stretching of the ester carbonyl C═O group is seen in the acetylated chicken feathers but not in the unmodified feather. Similarly, the appearance of the peak at 3307 cm-1 is mainly due to the unfolding of the proteins after acetylation. In addition, the groups may be partially acetylated and the unacetylated parts cause vibrations of the hydrogen and N—H bonds. It is believed that the increase in the intensity of the amide III peak at 1238 cm-1 is due to the stretching of the C—N group in the secondary amides and the C—C—O stretch of the acetates around 1240 cm-1. It is believed that the variations in the peak intensities between the unmodified and modified feathers at 2970 and 2882 cm-1 were be due to the asymmetric and symmetric vibration of the CH3 group, respectively. In addition, presence of the three characteristic ester peaks close to 1100, 1200 and 1700 cm-1 (1042, 1238 and 1732 cm-1) confirmed acetylation of the feathers.

### Thermal Analysis

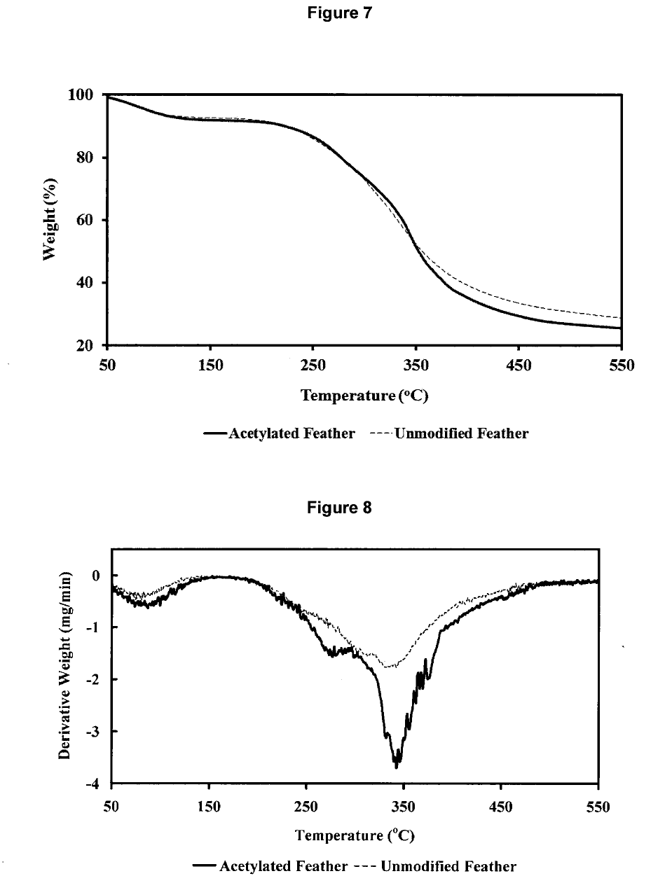

The thermal behavior of the acetylated chicken feather was compared to the unmodified chicken feather in FIGS. 7 to 9. The unmodified and acetylated chicken feathers have similar thermal degradation up to about 250° C. However, the acetylated chicken feather showed slightly higher overall weight loss than the unmodified chicken feather. The overall weight loss of the acetylated chicken feather was about 75% compared to 68% for the unmodified chicken feather. It is believed that the higher % weight loss for the acetylated chicken feather compared to the unmodified chicken feather was mainly be due to the relatively poor thermal instability of the acetyl groups.

FIG. 8 shows the DTG curve of the unmodified and acetylated feathers. Both the modified and unmodified feathers show a peak at 70° C. most likely due to the evaporation of water. It is believed that the peak at about 270° C., especially in the acetylated feathers, was due to the substitution on the amino group, which decreases the thermal stability of the parent polymer. Also, a prominent peak is seen at 330° C. for the unmodified feather but at a slightly higher temperature (340° C.) for the acetylated feather due to the degradation of the proteins in the feathers. The acetylated feathers have a faster degradation than the unmodified feathers due to the thermal instability of the acetyl groups.

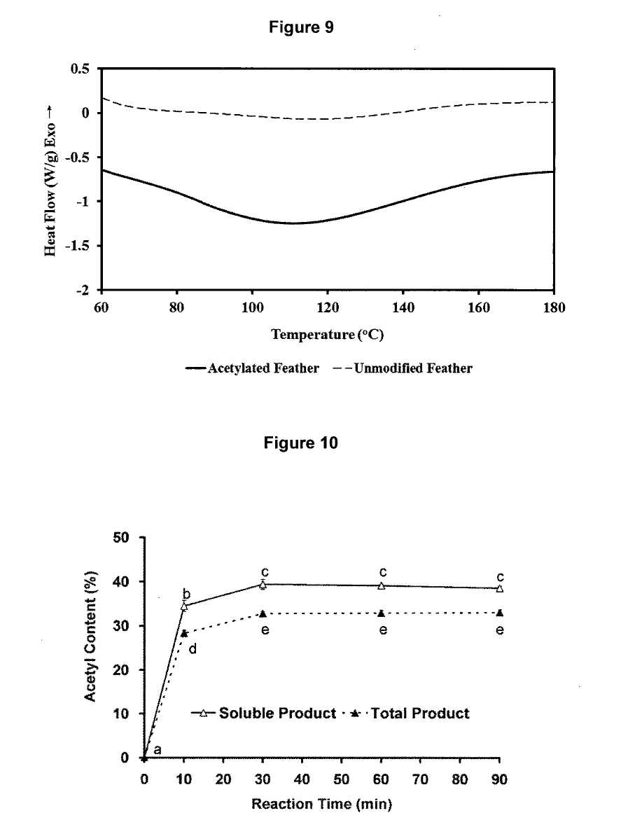

DSC thermograms in FIG. 9 showed that the acetylated chicken feathers had different thermal behavior than the unmodified chicken feathers. The DSC curve for the acetylated chicken feathers had a broad endothermic melting peak at around 115° C. indicating that the acetylated feathers were thermoplastic. The unmodified chicken feathers did not show any melting peak. It should also be noted that the melting temperature of the acetylated chicken feathers at about 115° C. is much lower than those of starch acetates (220-270° C.) and cellulose acetates (230-300° C.). The lower melting temperature of acetylated chicken feather is beneficial because high temperatures would damage the proteins and result in thermoplastic products with poor properties. It has been shown that feathers are thermally damaged when compression molded above 180° C. Therefore, lower melting temperatures are desirable to process the feathers into various products. However, the low melting temperature would be a constraint if feathers are mixed with polymers that have high melting temperatures to develop blend products. Similarly, feathers would not be suitable for applications where products are exposed to temperature higher or close to 115° C.

Biothermoplastics from Acetylated Chicken Feather

The unmodified and acetylated feathers were compression molded to verify the possibility of developing thermoplastics from the acetylated chicken feathers. The unmodified chicken feathers did not melt under the pressing conditions (20% glycerol, 170° C. for 15 minutes) used. However, the acetylated chicken feather melted and formed a transparent film indicating that the acetylated chicken feathers could be converted to various thermoplastic products.

This example showed that chicken feathers can be used to develop thermoplastic products after acetylation which is a green and relatively inexpensive process. Acetylation was performed under acidic conditions and under the optimized acetylation conditions the % acetyl content obtained was 7.2% after acetylating using 4:1 ratio of acetic anhydride to feathers, 10% catalyst and reaction temperature of 70° C. and reaction time of 60 minutes. The corresponding increase in weight of feathers was 10.6%. Pyrolysis-MS and FTIR confirmed acetylation of feathers. Acetylated feathers had a melting peak at about 115° C. and a slightly higher overall weight loss after thermal degradation. Acetylated feathers were compression molded to form transparent thermoplastic films. The low melting temperature of acetylated feathers provides an opportunity to develop feather thermoplastics without damaging the proteins. Acetylated poultry feathers may be used to develop inexpensive, biodegradable and environmentally friendly films, extrudates and other thermoplastic products

### Example 2

### Acetylation of DDGS

Acetylation of the oil-and-zein-free DDGS was performed using acetic anhydride in acetic acid, and sulfuric acid as the catalyst. Glacial acetic acid was added into the oil-and-zein-free DDGS at a 2:1 acetic acid to DDGS weight ratio at room temperature under constant stirring, followed by the addition of a specified amount of acetic anhydride, varied from 1:1 to 5:1 acetic anhydride to DDGS weight ratio. The ratio of sulfuric acid used as the catalyst was varied from 0 to 20% based on the weight of the DDGS used and the mixture was stirred at a temperature below 30° C. The acetylation was completed by heating the mixture containing DDGS, acetic acid, acetic anhydride and sulfuric acid for a specified time from 10 to 120 minutes at the specified temperature from 50 to 120° C.

After the reaction, the acetylated DDGS was centrifuged at 12,500×g for 15 minutes. After centrifugation, two layers, a layer of liquid at the top and a solid layer at the bottom were formed. The liquid part consisted of the acetylated products that dissolved in the reaction solution and are referred to as soluble products in this manuscript. The liquid layer was separated and 20% (w/w) aqueous sodium acetate was added to neutralize the acid and later water was added to precipitate the soluble products. The solid portion was neutralized and washed similarly to the liquid portion after centrifugation and dried at 40-50° C. in a hot air oven for 12 hours for further analysis. The solid portion obtained is referred to as the insoluble product. To determine the overall acetylation of DDGS, the soluble products were precipitated into the insoluble products and the combined product is referred to as the total product in this manuscript. For practical reasons, it is believed that it is economically more feasible to use the total product rather than use the soluble and insoluble portions separately. However, the soluble portion will have high acetyl content and is expected to be more thermoplastic than the insoluble and total product. Therefore, we have studied the acetyl content of the soluble and total products, respectively.

### Effect on % Acetyl Content

FIG. 10 depicts the effect of reaction time on the % acetyl content of the soluble and total products. As seen from FIG. 10, increasing reaction time from 10 to 30 minutes increased the % acetyl content for both the soluble and total products. Further increase in reaction time above 30 minutes did not increase the % acetyl content for either the soluble or total product, indicating that the reaction had reached equilibrium. The highest acetyl content of 32.7% and 39.9% were obtained for the total and soluble products, respectively, at a reaction time of 30 minutes. The existence of an insoluble product may be mainly due to the presence of lignin and the chemical linkages between some of the carbohydrates/proteins and lignin. It is believed that because of the higher solubility of the acetylated products with higher degrees of substitution (high % acetyl content) in the reaction solutions, and because of the insolubility of lignin and lignin connected carbohydrates and proteins, the soluble product had higher % acetyl content than the insoluble product.

### Effect on Weight and Relative Viscosity of Soluble Product

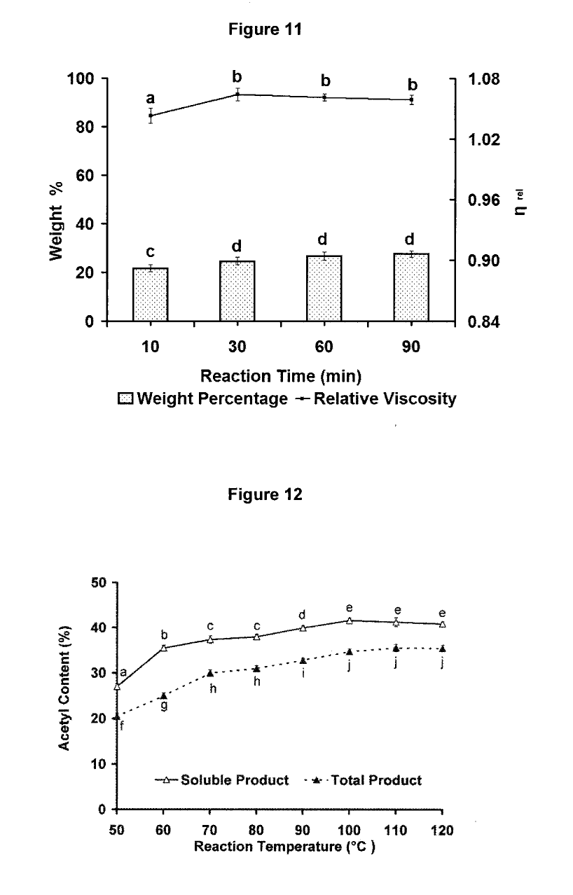

FIG. 11 shows the effect of reaction time on the amount (% weight based on the total product obtained after acetylation) and relative viscosity of the soluble product. Increasing reaction time from 10 to 30 minutes marginally increased the weight of the soluble product obtained, whereas the relative viscosity of the soluble product increased substantially. Increasing reaction time above 30 minutes did not change the % weight or the viscosity of the soluble product. Increasing acetylation (% acetyl content) increased the viscosity and hence the products obtained at 30 minutes had higher viscosity compared to the products obtained after 10 minutes of reaction. A reaction time of 30 minutes was the optimum to obtain the soluble product with good weight % and relative viscosity under the acetylation conditions studied.

### Effect of Reaction Temperature on % Acetyl Content

The effect of increasing reaction temperature on the % acetyl content of the soluble and total products is shown in FIG. 12. As seen from FIG. 12, increasing reaction temperature continually increased the % acetyl content of both the soluble and total products up to a temperature of 100° C. There was a relatively steep increase in the % acetyl content for the soluble product when the temperature was increased from 50 to 60° C. and moderate increase upon further increase in the reaction temperature. The highest acetyl content of 42% and 35% was obtained for the soluble and total products, respectively, at a temperature of 100° C. The % acetyl contents of both the soluble and total products did not increase upon further increase in reaction temperature above 100° C. Increasing temperature accelerated the acetylation reaction and also allowed the carbohydrates and proteins that are bound to each other and to lignin to be acetylated. As a result, an increase in the % acetyl content when the temperature was increased from 50 to 100° C. was observed. However, the acetyl content did not increase above 100° C. since most of the functional groups in the proteins and carbohydrates had been acetylated.

### Effect of Reaction Temperature on Weight and Relative Viscosity of Soluble Product

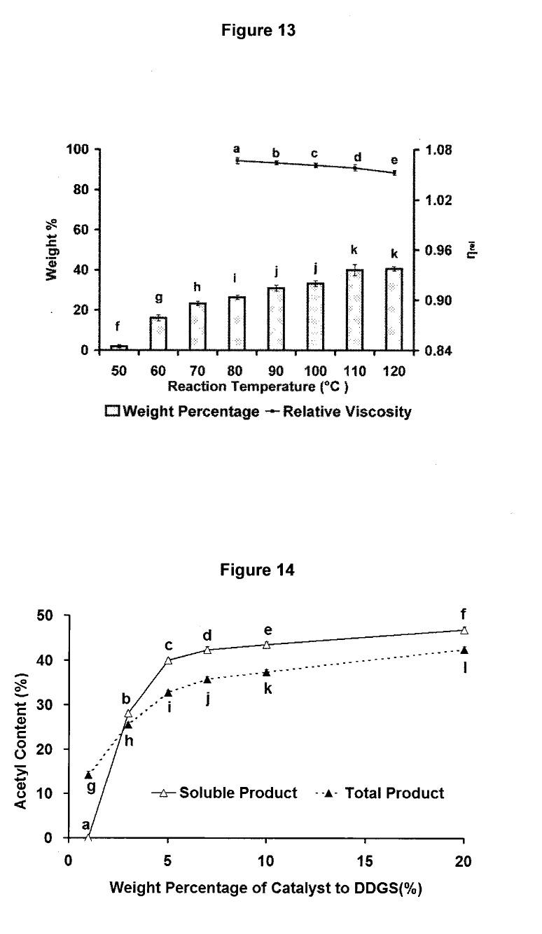

Increasing temperature considerably increased the weight but decreased the relative viscosity of the soluble product as seen from FIG. 13. The highest weight of the soluble product obtained was 40% at a temperature of 110° C. but the relative viscosity was comparatively low at that temperature. The weight of the soluble product obtained does not change whereas the relative viscosity decreases when the temperature is increased above 110° C. The increase in weight of the soluble product with increasing temperature up to 110° C. is believed to have been due to continued acetylation of the components in DDGS as seen from FIG. 12. The decrease in relative viscosity is believed to be due to the hydrolysis of the carbohydrates and proteins under acidic conditions, especially at high temperatures. The weight of the soluble product obtained increased from 33 to 40% when the temperature was increased from 100 to 110° C., although the % acetyl content remained the same. This is believed to be due to the increased solubility of those polymers with low % acetyl content as indicated by the low relative viscosity and those that are attached to lignin becoming soluble at high temperatures. It is believed that the temperature of the acetylation reaction may be selected based on the amount and the viscosity of the soluble product desired for a particular application. It is believed that a temperature between 90-100° C. appeared to be the optimum temperature to obtain the soluble products with good weight % and relative viscosity under the conditions used for the acetylation.

### Effect of Catalyst Concentration on % Acetyl Content

The effect of weight of catalyst used on the acetyl content of the soluble and total product is shown in FIG. 14. As seen from FIG. 14, catalyst concentration had considerable effect on the % acetyl content of both the soluble and total products. At a low level (1%) of catalyst, the soluble product does not show any acetylation and the total product had an acetyl content of about 15%. Increasing the catalyst concentration from 1 to 3% increased the acetyl content to about 27% for both the soluble and total products. Further increase in catalyst concentration continually increased the acetyl content for both the soluble and total product. The highest % acetyl content of 42.5% and 46.8% for the total and soluble products, respectively, was obtained at a catalyst concentration of 20%. The acetyl content of the soluble product at 46.8% is higher than the highest theoretical acetyl content of cellulose triacetate (44.8%), suggesting the degradation, probably hydrolysis, of the carbohydrate polymers at high catalyst concentrations.

### Effect of Catalyst Concentration on Weight and Relative Viscosity of Soluble Product

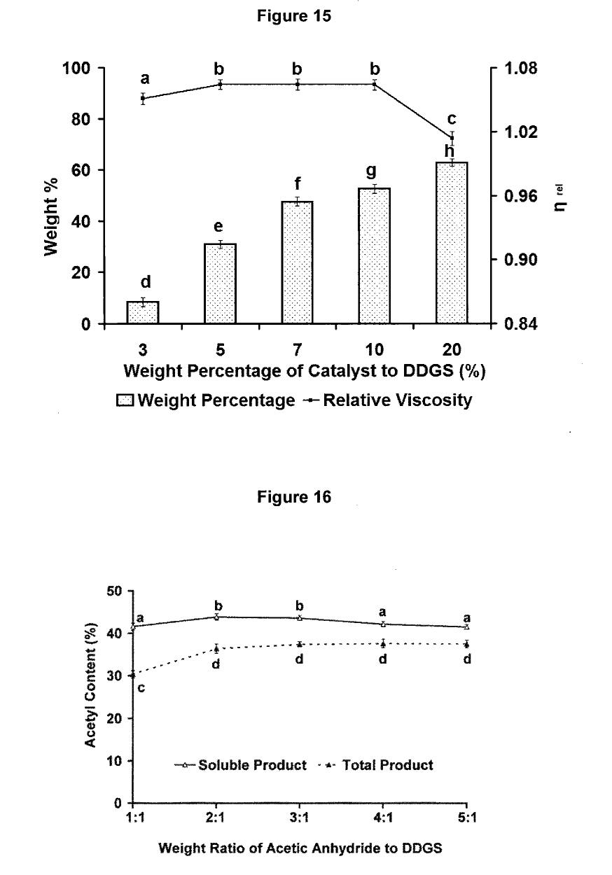

FIG. 15 shows the effect of increasing catalyst concentration on the weight and viscosity of the soluble product obtained. At low catalyst concentration (3%), less than 15% of the soluble product was obtained but the weight of the soluble product was more than doubled when the catalyst concentration was increased to 5%. Further increases in catalyst concentration increased the weight of soluble product and the highest weight of soluble product obtained was about 63% at a catalyst concentration of 20%. However, the relative viscosity of the soluble product obtained at 20% catalyst concentration was substantially lower compared to the relative viscosity at other catalyst concentrations. At higher catalyst concentrations, the excessive sulfuric acid caused the degradation of carbohydrates and proteins, indicated by the decrease in relative viscosity. A catalyst concentration of 10% seemed to be the optimum to obtain the soluble product with good weight % and relative viscosity under the specified acetylation conditions.

### Effect Acetic Anhydride Concentration on % Acetyl Content

The effect of increasing the weight ratio of acetic anhydride to DDGS on the acetyl content of soluble and total products is shown in FIG. 16. The acetyl content increased for both the soluble and total product when the ratio of acetic anhydride was increased from 1:1 to 2:1, remained the same up to an acetic anhydride ratio of 3:1, but slightly decreased for the soluble product at anhydride concentrations of 4:1 and 5:1. At a ratio of 1:1, there was insufficient anhydride to react with the hydroxyl and amine groups in the carbohydrates and proteins, and hence there was a low level of acetylation especially for the total product. It is believed that, for this example, increasing the anhydride ratio of 2:1 yielded no increase in acetyl content. The acetyl content of the soluble product obtained with an acetic anhydride ratio of 2:1 was 43.8% which corresponds to a degree of substitution of 2.9. Such a high degree of acetylation at low ratios of anhydride has not been achieved for starch acetates using alkaline conditions for acetylation. Previously, starch acetates obtained with an acetic anhydride ratio of 2:1 had degrees of substitution ranging from 1.1 to 1.7. Using such relatively low amounts of acetic anhydride substantially reduces the cost of acetylation and also makes the process more environmentally friendly.

### Effect Acetic Anhydride Concentration on Weight and Relative Viscosity of Soluble Product

Increasing acetic anhydride concentration did not change the weight or the viscosity of the soluble product obtained. About 43% of soluble product was obtained and the relative viscosity remained constant at about 1.06 at various ratios of acetic anhydride to DDGS studied.

### ¹HNMR Spectra of Soluble Product

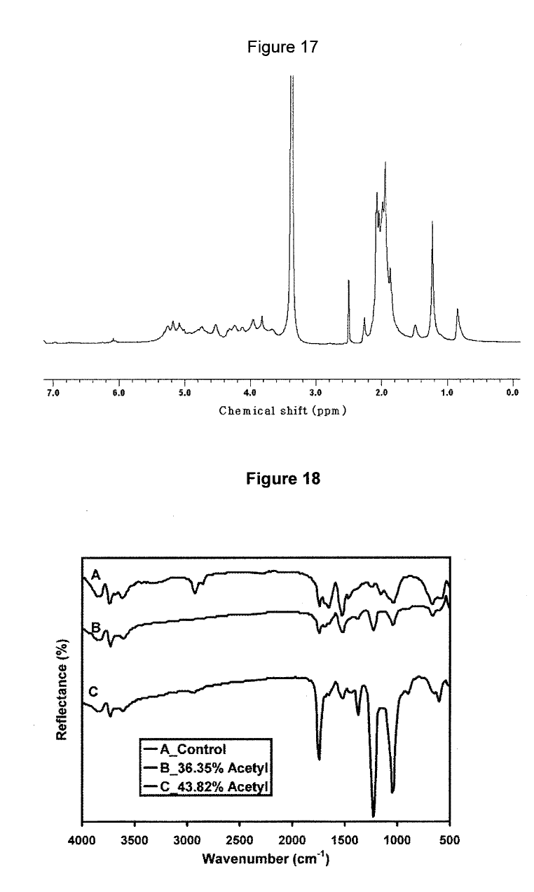

The 1HNMR spectrum of the soluble product with an acetyl content of 43.8% is shown in FIG. 17. The peak position of proton had a chemical shift in the range of 3.5-5.1 ppm and the methyl protons of acetyl groups displayed a resonance signal in the range of 1.9-2.2 ppm. The position of the peaks suggests that the soluble product contains a large amount of carbohydrate esters indicating successful acetylation as reported for cellulose acetates and other carbohydrate derivatives.

### FTIR Measurement

The FTIR spectra of unmodified DDGS and soluble and total products are shown in FIG. 18. Compared to native DDGS, the acetylated DDGS had a strong absorbance peak at 1745-1754 cm-1 attributed to the stretching of the ester carbonyl C═O indicating the acetylation of DDGS. In addition, the peak at 1250 cm-1 in the fingerprint region, characterized as the COC ester stretching, also increased for the acetylated DDGS, further confirming acetylation of DDGS. There was no absorbance at 1840-1760 cm-1, or at around 1700 cm-1, indicating the absence of free acetic anhydride in the acetylated DDGS being tested.

### Thermal Analysis

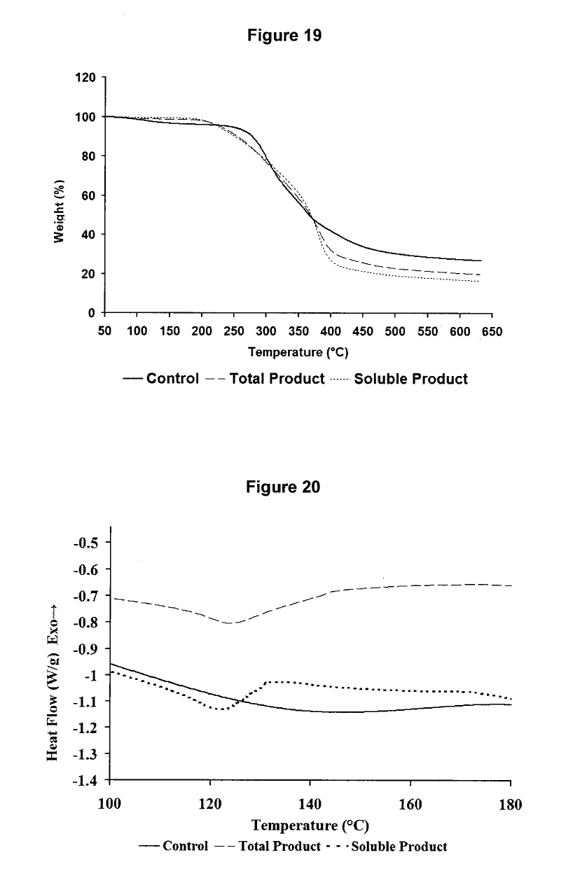

The thermal properties of the acetylated DDGS are important for eventual use of DDGS as a thermoplastic product. FIGS. 19 and 20 contain TGA and DSC thermograms, respectively, for the unmodified DDGS and the total and soluble acetylated products. There was negligible weight loss up to a temperature of 200 and 240° C. for the unmodified and acetylated DDGS, respectively, and the weight loss increased substantially above these respective temperatures as seen from the TGA curves in FIG. 19. The acetylated DDGS had relatively low thermal stability and therefore higher weight loss than the unmodified DDGS above 220° C. because acetate has lower thermal stability than hydroxyl. The acetylated DDGS also had a higher total weight loss than the unmodified DDGS due to the same reason. The soluble product had a total weight loss of 84% compared to 80% for the total product. The unmodified DDGS had a lower total weight loss of 73% compared to the acetylated DDGS.

As shown from FIG. 20, the soluble acetylated DDGS had a melting peak at about 120° C., and the total acetylated product had a melting peak at about 125° C. These melting peaks are from the acetylated proteins and carbohydrates. The soluble product had a melting peak with a higher enthalpy of 4.2 J/g, higher than the enthalpy of 2.7 J/g for the total product, because of the higher % acetylation of the soluble product than the total product, and the existence of lignin and other materials in the total product.

The 80° C. difference between the melting point and thermal decomposition temperature suggested that the acetylated DDGS could be thermally manipulated without damaging the materials, and that the thermoplastic products developed from acetylated DDGS can be expected to have good mechanical properties.

Biothermoplastics from DDGS

Both the soluble and the total products were converted to plastics at a temperature of 138° C. for 2 minutes, although the soluble product provided a more transparent thermoplastic than the total product. The thermoplastic obtained from the total product contained relatively large particles that had not completely melted due to the lower thermoplasticity of the total product compared to the soluble produce. The larger particles could have been melted if higher temperatures or longer compression times were used. The unmodified DDGS was not changed under the pressing conditions and was only loosely compacted.

### Conclusions

This research demonstrates that oil-and-zein-free corn DDGS may be acetylated and used to develop biothermoplastics. Unlike conventional cellulose and starch acetylation, the acetylation process disclosed herein may be performed with low levels of acetic anhydride and still generate products with high % acetyl contents leading to low cost acetylation. Acetylation resulted in two types of product, those soluble and insoluble in acetic anhydride. The soluble product had high % acetyl content of 43.8%, very close to that of cellulose triacetate (44.8%) and the insoluble product had an acetyl content of 42.5%, equivalent to a DS value of 2.7. The highest acetyl content of 43.8% equivalent to a degree of substitution of 2.9 was obtained for the soluble product at an acetic anhydride to DDGS ratio of 2:1, catalyst concentration of 10% and reaction temperature and time of 90° C. for 30 minutes, respectively. An overall weight gain of 40% was obtained for the total product compared to the weight of the DDGS used for acetylation and up to 63% of the DDGS used could be obtained as the soluble product with high levels of acetylation. 1HNMR analysis of the soluble product shows the chemical shift of methyl protons of the acetyl group at δ=1.9-2.2 ppm and FTIR analysis shows the presence of ester groups confirming acetylation of DDGS. The soluble and total products have melting peaks at 120 and 125° C., respectively, about 100° C. below their starting thermal decomposition temperatures, and both products were compression molded to develop biothermoplastics. Since oil-and-zein-free DDGS is inexpensive and the acetylation process uses low levels of acetic anhydride and temperatures below 100° C., thermoplastics that are highly competitive price-wise to cellulose and starch acetates may be produced.

### Example 3

### Comparison of Acid and Alkaline Catalysts in Acetylation of DDGS

The oil-and-zein-free DDGS was acetylated using acetic anhydride and sodium hydroxide solution (50%, w/w) as the catalyst. Initially, acetic anhydride was added to oil-and-zein-free DDGS (3:1 ratio of anhydride to DDGS) and allowed to react for 60 minutes at room temperature. After the reaction, saturated sodium hydroxide (50% w/w in water) was added (10 to 100% w/w, based on weight of DDGS) as the catalyst maintaining the DDGS between −5° C. to +5° C. using an ice bath for 30 minutes. The acetylation reaction was then completed by heating the DDGS mixture for a specific time (10 to 120 minutes) at a specific temperature (90 to 130° C.). For temperatures above 100° C., the reaction was performed in sealed high pressure canisters using an oil bath. After the reaction, cold water was added into the canister to precipitate the acetylated products. The products were later thoroughly washed until they were neutral.

Acetylation under acidic conditions was also performed. Sulfuric acid was used as the catalyst and the ratio of anhydride to DDGS was varied from 1:1 to 5:1, catalyst concentrations from 0 to 20% based on the weight of the DDGS were used, temperatures from 50 to 120° C. and times from 10 to 120 minutes.

### Effects of Catalyst Concentration on % Acetyl Content of DDGS Acetates

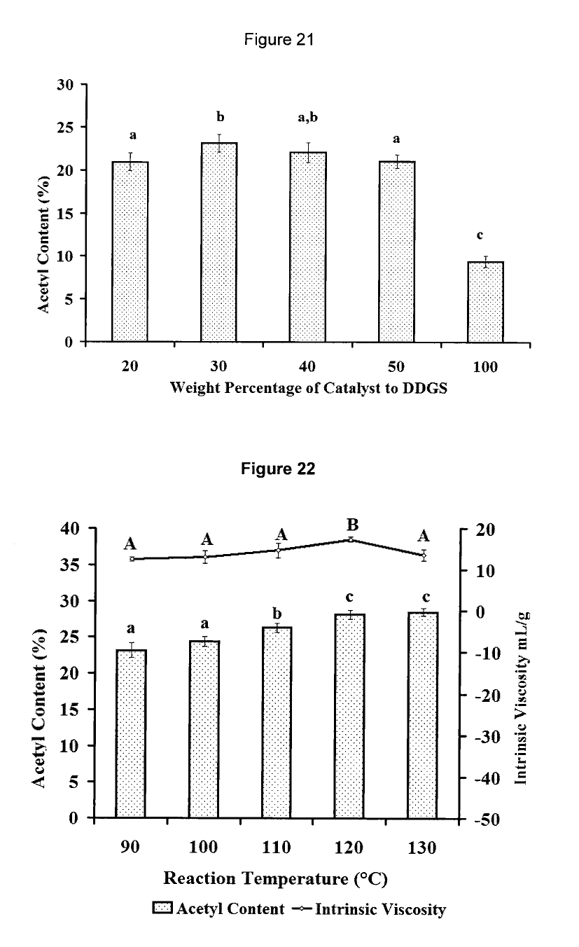

FIG. 21 depicts the effect of changing the % of catalyst (sodium hydroxide) on the acetyl content of DDGS. Increasing catalyst concentration from 20 to 30% increased the % acetyl content by about 11%. Increases in catalyst concentration from 30 to 40 and from 40 to 50% did not increase the % acetyl content significantly. However, the % acetyl content decreased substantially to 9.4% when the amount of catalyst used was equal to 100% of the weight of DDGS. The highest acetyl content obtained was 23% at a catalyst concentration of 30% and was used for the optimization of other acetylation parameters of this example. The decrease in the % acetyl content at 100% catalyst was mainly due to the hydrolysis of the protein and carbohydrates under strong alkaline conditions and high temperatures. The catalyst (sodium hydroxide) was added into the reaction as a saturated solution (50% w/w) in water because sodium hydroxide does not dissolve in acetic anhydride. The addition of water and the presence of high amounts of alkali at high temperatures lead to the hydrolysis of the proteins in DDGS and hence the % acetyl content decreased.

### Effects of Temperature on % Acetyl Content and Intrinsic Viscosity of DDGS Acetates

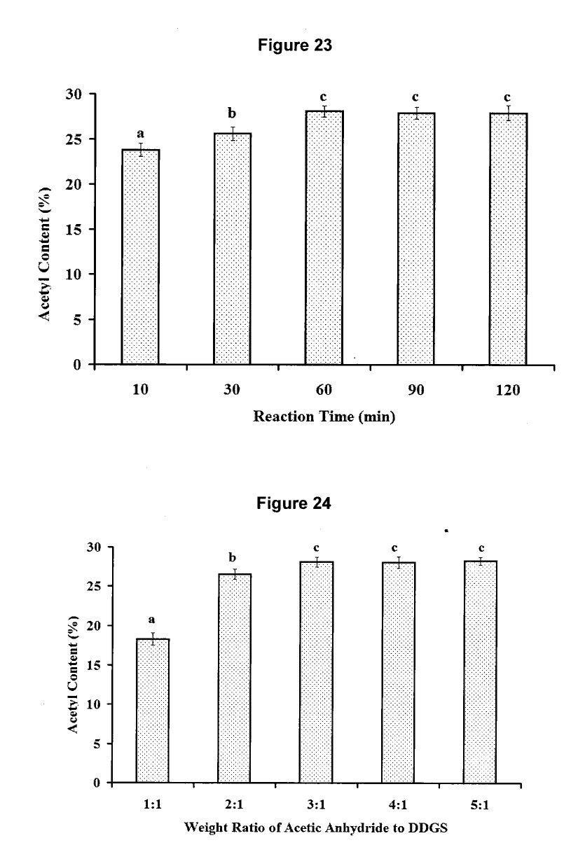

FIG. 22 shows the effect of increasing reaction temperature on the % acetyl content and intrinsic viscosity of the acetylated DDGS. Increasing reaction temperature from 90 to 130° C. increased the acetyl content by about 23%. A highest acetyl content of 28.5% was obtained when the reaction was carried out at 130° C. However, as seen from FIG. 23, the intrinsic viscosity of the DDGS acetate obtained at 130° C. was significantly lower than the viscosity of the DDGS acetate obtained at 120° C. Increasing reaction temperature increased the accessibility of the proteins and carbohydrates to chemicals and also increased the acetyl content and therefore the intrinsic viscosity. At high temperatures (130° C.) and in the presence of alkali and water, some of the proteins and carbohydrates in DDGS were hydrolyzed and therefore the intrinsic viscosity decreased. Since the DDGS acetate obtained at 120° C. has similar acetyl content but higher viscosity compared to that obtained at 130° C., a temperature of 120° C. was chosen to optimize the other acetylation conditions of this example.

### Effects of Reaction Time on % Acetyl Content of DDGS Acetates

Increasing reaction time from 10 to 30 minutes and from 30 to 60 minutes increased the % acetyl content by 7.6 and 9.7%, respectively, as seen in FIG. 23. Further increases in reaction time above 60 minutes did not change the % acetyl content. The initial increase in acetyl content with the increase in temperature is believed to be due to the better acetylation of DDGS. More carbohydrates and proteins are acetylated with increasing time and therefore the % acetyl content increased. However, the acetylation reaction reached equilibrium at 60 minutes and therefore there was no increase in the % acetyl content when the reaction time was increased above 60 minutes under the reaction conditions studied.

### Effects of Ratio of Acetic Anhydride on % Acetyl Content of DDGS Acetates

A relatively low ratio of acetic anhydride to DDGS (2:1) was sufficient to provide high acetyl content (26.5%) as seen in FIG. 24. Increasing the ratio of acetic anhydride above 2:1 marginally increased the acetyl content to 28.1% but the acetyl content remained the same at acetic anhydride ratios of 4:1 and 5:1 (28.1 and 28.2%, respectively). It is believed that the number of accessible hydroxyl groups reached equilibrium at an anhydride ratio of 3:1 and as a result an increase in % acetyl content was not realized with an increasing ratio of anhydride.

### ¹H NMR Spectra of DDGS Acetates

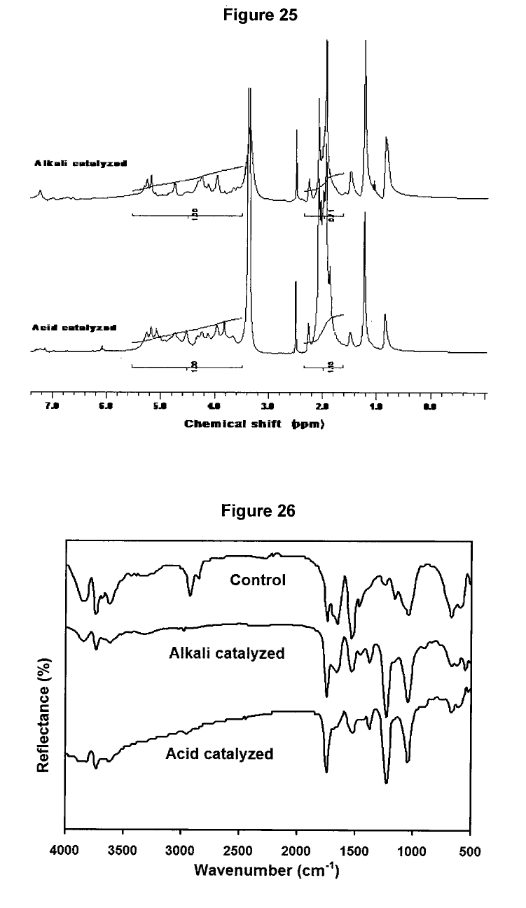

The 1H NMR spectrums of the unmodified and acetylated DDGS are shown in FIG. 25. The presence of large number of peaks in the range of 1.9-2.2 ppm (absorbance of methyl protons from the acetyl groups) confirmed the presence of carbohydrates esters formed due to acetylation. The integral area of the curve between 1.9-2.2 ppm for the DDGS obtained using alkaline catalysts was 0.7 and 1.13 for the DDGS acetates formed under acidic catalysis. The higher peak area for the DDGS acetates formed under acidic catalysis confirmed the presence of a higher number of acetyl groups and therefore higher degree of substitution than the DDGS acetates formed under alkaline conditions.

### FTIR Measurements

FIG. 26 shows the FTIR curves of the unmodified and acetylated DDGS. The presence of strong absorbance peaks between 1745-1754 cm-1 belonging to the stretching of the ester carbonyl C═O group and the strengthening of the COC ester stretching peak at 1250 cm-1 for the acetylated DDGS confirmed acetylation. However, the heights of the peaks are different for the DDGS acetates obtained using alkaline and acidic catalysts. The length of the C═O stretching peak at 1750 cm-1 is 3.4 cm for DDGS acetate formed under alkaline conditions and 2.9 cm for the DDGS acetate obtained under acidic conditions. Using the aromatic peak at 1510 cm-1 as a reference, the ratio of height of the peaks at 1750 and 1510 cm-1 for DDGS acetate formed under alkaline conditions was 2 and 2.9 for the DDGS acetates obtained under acidic conditions. This shows that the DDGS acetates obtained using acidic catalysts had higher acetyl content.

### Thermal Analysis

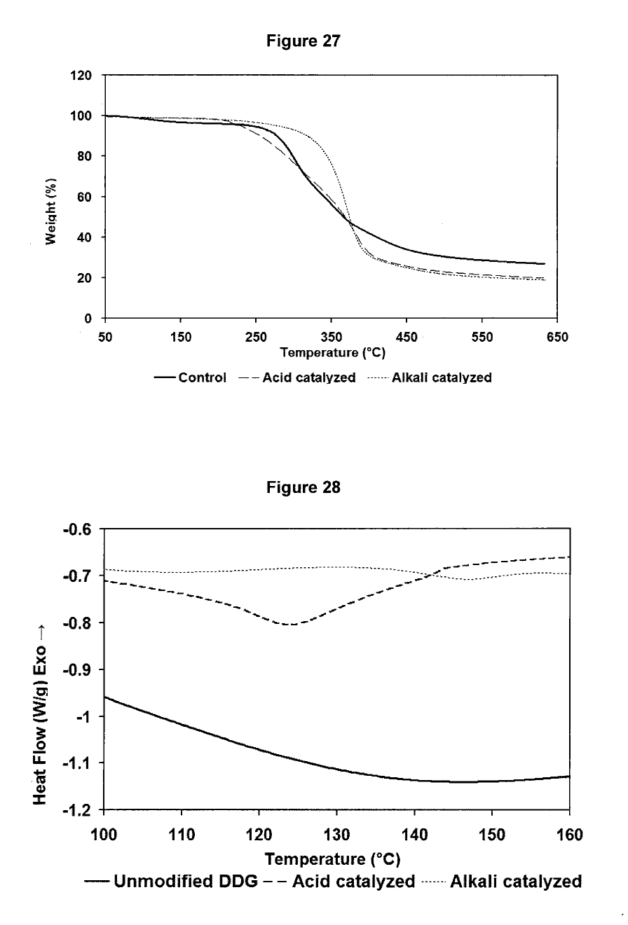

The thermal behavior of the acetylated DDGS obtained using acidic and alkaline catalysts are compared to the unmodified DDGS in FIG. 27. The unmodified and acetylated DDGS had similar thermal degradation up to about 220° C. Above 220° C., the degradation of the DDGS acetates formed under acidic catalysis was similar to that of unmodified DDGS whereas the DDGS acetates obtained under alkaline catalysis had lower thermal degradation. The better thermal stability of the DDGS acetates obtained under alkaline conditions was most likely due to less protein in the alkaline DDGS acetates than DDGS acetates obtained using acidic catalysts. A large portion of protein in DDGS acetates were probably hydrolyzed under the strong aqueous alkaline and high temperature conditions used for alkaline catalysis. The hydrolyzed proteins were removed from the acetates resulting in carbohydrates and remaining proteins that had high thermal stability. However, both the DDGS acetates had higher final weight loss than the unmodified DDGS. The overall weight loss of the DDGS acetates was about 80% compared to 73% for the unmodified DDGS. The higher degradation of the DDGS acetates compared to the unmodified DDGS was mainly due to the presence of the acetyl groups that make the DDGS acetates unstable. Acetylated DDGS will be decomposed more readily and therefore has higher weight loss than that of the unmodified DDGS.

DSC thermograms in FIG. 28 show that the DDGS obtained using the alkaline catalyst had considerably different thermal behavior than the DDGS acetates obtained using the acid catalyst. DDGS acetates formed under acidic catalysis had a melting peak at about 125° C. whereas the DDGS acetates catalyzed by alkali had a relatively small melting peak at a temperature of about 147° C. The melting enthalpy for the DDGS acetates formed under acidic conditions was 4.2 J/g whereas DDGS acetates formed under alkaline conditions had a much lower melting enthalpy of 0.5 J/g. Under alkaline acetylation conditions, proteins will be hydrolyzed whereas the carbohydrates are relatively unaffected compared to acetylation under acidic conditions. Because most of the hydrolyzed proteins are removed during washing, the DDGS acetate obtained under alkaline conditions had better thermal stability and hence a higher melting point compared to the DDGS acetates formed under acidic conditions. However, the DDGS acetate obtained under alkaline conditions had much lower acetyl content (28.1% corresponding to a DS value to 1.5) compared to the DDGS acetates formed under acidic conditions which had an acetyl content of 36.1% (DS value of 2.1). Therefore, the DDGS acetate obtained under acidic conditions had higher melting enthalpy and was expected to have better thermoplasticity than the DDGS acetates obtained using alkaline catalysts.

### Comparison of Alkaline and Acid Catalysis of Carbohydrates and Proteins in DDGS

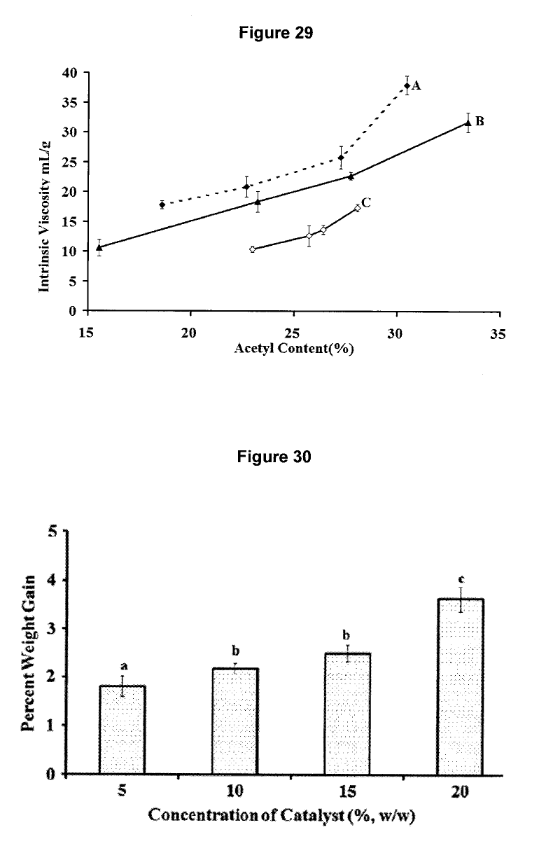

FIG. 29 shows the comparison of the intrinsic viscosity and % acetyl content of the DDGS acetates obtained using alkaline and acidic catalysis at various acetylation conditions. As shown in FIG. 29, the DDGS acetates obtained under alkaline conditions had much lower intrinsic viscosity than the DDGS acetates obtained using acidic catalysts at various acetylation conditions. The viscosity of the DDGS acetates obtained under alkaline conditions varied from 10.3 to 17.4 when the ratio of anhydride to DDGS was varied from 1.5:1 to as high as 3:1 (Curve C). Acidic conditions provided much higher intrinsic viscosity even at substantially lower ratios of anhydride to DDGS. The intrinsic viscosity of the DDGS acetates obtained using acidic catalysts varied from 10.6 to 31.8 when the ratio of anhydride to DDGS was varied from 0.5:1 to 1.5:1 (Curve B).

DDGS acetates obtained using an acid catalyst also had considerably higher % acetyl content and therefore better thermoplasticity than DDGS acetates obtained using an alkaline catalyst at similar ratios of acetic anhydride. The highest % acetyl content obtained for alkaline catalysis was 28.1% at an acetic anhydride to DDGS ratio of 3:1 whereas the % acetyl content for the acid DDGS at anhydride to DDGS ratio of 3:1 was 37.3%. Acid catalysis was able to provide a high acetyl content of 36.1% even at a low anhydride to DDGS ratio of 2:1. The lower intrinsic viscosity and % acetyl content of the DDGS acetates obtained under alkaline conditions shows that alkaline catalysis is less favorable for acetylation of the carbohydrates and proteins in DDGS compared to acidic catalysis. It is believed that the better acetylation of DDGS under acidic conditions than alkaline conditions was due to the following reasons. First, alkaline catalysis required high temperatures (120° C.) under high concentrations of catalyst (30% w/w) for 60 minutes to achieve good acetylation, similar to the conditions used for acetylating starch. Second, alkali (NaOH) used as catalyst did not dissolve in acetic anhydride and therefore high concentrations of alkali solution in water were used as the catalyst. Under these conditions, proteins and to some extent carbohydrates will be hydrolyzed. Third, carbohydrates were oxidized in the presence of strong alkali leading to a decrease in the molecular weight. Fourth, alkaline media also caused isomerization of the carbonyl groups in the carbohydrates resulting in depolymerization. Therefore, the intrinsic viscosity of the DDGS acetates obtained using alkaline catalysts was low.

Acid catalysis was performed under relatively mild conditions and without the presence of water. Therefore, there was limited hydrolysis and decrease in molecular weight of the proteins and carbohydrates. The amount of catalyst required for acid catalysis was also low, about 10% compared to 30% for the alkaline catalysis. In fact, acid concentration of 5% provided the highest intrinsic viscosity and acetyl content but with an anhydride to DDGS ratio of 2:1 as seen from FIG. 29.

The better thermoplasticity of the DDGS acetates obtained using acid catalysts was also evident from the thermoplastic DDGS acetates films. DDGS acetate obtained using alkaline catalyst are less transparent compared to the DDGS acetates obtained using acid catalysts whereas the unmodified DDGS was non-thermoplastic and did not melt. The acid DDGS acetates were made into films by compression molding at 138° C. for 2 minutes whereas the alkaline DDGS acetates required much higher temperature (170° C.) and longer times (5 minutes) to form films also indicating the relatively poor thermoplasticity (low % acetyl content) of the DDGS acetates obtained using alkaline catalysts. SEM images also showed that the DDGS alkaline acetates and acid acetates melt and have a smooth and non-particulate surface whereas the unmodified DDGS did not melt and had many particles on the surface.

### Conclusions

This example showed that the acetylation using acidic catalysts provided substantially higher acetyl content and intrinsic viscosity at low ratios of anhydride and catalyst concentrations compared to alkaline catalysis of the carbohydrates and proteins in DDGS. Alkaline catalysis required high temperatures (120° C.) and catalyst concentrations (30%), which hydrolyzed the proteins and the carbohydrates to some extent resulting in DDGS acetates with low % acetyl content and intrinsic viscosity. DDGS acetates with highest acetyl content of 28.1% and intrinsic viscosity of 17.4 were obtained using an anhydride to DDG ratio of 3:1 and 30% catalyst for alkaline catalysis whereas similar acetyl content (27.8%) but higher intrinsic viscosity (22.7) were obtained under acidic conditions using a much lower anhydride to DDGS ratio of 1:1 and 10% catalyst or anhydride ratio of 2:1 and catalyst concentration of 4%. Both FTIR and 1H-NMR confirmed acetylation and the higher % acetyl content in DDGS acetates obtained using acid catalysts. DDGS acetates obtained using acid catalyst also had lower melting temperature and higher melting enthalpy resulting in more transparent thermoplastics than the DDGS acetates obtained using alkaline catalysts.

### Example 4

### Cyanoethylation of Chicken Feather

To perform the cyanoethylation, chicken feather was mixed with equal amounts of various concentrations 5, 10, 15, 20% (w/w) of aqueous sodium carbonate for 15 minutes at room temperature. Acrylonitrile was then added into the feathers at an acrylonitrile to feather weight ratio of 8:1 under constant mixing until the temperature reached 40° C. The cyanoethylation was completed by heating the mixture containing chicken feather, acrylonitrile, and sodium carbonate for 2 hours at 40° C. At the end of the reaction, the products formed were added into 50% ethanol to ensure complete removal of acrylonitrile and the products obtained were later neutralized with acetic acid (20% w/w). The precipitate obtained was first washed with ethanol, then thoroughly with distilled water at 50° C. for 30 minutes and repeated five times, followed by absolute ethanol and finally dried in an oven at 50° C. for 12 hours. To exclude the effect of alkali on the thermoplasticity of the feathers, the reaction was performed under the same conditions (40° C., 2 hours) using 20% sodium carbonate but without acrylonitrile.

The amount of acrylonitrile consumed by the feathers was determined by titrating the double bonds in acrylonitrile using potassium bromate. Based on the differences in the double bonds in acrylonitrile before and after the reaction, it was found that less than 2% of the acrylonitrile was consumed and the remaining acrylonitrile could be reused for etherification. Therefore, the cost of etherification will be low even though relatively high ratio of acrylonitrile to feathers was used for the reaction.

### Effects of Catalyst Concentration on Percent Weight Gain of Cyanoethylated Chicken Feathers

FIG. 30 shows the effect of increasing the catalyst (sodium carbonate) concentration on the percent weight gain of cyanoethylated chicken feathers. As seen from FIG. 30, increasing the catalyst concentration from 5 to 10% significantly increased the weight gain. The weight gain obtained at a catalyst concentration of 10% was 2.2% and at ratio of 15% catalyst, the % Weight Gain was slightly higher at 2.5% but the weight gain at 15% catalyst concentration was not significant compared to the weight gain at 10%. However, the p value for the weight gains between 10 and 15% was 0.0698 indicating that the weight gains were close to being significant. The highest % Weight Gain obtained was 3.6% at a catalyst concentration of 20% and when the pH was 11.6. Solubility of sodium carbonate reached saturation (21.7%) at 20° C. and we therefore did not use catalyst concentrations higher than 20% [16]. Increasing weight gain with increasing catalyst concentration indicates better reaction between the acrylonitrile and feathers. The alkali used as catalyst could hydrolyze the feathers and also affect the thermoplasticity of the feathers. However, the weight of the feathers treated with 20% sodium carbonate but without acrylonitrile did not show any change in weight after treatment indicating that the feathers were not damaged (hydrolyzed) during the treatment.

### FTIR Measurements

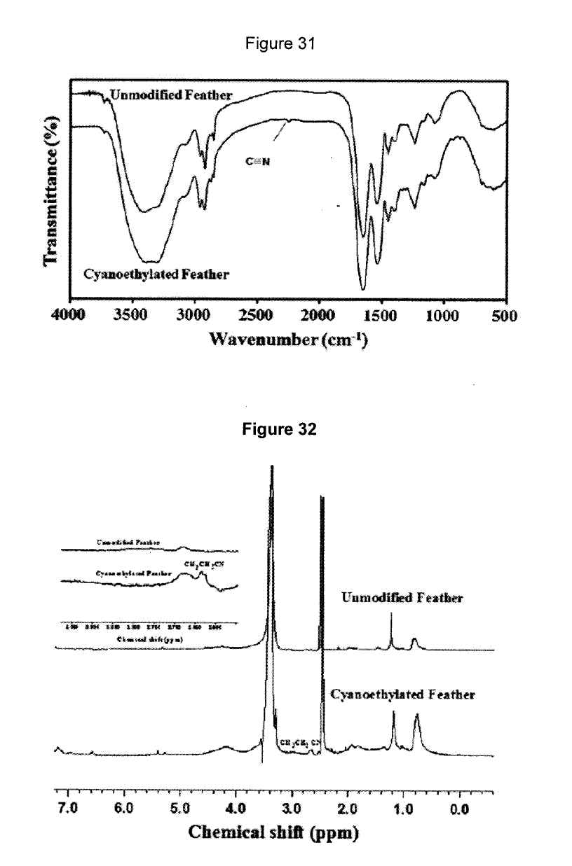

FIG. 31 shows the FTIR spectra of the unmodified and cyanoethylated chicken feathers.

The absorption peak attributed to the stretching of nitrile groups in acrylonitrile was seen at 2260 cm-1 for the modified feather but was not seen in the unmodified feather thereby confirming cyanoethylation.

### ¹H NMR Spectra of Unmodified and Cyanoethylated Chicken Feathers

The 1H NMR spectrums of the unmodified and cyanoethylated chicken feather are shown in FIG. 32. In 1H NMR spectra, the signals due to cyanoethylated methylene protons (—CH2CH2CN) δ 2.6-2.8 ppm are present (inset) in the modified chicken feather but are not seen in the unmodified chicken feather. The appearance of the peak due to the methylene protons in the 1H NMR spectrum indicated cyanoethylation.

### P-GC-MS Spectra of Unmodified and Cyanoethylated Chicken Feathers

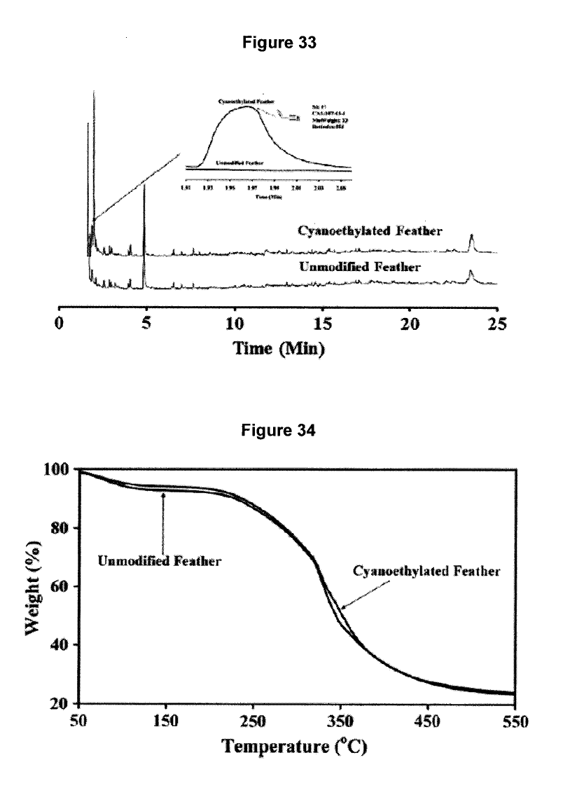

The P-GC-MS spectrums of the unmodified and cyanoethylated chicken feather are shown in FIG. 33. The P-GC-MS peaks were assigned with the help of a library spectrum. In P-GC-MS spectra, the signals due to pyrolysis of cyano group (—CH2CH2CN) at 1.965 minute can be seen in the modified chicken feather but are not seen in the unmodified chicken feather. The appearance of the peak due to the cyano group in the P-GC-MS spectrum confirms the cyanoethylation of chicken feather [20].

### Thermal Analysis

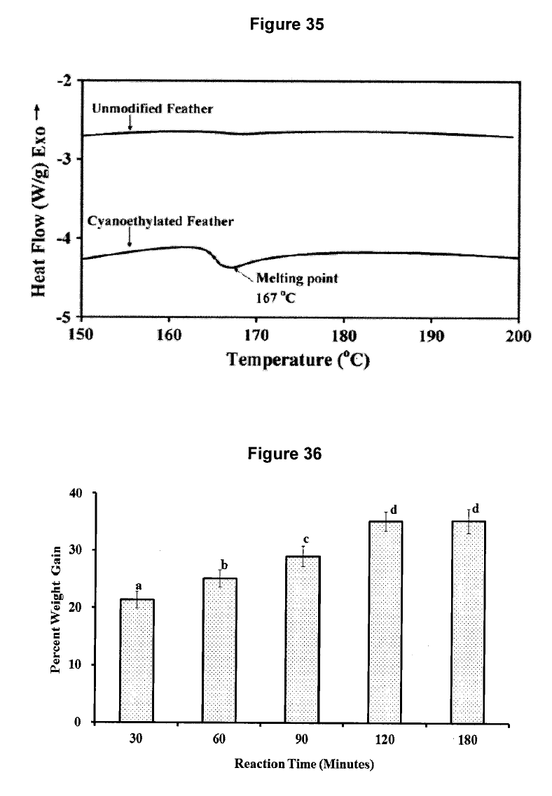

The thermal behavior of the cyanoethylated chicken feather was compared to the unmodified chicken feather in FIGS. 34 and 35. FIG. 34 shows that the cyanoethylated chicken feather had similar thermal stability compared to the unmodified chicken feather. Both the samples show a starting degradation temperature of 240° C. and similar weight loss of about 77% after heating to 550° C.

DSC thermograms in FIG. 35 showed that the cyanoethylated chicken feathers had different thermal behavior than the unmodified chicken feathers. The DSC curve for the cyanoethylated chicken feathers had an endothermic melting peak at around 167° C. that should be due to the introduction of cyano group onto chicken feathers [20]. The unmodified chicken feathers did not show any melting peak. The melting temperature obtained from DSC was corroborated by the melting of the feathers at 180° C. during compression molding. However, 20% glycerol and high pressure were necessary to obtain films from cyanoethylated feathers. In addition, it should also be noted that the melting temperature of the cyanoethylated chicken feathers at about 167° C. is much lower than those of starch acetates (270-315° C.) and cellulose acetates (230-300° C.) [21, 22]. The lower melting temperature of cyanoethylated chicken feather is beneficial because high compression temperatures would damage the proteins and result in thermoplastic products with poor properties.

Biothermoplastics from Cyanoethylated Chicken Feather

The unmodified and cyanoethylated feathers were compression molded. The unmodified chicken feathers did not melt under the compression conditions used (20% glycerol, 2 minutes at 180° C.). Similarly, films treated with 20% sodium carbonate but without acrylonitrile were also non-thermoplastic and could not be compression molded into films. However, the modified chicken feather melted and formed a transparent film indicating that the cyanoethylated chicken feathers had good thermoplasticity.

The tensile properties of the films developed from feathers cyanoethylated to 1.8, 2.2, 2.5, and 3.6% Weight Gains using catalyst concentrations of 5, 10, 15 and 20%, respectively are shown in Table C. The etherification was performed at 40° C. for 120 minutes with acrylonitrile to chicken feather ratio of 8:1 and catalyst concentrations ranging from 5 to 20%. The films were compression molded at 170° C. for 2 minutes after mixing with 20% (w/w) glycerol.

TABLE C

| | Tensile Strength | Elongation, | Modulus, |
|---|---|---|---|
| % Weight Gain | (MPa) | (%) | (MPa) |
| 1.80 | 4.2 ± 1.5 | 5.8 ± 2.1^{a} | 197 ± 103 |
| 2.18 | 3.2 ± 1.2^{a} | 9.7 ± 3.5^{a} | 110 ± 67 |
| 2.49 | 2.3 ± 0.7^{a, b} | 16.1 ± 5.9^{b} | 40 ± 13^{a} |
| 3.63 | 1.6 ± 0.5^{b} | 14.2 ± 4.1^{b} | 23 ± 7^{a} |

^{a, b}For each tensile property, data points having superscripts with the same alphabets indicate that the data was not significantly different from each other.

As seen from Table C, increasing % Weight Gain decreased the strength and modulus but increased the elongation of the feather films. However, there was no significant difference in strength for films with 2.2 and 2.5% and 2.5 and 3.6% Weight Gain. The elongation of the films was similar when the % Weight Gain was 1.8 and 2.2% and 2.5 and 3.6%. The modulus of the films showed decreasing trend except for films made from 2.5 and 3.6% Weight Gain, 15 and 20% catalyst, respectively. The change in the properties of the feather films due to increasing weight gain is believed to be mainly be due to the better thermoplasticity. As seen from FIG. 30, increasing catalyst concentration increased the % Weight Gain and therefore the amount of acrylonitrile on the feathers increased. At low concentrations of acrylonitrile, the % Weight Gain was low, the feathers partly melt and the unmelted feathers acted as reinforcement and increased the strength and modulus but decreased the elongation. At high weight gains, the feathers had good thermoplasticity, could melt better, and therefore the elongation increased. Based on the data in Table C, a catalyst concentration of 15% produced films with the best strength, elongation, and modulus in this example.

### Conclusions

This research showed that etherification using acrylonitrile (cyanoethylation) was a viable approach to develop thermoplastic films from feathers. The % Weight Gain after cyanoethylation increased up to 3.6% with increasing ratio of catalyst to feather from 5 to 20%. Presence of a new absorption peak belonging to the nitrile groups in the FTIR spectrum confirmed cyanoethylation. Cyanoethylated feathers showed a melting peak at 167° C. and the modified feathers were compression molded into thermoplastic films. The properties of the feather films were varied by changing the cyanoethylation conditions, especially catalyst concentration. The ability, to form thermoplastic films even at low levels of cyanoethylation (low % Weight Gain) indicated that the feather thermoplastics would be biodegradable.

### Example 5

### Cyanoethylation of DDGS

Cyanoethylation of the oil-and-zein-free DDGS was performed using acrylonitrile and sodium hydroxide as both the swelling agent and catalyst. To perform the cyanoethylation, aqueous solutions of sodium hydroxide (with a concentration of 1, 5, 10, 15, 20% (w/w)) were added into dried oil-and-zein-free DDGS in 1:1 weight ratios with continuous stirring at room temperature for 30 minutes. Later, a specified amount of acrylonitrile ranging from 1:1 to 10:1 acrylonitrile to DDGS weight ratio was added. The cyanoethylation was completed by heating the mixture containing DDGS, acrylonitrile, and sodium hydroxide for a specified time ranging from 30 to 180 minutes at a specified temperature ranging from 10 to 50° C. At the end of the reaction, the products formed were added into 50% ethanol to precipitate the products by neutralizing with hydrochloric acid (20% v/v). The precipitate obtained was first washed with ethanol, then thoroughly with distilled water, followed by absolute ethanol, and finally dried in an oven at 50° C. for 12 hours.

The amount of acrylonitrile consumed during the reaction was determined by titrating the double bonds in acrylonitrile using potassium bromate. Acrylonitrile containing 30% aqueous sodium hydroxide was heated at 70° C. for 1 hour. After heating, the amount of double bonds were determined and compared to the number of bonds before treatment. It was found that less than 2% of acrylonitrile was consumed during the reaction.

### Effect of Reaction Time on Percent Weight Gain

The effect of increasing reaction time on percent weight gain is illustrated in FIG. 36. As shown, increasing the time from 30 to 120 minutes increased the percent weight gain. There was no significant increase in percent weight gain when the reaction time was increased above 120 minutes, which indicated that the reaction had reached equilibrium. The highest percent weight gain obtained was approximately 35% when the reaction was carried out for 120 minutes with a reaction temperature of 40° C. At short reaction times, the acrylonitrile was unable to penetrate and cyanoethylate the DDGS efficiently. However, long reaction times are not preferable for industrial production. Therefore, a reaction time of 120 minutes was chosen to optimize other cyanoethylation conditions for this example.

### Effect of Reaction Temperature on Percent Weight Gain

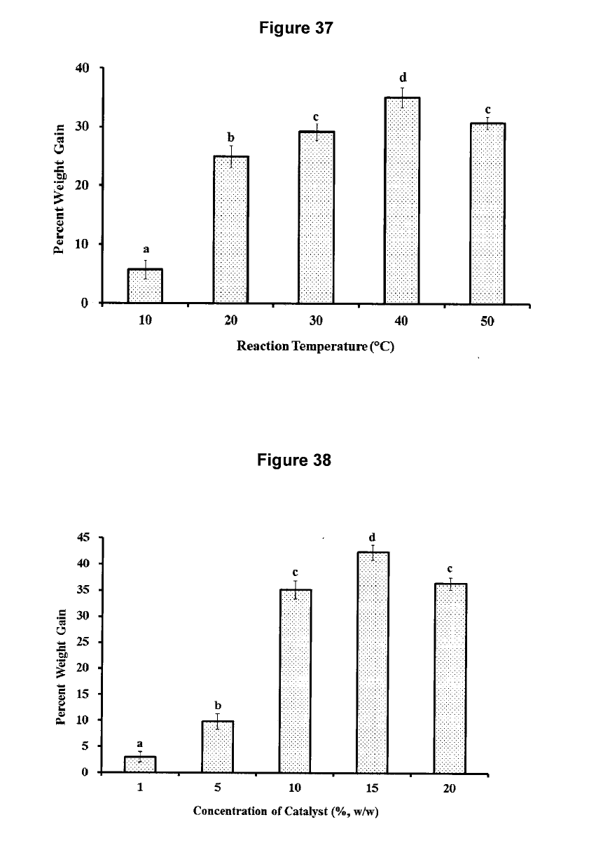

FIG. 37 shows the effect of increasing reaction temperature on the percent weight gain of cyanoethylated DDGS. The percent weight gain of DDGS after reaction at 10° C. for 120 minutes was only 5.7%, much lower than the percent weight gain obtained at higher temperatures. The percent weight gain increased substantially to 25% when the reaction temperature was increased from 10 to 20° C. Further increases in reaction temperature steadily increased the percent weight gain. The highest percent weight gain obtained was 35% at a temperature of 40° C. Temperatures above 40° C. decreased the percent weight gain. At low temperatures (10-30° C.), the reaction time of 120 minutes was insufficient to provide high percent weight gain. However, it is believed that higher percent weight gains could have be obtained even at lower temperatures if the reaction was carried out for sufficient time (lesser than 120 minutes). The reaction between acrylonitrile and DDGS was exothermic and therefore, the percent weight gain decreased at high temperatures.

### Effect of Concentration of Sodium Hydroxide on Percent Weight Gain

Using low ratios of sodium hydroxide (1 and 5%) resulted in a low percent weight gain but increasing alkali concentration to 10% substantially increased percent weight gain to about 35% as seen from FIG. 38. Further increasing the alkali concentration to 15% increased the percent weight gain to 42%. However, the percent weight gain decreased to 36% when the concentration of alkali was 20%. Alkali acts as a catalyst and increased the rate of reaction. At low concentrations, there was not enough alkali to accelerate the reaction. An alkali concentration between 10 and 15% seemed to be the be the optimum to obtain high percent weight gain in this example. Cyanoethylation is a competitive reaction that occurs between acrylonitrile and the functional groups in DDGS and also between acrylonitrile and the hydroxyl groups in water. Initially, the reaction with DDGS was more favorable and therefore an increased percent weight gain with increase in concentration of sodium hydroxide was observed. After a certain level of cyanoethylation of DDGS, however, the acrylonitrile reacted predominantly with the hydroxyl groups in water resulting in lower availability of acrylonitrile for cyanoethylation of the DDGS. Therefore, the percent weight gain decreased at high concentrations of sodium hydroxide.

### Effect of Acrylonitrile to DDGS Ratio on Percent Weight Gain

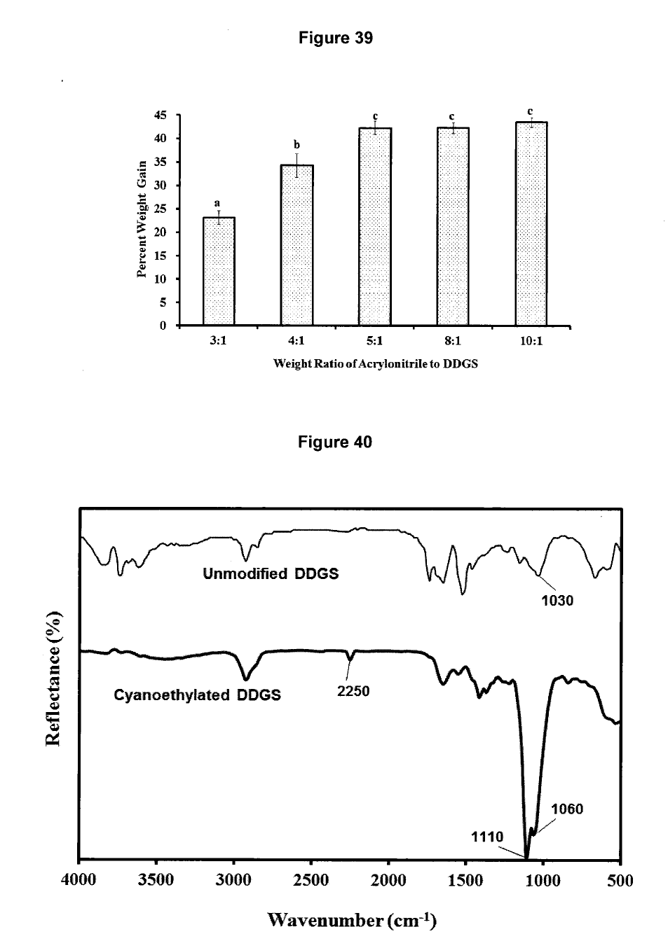

The effect of increasing the weight ratio of acrylonitrile to DDGS on the percent weight gain of cyanoethylated DDGS is shown in FIG. 39. Increasing the ratio of acrylonitrile above 3:1 increased the weight gain up to a ratio of 5:1. The percent weight gain obtained increased substantially to 34% and then to 42% when the ratio of acrylonitrile to DDGS was increased to 4:1 and 5:1, respectively. However, the percent weight gain did not show any considerable increase above an acrylonitrile ratio of 5:1. At low amounts of acrylonitrile (3:1), the amount of acrylonitrile available was not sufficient to adequately cyanoethylate DDGS. Therefore, the percent weight gain obtained was low. At acrylonitrile concentration of 5:1, most of the available hydroxyl and amine groups had reacted and therefore an increase in percent weight gain was not observed when the ratio of acrylonitrile was increased above 5:1.

### Confirming Cyanoethylation of DDGS

FTIR spectrums of the cyanoethylated and unmodified DDGS are shown in FIG. 40. The cyanoethylated DDGS had much stronger absorption peaks compared to the unmodified DDGS in the region of 1000-1100 cm-1. The unmodified DDGS had a small peak at 1030 cm-1 whereas the modified DDGS showed two peaks at 1060 and 1110 cm-1 that are due to the COC stretching in the cyanoethylated DDGS. Another absorption peak attributed to the stretching of nitrile groups was seen at about 2250 cm-1 for the modified DDGS but was not apparent in the unmodified DDGS. The broad peaks are about 3500 cm-1 for the cyanoethylated and unmodified DDGS were due to the unreacted hydroxyl groups in DDGS and the hydroxyl groups in water absorbed by DDGS.

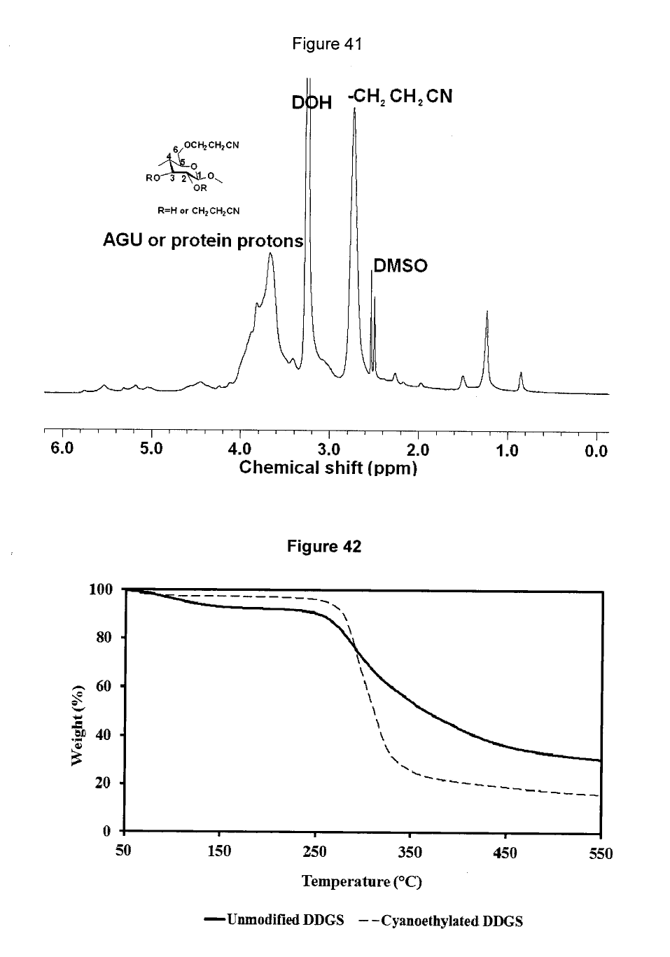

1H-NMR spectrum of the cyanoethylated DDGS is shown in FIG. 41. In the spectra, signals due to cyanoethylated methylene protons δ 2.6-2.9 ppm appeared separately indicating the cyanoethylation of DDGS. The presence of the two additional peaks in the FTIR spectrum (1110 and 2250 cm-1) and the appearance of the peaks due to the methylene protons in the 1H-NMR spectrum indicated cyanoethylation of DDGS.

### Thermal Analysis

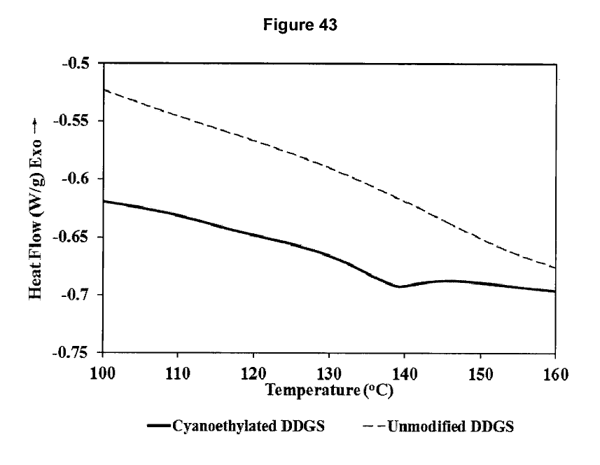

TGA curves in FIG. 42 showed that cyanoethylation provided better thermal stability to DDGS up to a temperature of 290° C. compared to unmodified DDGS. However, the weight loss of cyanoethylated DDGS increased sharply above 290° C. Modified DDGS had a weight loss of 86% at 550° C. compared to 70% for unmodified DDGS. Cyanoethylated DDGS was more stable under heat and it therefore had lower weight loss up to 290° C. However, the cyanoethylated DDGS showed higher final weight loss than the unmodified DDGS because the cyanoethylated DDGS contained lesser amounts of ash and minerals that remained after burning the samples at 550° C. DSC analysis showed that the cyanoethylated DDGS had a small melting peak at about 140° C. whereas the unmodified DDGS did not show any peak as seen in FIG. 43.

Biothermoplastics from DDGS

The unmodified DDGS did not melt and was loosely compacted after compression molding whereas the cyanoethylated DDGS formed thin transparent films indicating good thermoplasticity. Table D shows the properties of thermoplastic DDGS films prepared with various levels of acrylonitrile that were compression molded at 150° C. for 2 minutes.

TABLE D

| Ratio of | Peak stress, | Breaking | Modulus, |
|---|---|---|---|
| Acrylonitrile to DDGS | MPa | Elongation, % | MPa |
| 2:1 | 462 ± 81 | 1.9 ± 0.6 | 3327 ± 382 |
| 3:1 | 651 ± 95 | 2.5 ± 0.6 | 3536 ± 292 |
| 4:1 | 20 ± 3 | 40 ± 3 | 125 ± 26 |
| 5:1 | 16 ± 3 | 44 ± 56 | 62 ± 16 |

As shown in Table D, the properties of the DDGS films varied considerably with increasing ratio of acrylonitrile to DDGS. At low ratios of acrylonitrile to DDGS, the films had high strength, as high as 651 MPa, and modulus as high as 3.5 GPa but relatively low elongation (1.9-2.5%). This was mainly due to the non-thermoplastic portion of the DDGS that acted as reinforcement and provided high strength and modulus. Also, the DDGS had relatively poor flexibility due to the low degree of cyanoethylation making the films brittle and with low elongation. Increasing the ratio of acrylonitrile to DDGS to 4:1 substantially decreased the strength and modulus but increased the elongation by more than 15 times. A further increase in the ratio of acrylonitrile to 5:1 decreased the strength and modulus even further whereas the elongation increased to 44%.

Etherification using acrylonitrile added bulky side groups (C≡N) onto DDGS. The ether linkage with 3 carbons made DDGS films flexible by allowing the polymers to slide easily under strain. At low ratios of acrylonitrile, there was insufficient acrylonitrile and therefore the films had low elongation. Increasing ratio of acrylonitrile to DDGS to 4:1 and above provided good cyanoethylation and therefore the films had high elongation. However, the high flexibility decreased the tensile strength since adjacent molecules were able to slide easily and could not share the load. The variation in the properties of the films with changing ratio of acrylonitrile indicated that the properties of the films may be controlled by varying the conditions of cyanoethylation and compression molding. It is believed that an acrylonitrile to DDGS ratio of 4:1 was found to provide the most optimum combination of strength and elongation to the films of this example.

Although the DDGS films with high acrylonitrile had relatively low strength, the strength of the DDGS films was higher than films previously developed from other biopolymers. Table E provides a comparison of the properties of DDGS films with similar films developed from various biopolymers.

TABLE E

| | Peak | Breaking |
|---|---|---|
| | stress | Elongation |
| Type of film | (MPa) | (%) |
| Silk fibroin + 20% glycerol | 9.4 ± 1.6 | 15 ± 11 |
| Wheat gluten + 0.62 mol glycerol/mol | 4.2 ± 0.8 | 179 ± 46 |
| of amino acid | | |
| Acetylated soy protein | 1.8 − 2.5 | 73 − 113 |
| Starch acetate + 20% glycerol | 10.2 ± 1.3 | 2.4 |
| Cyanoethylated DDGS | 20 ± 3 | 40 ± 3 |

As seen from Table E, DDGS films had much higher strength than any other film in Table E whereas the wheat gluten and acetylated soy protein films had much higher breaking elongation than the DDGS films. However, high amounts of glycerol were used in the wheat gluten films. Starch acetate films had low elongation even after using 20% glycerol since carbohydrates are relatively inflexible compared to proteins. It should be noted that the DDGS films had elongation of 39.5% with strength of 19.7 MPa, higher than any of the films in Table E, when cyanoethylated with an acrylonitrile to DDGS ratio of 4:1. The elongation of the DDGS may have been further increased by modifying the cyanoethylation conditions or by using plasticizers. Comparison of the properties of the films indicated that cyanoethylated DDGS may be a better alternative to obtain flexible films with good strength than the films developed from common biopolymers.

### Conclusions

This example demonstrated that cyanoethylated DDGS may be made into thermoplastic films with high flexibility and strength without the need for plasticizers. The optimum conditions for the cyanoethylation of DDGS in this example were a temperature of 40° C., a time of 120° C., a acrylonitrile to DDGS ratio of 5:1, and 15% alkali based on the weight of DDGS. The cyanoethylated DDGS was compression molded into films at 150° C., close to the melting point seen from DSC curves. The DDGS films had tensile strength ranging from 15.9 to 651 MPa and elongation ranging from 1.9-44% depending on the extent of cyanoethylation. The DDGS films had much higher strength even at high elongation compared to films developed from various biopolymers. Since no plasticizers were necessary, the cyanoethylated films can be expected to retain their properties at high humidity and temperatures.

### Example 6

### Graft Polymerization of Feathers

Before grafting, chicken feathers were soaked by mixing with distilled water. Then, the mixture was transferred into a 500 mL four-neck flask. Dilute hydrochloric acid was added to adjust the feather dispersion to a desired pH (4.5-6.5). The flask was maintained at a specific temperature (40-70° C.) in a water bath. After the mixture was deoxygenated by passing nitrogen gas for approximately 30 minutes, the initiator including the oxidant (K2S2O8) (2.5 wt %-10 wt %, to feather) and the reductant (NaHSO3) (0.96 wt %-3.84 wt %, to feather) were dissolved in proper amounts of distilled water, respectively. The initiator solutions and MA monomer (10 wt %-60 wt %, to feather) were added continuously into the flask through three funnels. The addition was completed in 10-20 minutes and final weight ratio of feather to water was 1:18. The graft polymerization was carried out in a 500 mL four-neck flask under vigorous stirring using a mechanical stirrer (Talboys Engineering Corporation, Model T Line 134-1) at 1000 rpm under nitrogen atmosphere for a predetermined time (1-5 hours). Finally, one milliliter of 2% paradioxybenzene solution was added to terminate the polymerization. The product was neutralized to about pH 7.0, filtered, washed thoroughly with distilled water and dried at 105° C. The grafted feathers were separated from homopolymer by repeated refluxing in Soxhlet with acetone, which was a good solvent for PMA, for 24 hours. The feather-g-PMA product obtained was later dried at 105° C. for 4 hours in order to remove acetone.

### Effect of Molar Ratio of NaHSO₃/K₂S₂O₈ on Grafting Parameters

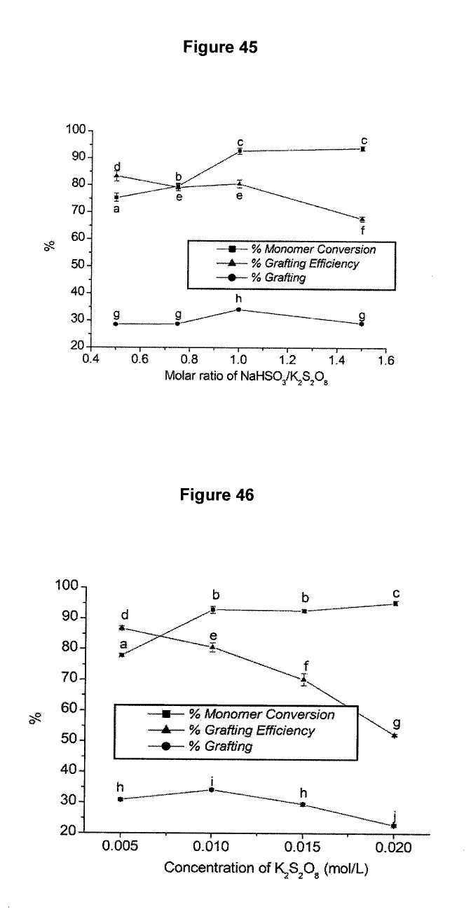

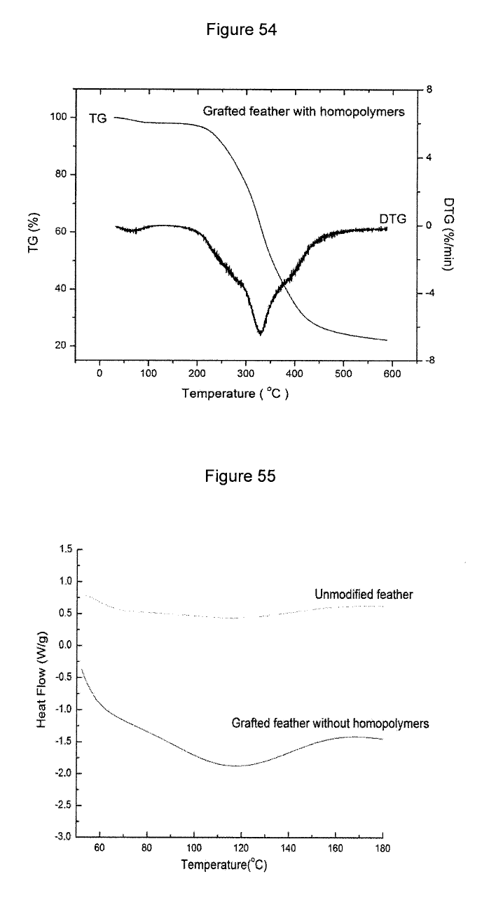

FIG. 45 shows the effect of molar ratio of NaHSO3 to K2S2O8 on the graft polymerization of feathers with MA. In FIGS. 45-50, data points with the same small letter were not statistically significantly different from each other. Also, for the materials tested for FIGS. 45-55, the grafting was carried out at 60° C. and pH 5.5 for 4 hours; the molar ratio of K2S2O8/NaHSO3 was 1.0; the concentration of K2S2O8 was 0.010 mol/L; and molar concentration of K2S2O8 was kept constant. It was observed that with the increase in molar ratio of NaHSO3 to K2S2O8, the % Monomer Conversion initially increased. Thereafter, the slight increase in the mean value of the % Monomer Conversion with increasing molar ratio of NaHSO3 to K2S2O8 from 1.0 to 1.5 was not statistically significant. The % Grafting initially increased, reached the maximum when the ratio was 1.0, and then decreased. The % Grafting Efficiency continuously decreased and was reduced substantially when the ratio was above 1.0.

As seen from FIG. 44, redox reaction occurs between a molecule of bisulfite as reductant and a molecule of persulfate as oxidant leading to the generation of free radicals. Therefore, when molar ratio of NaHSO3 to K2S2O8 was less than 1.0, the increasing amount of NaHSO3 could react with superfluous K2S2O8 and generate more free radicals. The increase in the amount of free radicals favored both graft polymerization and homopolymerization. Therefore, both the % Grafting and the % Monomer Conversion increased initially. From Equation 12, it could be observed that the % Grafting Efficiency was directly proportional to the % Grafting and was inversely proportional to the % Monomer Conversion when the ratio of feathers to total monomer was kept constant. When the molar ratio increased from 0.5 to 1, the rate of increase in the % Grafting was lower than that of the % Monomer Conversion due to homopolymerization among the monomers. As a result, the % Grafting Efficiency decreased when the molar ratio ranged from 0.5 to 1.0.

When the molar ratio exceeded 1.0, the excess amount of NaHSO3 would function as chain transfer agent. As a result, the radicals on the propagating chains of PMA were likely to transfer to monomer or initiator. Hence, the propagation of the molecular chains of PMA was restrained. As for graft polymerization, the number of active sites on the surfaces of the chicken feathers was limited. Generation of every grafted branch on the backbones of the feather was based on active sites. Therefore, the number of grafted branches was also limited. Chain transfer caused by excessive amount of NaHSO3 would restrain the propagation of grafted branches and decrease their degree of polymerization (DP). Therefore, the total weight of grafted branches was reduced and the % Grafting decreased. As for homopolymerization, each monomer could be considered as a potential active site and thus the number of active sites of homopolymerization was much larger than that of active sites on the surfaces of the chicken feathers. Although chain transfer could decrease DP of PMA, the amount of homopolymer could still increase. Thus, the weight of homopolymer kept increasing even if the molar ratio of NaHSO3 to K2S2O8 was higher than 1.0. Thus, the % Grafting Efficiency sharply decreased when the molar ratio was above 1.0. When the molar ratio reached 1.0, nearly all the monomers (93%) were converted to polymers. Thus, the slight increase in the mean value of % Monomer Conversion was not statistically significant.

### Effect of Initiator Concentration on Grafting Parameters

FIG. 46 depicts the effect of initiator concentration on the grafting parameters. With the increase in the concentration of K2S2O8, the % Monomer Conversion increased substantially when the concentration ranged from 0.005 to 0.010 mol/L and then increased slightly. As for the % Grafting, it initially increased and then decreased after above 0.010 mol/L. The % Grafting Efficiency continued to decrease with increasing initiator concentration from 0.005 to 0.020 mol/L.

As the concentration of initiator increased, more free radicals were generated. In general, enhancing the amount of free radicals contributes to increases in both graft polymerization and homopolymerization. Therefore, the % Grafting and the % Monomer Conversion increased markedly when the concentration of K2S2O8 ranged from 0.005 to 0.010 mol/L. However, the rate of the increase in the % Monomer Conversion was higher than that of the % Grafting due to homopolymerization among the monomers. Therefore, the % Grafting Efficiency decreased when the concentration of K2S2O8 ranged from 0.005 to 0.010 mol/L.

When the concentration of K2S2O8 was excessively high, K2S2O8 not only reacted with NaHSO3 in the redox, but also oxidized the radicals on propagating chains of PMA. Therefore, excessively high concentration of K2S2O8 would restrict the propagation of grafted branches and decrease their DP. As was explained in the preceding section, when the number of grafted branches on the backbone of the feather was limited, the decrease in DP of grafted branches would lead to the decrease in the % Grafting. As for homopolymerization, the amount of homopolymer would still increase when the concentration of K2S2O8 was high. Hence, the weight of homopolymer continued to increase when the concentration of K2S2O8 was above 0.010 mol/L. Therefore, there was still a decrease in % Grafting Efficiency. When the concentration of K2S2O8 exceeded 0.010 mol/L, nearly all the monomers (93%) were converted to polymers. Thus there was no substantial increase in the % Monomer Conversion.

### Effect of pH on Grafting Parameters

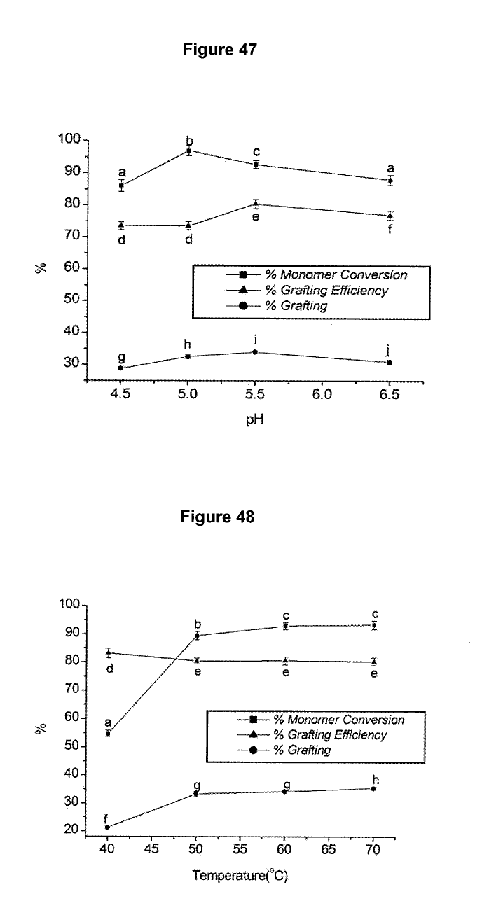

The effects of pH during the reaction on grafting parameters are depicted in FIG. 47. With the increase in pH from 4.5 to 6.5, the three grafting parameters (% Monomer Conversion, % Grafting, and % Grafting Efficiency) initially increased then decreased. It is believed that the reducing ability of NaHSO3 is more effective when pH is controlled in the range from 5.0 to 6.0 and more preferably from 5.0 to 5.5 because of the redox reaction between NaHSO3 and K2S2O8 generates more free radicals. Excessively high or low concentration of H+ decreased the reducing ability of NaHSO3 and impeded the production of free radicals.

### Effect of Reaction Temperature and Time on Grafting Parameters

Effects of temperature on grafting parameters were studied by changing reaction temperature from 40 to 70° C. as depicted in FIG. 48. With the increase in temperature from 40 to 70° C., the % Monomer Conversion and the % Grafting both increased. As for the % Grafting Efficiency, it initially decreased from 40 to 50° C. and then leveled off.

In general, the higher reaction temperature is, the higher the rates of graft polymerization and homopolymerization. Increases in the rates could be ascribed to the following reasons: the increase in temperature favored fast decomposition of the initiator and led to the generation of a greater number of free radicals at early stage of the reaction; the mobility of free radicals and monomers would increase at higher temperature leading to higher % Monomer Conversion and % Grafting if reaction time was equal and inadequate. In FIG. 48, the % Monomer Conversion and the % Grafting both increased with the increase in temperature when reaction time was 3 hours. Hence, it was necessary to study the effect of reaction time on the grafting parameters.

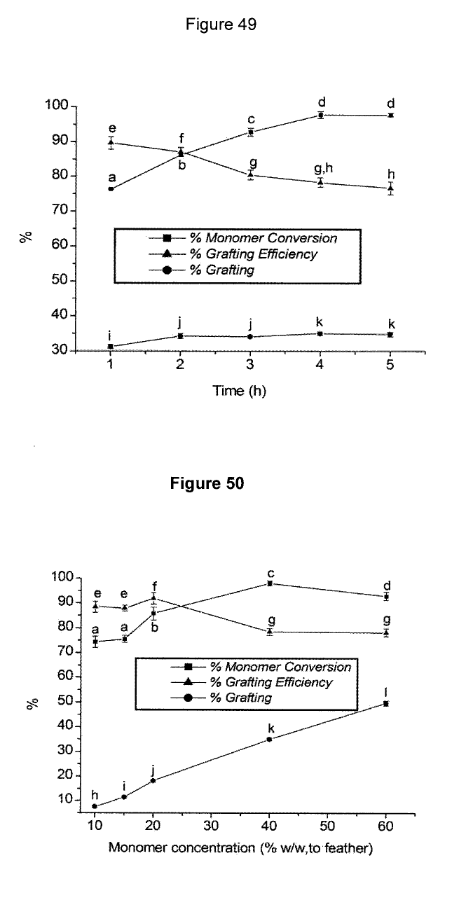

Effects of reaction time on grafting parameters are shown in FIG. 49. With the increase in reaction time ranging from 1 to 4 hours, both the % Monomer Conversion and the % Grafting increased but the % Grafting Efficiency decreased. All the grafting parameters leveled off after reaction time exceeded 4 hours.

Generally, the longer reaction time, the larger the amount of the monomer converted to polymers. At 4 hours, almost all the monomers (about 97%) were converted to polymers including both grafted branches and homopolymer. Thus the % Monomer Conversion and the % Grafting did not increase further.

### Effect of Monomer Concentration on Grafting Parameters

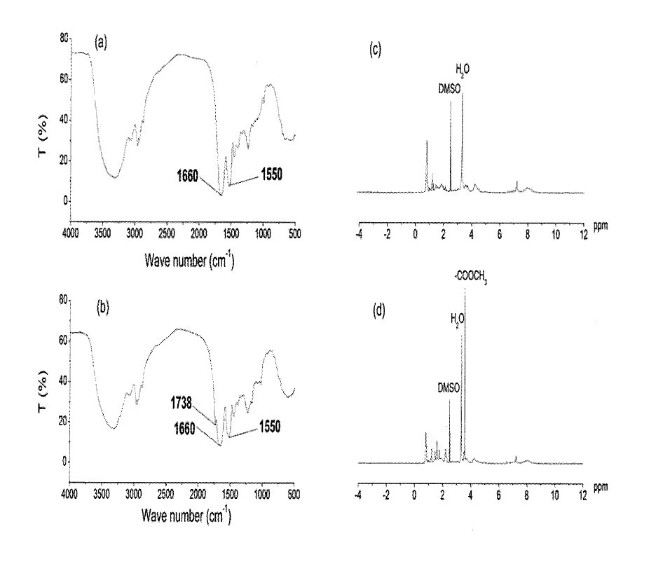

FIG. 50 shows the effect of monomer (MA) concentration on the grafting. The % Grafting increased continuously with the increase in the concentration of MA from 10% to 60%, whereas the % Monomer Conversion initially increased, reached the maximum when the concentration of MA was 40%, and later decreased. As for the % Grafting Efficiency, it increased when the concentration ranged from 10% to 20%, decreased after the concentration reached 20%, and then leveled off.

The initial increase in the % Monomer Conversion is mainly due to the invariability of equilibrium constant of polymerization. In general, higher monomer concentration helps to make polymerization including both graft and homo polymerization move towards positive direction. In addition, increasing concentration of MA could increase the concentration of PMA, which included grafted branches and homopolymer. The increasing concentration of PMA led to higher viscosity of reaction system. The increased viscosity hindered chain termination, especially the coupling termination of growing PMA chains. However, with the increase in the length of molecular chains of PMA, entropy and stability of reaction system increased. It would be more difficult for the molecular chains of PMA to become longer if the amount of MA exceeded 40%. Therefore, % Monomer Conversion began to decrease when MA concentration reached 40%.

The % Grafting in our study describes the weight percentage of PMA branches grafted onto feathers to feathers. The higher the concentration of MA, the larger the amount of PMA branches formed. Because the amount of feather used was constant during grafting, the % Grafting kept increasing when the concentration of MA increased from 10% to 60%.

During grafting process, graft polymerization and homopolymerization are a pair of competitive reactions. With the gradual occupation of active sites on the surfaces of the chicken feathers, it might be more probable for residual monomer in the reaction medium to take part in homopolymerization. Therefore, the % Grafting Efficiency decreased when the monomer concentration was above 20%. The aim of our investigation was to prepare a thermoplastic product through the grafting of native feathers using as little MA as possible to achieve high values of all grafting parameters. The MA has much higher price than feathers and its polymer (PMA) is not biodegradable. Generally, higher monomer concentration tends to increase the amount of synthetic polymers, including grafted branches and homopolymers. The presence of higher amounts of synthetic polymers tends to decrease the biodegradability of the products. In this example, using 40% of monomer concentration was enough to obtain thermoplastic grafted feathers with good mechanical properties. In addition, the % Monomer Conversion was high (about 98%) when monomer concentration was 40%.

### FTIR Analysis

The FTIR spectra of unmodified feather and feather-g-PMA are shown in FIGS. 51a and 51b, respectively. The two peaks appeared at 1660 cm-1 and 1550 cm-1 are due to characteristic absorption bands of the amide I and amide II bands, respectively. The FTIR spectrum of feather-g-PMA showed a new characteristic absorption band of carbonyl group of methyl ester at 1738 cm-1 in addition to the absorption bands of unmodified feather. The peak at 1738 cm-1 confirmed the grafting of MA onto the feather.

### ¹H-NMR Analysis

The 1H-NMR spectra of unmodified feather and feather-g-PMA are shown in FIGS. 51c and 51d, respectively. Compared to the spectrum of unmodified feather, new chemical linkages were found in feather-g-PMA. In FIG. 51d, the protons of methyl ester (—COOCH3) appeared at 3.5 ppm and the grafting of MA onto the feather was confirmed. The PMA contained groups such as methylene (—CH2-) and methane (>CH—). Therefore, the increases in peak intensities of the protons of —CH2- and >CH—, which appeared at 1.4-2.3 ppm in FIG. 51d, could be considered as additional proof of the grafting of MA onto the feather.

### Thermogravimetric Analysis

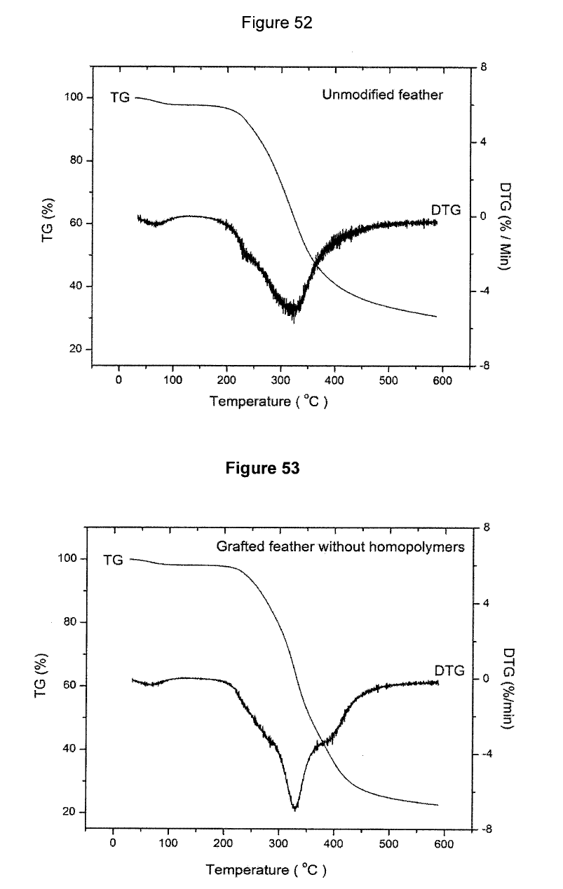

FIGS. 52, 53, and 54 reveal the thermal degradation behavior of unmodified feather, grafted feathers without homopolymers, and grafted feathers with homopolymers, respectively. From TG and DTG curves, it could be observed that thermal degradation behaviors of grafted feathers with and without homopolymers were very similar. The ratio of the homopolymers was only 6.7% (w/w, to the total weight of the grafted feathers with homopolymers) and at this low ratio, the homopolymers did not affect the thermal degradation of the feathers substantially. However, the thermal degradation temperature of the grafted feathers was higher than that of unmodified feathers as seen in the figures. The TG and DTG results show that the start thermal degradation temperature of unmodified feathers is about 208° C. whereas that of grafted feathers is about 228° C. From the peaks of DTG curves, it is observed that the unmodified feathers lost weight the most quickly at about 320° C. whereas the grafted feathers did at about 330° C. There were two possible explanations for the improved thermal stability of grafted feathers. The thermal stability of carbon-carbon bond of grafted branches (PMA) was higher than that of peptide bond of feather keratin. In addition, mild crosslinking between grafted branches that might occur during the grafting helped to increase the thermal stability.

As seen in the TG curves, about 67% of unmodified feathers were lost after being heated to 600° C. whereas 78% of grafted feather without homopolymers were lost. Through the integration of the peaks of DTG curves, the weight loss percentages of unmodified feather and grafted feather without homopolymers at 600° C. were 71% and 81%, respectively, which were in agreement with the TG results. The difference in weight loss between the unmodified and grafted feathers were used to confirm the % Grafting of the sample. Based on the curve of unmodified feather, it is believed that the residual amount of unmodified feather, which was decomposed after heating at 600° C., should have been 33%. Assuming that all the grafted branches (35%) would have decomposed, the actual weight loss of the feather mathematically will have been 78.5%, which is similar to the weight loss observed from the curve of grafted feather without homopolymers (78%). This shows that the % Grafting achieved was 35%.

### DSC Analysis

The DSC thermogram of unmodified feather and feather-g-PMA is shown in FIG. 55. There was no endothermic peak for unmodified feather, indicating its poor thermoplasticity. The melting curve of feather-g-PMA has a broad endothermic peak around 120° C. that can be attributed to the melting of feather-g-PMA. The presence of the melting peak demonstrates that the thermoplasticity of the feathers was improved due to the grafting of PMA.

### Thermoplastic Feather Films

Due to poor thermoplasticity of unmodified feathers, compression molding at high temperature damaged the feathers and made them charred. The modified feathers melted well and became transparent thermoplastic films, indicating good thermoplasticity of the modified feathers.

### Tensile Properties of Feather Films

Table F shows the tensile properties of the films developed from grafted feathers containing various amounts of glycerol in comparison to films made from two common natural polymers, soy protein isolate (SPI) and starch acetate (SA).

TABLE F

| | tensile | breaking | Young's |
|---|---|---|---|
| type of film | strength (MPa) | elongation (%) | modulus (GPa) |
| 0% Glycerol-Feather^{a} | 206.3 ± 15.7 | 1.1 ± 0.4 | 28.8 ± 0.7 |
| 10% Glycerol-Feather^{a} | 122.1 ± 8.4 | 1.6 ± 0.5 | 11.1 ± 0.6 |
| 20% Glycerol-Feather^{a} | 96.2 ± 9.6 | 3.0 ± 0.5 | 8.4 ± 0.2 |
| 30% Glycerol-Feather^{a} | 55.7 ± 9.0 | 14.2 ± 2.2 | 4.4 ± 0.2 |
| 0% Glycerol-SPI | 41.6 | 1.3 | 1.2 |
| through | | | |
| solvent-casting^{b} | | | |
| 11% Water-SPI | 40 ± 6 | 4.0 ± 0.5 | 1.63 ± 0.03 |
| through compression | | | |
| molding^{c} | | | |
| 20% Glycerol-SPI^{d} | 15.8 ± 0.2 | 4.2 ± 1.4 | — |
| 30% Glycerol-SPI^{d} | 5.4 ± 0.2 | 96.5 ± 6.2 | — |
| 0% Glycerol-SA^{e} | 56.30 ± 7.59 | 1.97 | — |
| 10% Glycerol-SA^{e} | 20.45 ± 5.38 | 1.63 | — |
| 20% Glycerol-SA^{e} | 10.22 ± 1.32 | 2.37 | — |
| 30% Glycerol-SA^{e} | 4.98 ± 0.65 | 9.00 | — |

^{a}The grafting was carried out at 60° C. and pH 5.5 for 4 h. The molar ratio of K₂S₂O₈/NaHSO₃ was 1.0 and the concentration of K₂S₂O₈ was 0.010 mol/L. The monomer concentration was 40% (w/w, to feathers). % Grafting was 35%. The feather films were conditioned at 65% R.H. and 21° C. for 24 h before testing.
^{b}Data from Su, J.; Huang, Z.; Yang, C.; Yuan, X. Properties of soy protein isolate/poly(vinyl alcohol) blend “Green” films: compatibility, mechanical properties, and thermal stability. J. Appl. Polym. Sci., 2008, 110, 3706-3716. The SPI films were solvent-cast at 50° C. for 6 h. The films were conditioned at 43% R.H. and room temperature (20° C.) for 72 h before testing.
^{c}Data from Paetau, I.; Chen, C. Z.; Jane, J. Biodegradable plastic made from soybean products. 1. Effect of preparation and processing on mechanical properties and water absorption. Ind. Eng. Chem. Res., 1994, 33, 1821-1827. The SPI films were prepared at 140° C. and 20.7 MPa for 6 min using hot press. The films were conditioned at 50% R.H. for 40 ± 2 h before testing.
^{d}Data from Cunningham, P.; Ogale, A. A.; Dawson, P. L.; Acton, J. C. Tensile properties of soy protein isolate films produced by a thermal compaction technique. J. Food Sci., 2000, 65, 668-671. The SPI films were prepared at 150° C. and 10 MPa for 2 min using a Carver Laboratory Press. The films were conditioned at 50% R.H. and 25° C. for 24 h before testing.
^{e}Data from Bonacucina, G.; Di Martino, P.; Piombetti, M.; Colombo, A.; Roversi, F.; Palmieri, G. F. Effect of plasticizers on properties of pregelatinized starch acetate (Amprac 01) free films. Int. J. Pharm., 2006, 313, 72-77. The SA films were cast through the evaporation of the solvent at room temperature (20° C.) for 48 h. The authors did not describe the equilibration conditions before testing.

It was observed that the tensile strength and Young's modulus decreased but breaking elongation increased with increasing amount of glycerol. The tensile strength of grafted feather films with 30% glycerol was only about 27% compared to that of the films without glycerol but with 13 times higher elongation. The modulus of the films also decreased substantially with increasing glycerol content. Glycerol plasticized the feathers and improved the thermoplasticity but decreased the tensile strength. It was also observed that, even with the concentration of 30% glycerol, tensile strength of the feather films was about 10 times and 11 times higher than that of SPI and SA films, respectively.

Without any glycerol, the tensile strength of feather films was about 5 times and 4 times higher than that of SPI and SA films, respectively. However, the elongation of feather films was similar to that of SPI films but lower than that of SA films. Without being bound to a particular theory, it is believed that the much higher tensile strength of feather films without any glycerol than that of SPI and SA films might be due to the better thermoplasticity of the modified feather than SPI and SA, and higher tensile strength of feather keratin than soy protein and starch acetate. The higher tensile strength is also due to the presence of unmelted feathers that act as reinforcement in the film.

With no glycerol or a low concentration of glycerol (0-20%, to the weight of the feathers), some of the feathers do not melt during compression molding. These unmelted feathers reinforced the film and provided higher strength and modulus. However, the unmelted feathers may have caused stress concentration and decreased the breaking elongation of the film. Adding more glycerol (30%, to the weight of the feathers) improved the thermoplasticity and most feathers melted during compression molding leading to substantial increase in breaking elongation but decreases in tensile strength and modulus. Based on the comparison of the properties of feather films with the SPI and SA, the thermoplastic feather films developed with different amounts of glycerol are expected to be suitable for various applications.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials:
(a) acylated biobased material comprising acyl groups (—OCR₁) where R₁ is an alkyl and having a % Acyl Content that is at least 3% and a % Weight Gain that is at least 1%, and;
(b) etherified biobased material comprising —R₂Q groups where R₂ is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and
(c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

2. The thermoplastic biobased material-containing composition of claim 1, wherein R₁ is selected from the group consisting of methyl, ethyl, propyl, butyl, and combinations thereof, and
wherein R₂ is selected from the group consisting of methyl, ethyl, propyl, butyl, and combinations thereof and Q is a cyano group, and
wherein the monomer is one or more acrylates.

3. The thermoplastic biobased material-containing composition of claim 2, wherein the monomer is selected from the group consisting of methyl methacrylate, ethyl methacrylate, butyl methacrylate, methyl acrylate, ethyl acrylate, and butyl acrylate, and combinations thereof.

4. The thermoplastic biobased material-containing composition of claim 1, wherein in addition to the graft polymerized biobased material, the thermoplastic bio-based material-containing composition further comprises a homopolymer of said monomer at an amount that is greater than 10% by weight of the graft polymerized biobased material.

5. The thermoplastic biobased material-containing composition of claim 1, wherein in addition to the graft polymerized biobased material, the thermoplastic bio-based material-containing composition further comprises a homopolymer of said monomer at an amount that is in the range of 20-80% by weight of the graft polymerized biobased material.

6. The thermoplastic biobased material-containing composition of claim 1, wherein in addition to the graft polymerized biobased material, the thermoplastic bio-based material-containing composition further comprises a homopolymer of said monomer at an amount that is in the range of 25-55% by weight of the graft polymerized biobased material.

7. The thermoplastic biobased material-containing composition of claim 1, wherein the biobased material is selected from the group consisting of feathers, portions thereof, and previously chemically-modified versions of the foregoing, and
wherein, for the acylated biobased material, R₁ is methyl, the % Acyl Content that is in the range of 3-10% and the % Weight Gain is in the range of 2-10%, and
wherein, for the etherified biobased material, R₂ is ethyl, Q is a cyano group, and the etherified biobased material has a % Weight Gain that is in the range of 2-4%, and
wherein, for the graft polymerized biobased material, the monomer is methyl methacrylate, the % Monomer Conversion that is at least 75%, the % Grafting Efficiency is in the range of 50-80%, and the % Grafting is in the range of 20-50%.

8. The thermoplastic biobased material-containing composition of claim 1, wherein the biobased material is selected from the group consisting of feathers, portions thereof, and previously chemically-modified versions of the foregoing, and
wherein, for the acylated biobased material, R₁ is methyl, the % Acyl Content that is in the range of 3-8% and the % Weight Gain is in the range of 4-10%, and
wherein, for the etherified biobased material, R₂ is ethyl, Q is a cyano group, and the % Weight Gain is in the range of 2-4%, and
wherein, for the graft polymerized biobased material, the monomer is methyl methacrylate, the % Monomer Conversion that is at least 85%, the % Grafting Efficiency is in the range of 50-80%, and the % Grafting is in the range of 25-35%.

9. The thermoplastic biobased material-containing composition of claim 1, wherein the biobased material is selected from the group consisting of dried distillers grains, constituents thereof, and previously chemically-modified versions of the foregoing, and
wherein, for the acylated biobased material, R₁ is methyl, the % Acyl Content that is in the range of 10-50% and the % Weight Gain is in the range of 10-60%, and
wherein, for the etherified biobased material, R₂ is ethyl, Q is a cyano group, and the % Weight Gain is in the range of 10-45%, and
wherein, for the graft polymerized biobased material, the monomer is methyl methacrylate, the % Monomer Conversion that is at least 40%, the % Grafting Efficiency is in the range of 50-90%, and the % Grafting is in the range of 10-70%.

10. The thermoplastic biobased material-containing composition of claim 1, wherein the biobased material is selected from the group consisting of dried distillers grains, constituents thereof, and previously chemically-modified versions of the foregoing, and
wherein, for the acylated biobased material, R₁ is methyl, the % Acyl Content that is in the range of 20-40% and the % Weight Gain is in the range of 20-50%, and
wherein, for the etherified biobased material, R₂ is ethyl, Q is a cyano group, and the % Weight Gain is in the range of 25-45%, and
wherein, for the graft polymerized biobased material, the monomer is methyl methacrylate, the % Monomer Conversion that is at least 50%, the % Grafting Efficiency is in the range of 40-90%, and the % Grafting is in the range of 10-70%.

11. The thermoplastic biobased material-containing composition of claim 1, wherein it comprises a physical mixture of at least two of the acylated biobased material, the etherified biobased material, and the graft polymerized biobased material.

12. The thermoplastic biobased material-containing composition of claim 11, wherein the acylated biobased material, if present, is at amount that is in the range of 10-90% by weight of the thermoplastic biobased material, the etherified biobased material, if present, is at amount that is in the range of 10-90% by weight of the thermoplastic biobased material, and the graft polymerized biobased material, if present, is at amount that is in the range of 10-90% by weight of the thermoplastic biobased material.

13. The thermoplastic biobased material-containing composition of claim 1, wherein it comprises at least two of the acylated biobased material, the etherified biobased material, and the graft polymerized biobased material, and each of which that is present is a portion of the same chemically-modified biobased material.

14. The thermoplastic biobased material-containing composition of claim 13, wherein the acylated biobased material, if present, is at amount that is in the range of 10-90% by weight of the thermoplastic biobased material, the etherified biobased material, if present, is at amount that is in the range of 10-90% by weight of the thermoplastic biobased material, and the graft polymerized biobased material, if present, is at amount that is in the range of 10-90% by weight of the thermoplastic biobased material.

15. The thermoplastic biobased material-containing composition of claim 1, further comprising a plasticizer.

16. The thermoplastic biobased material-containing composition of claim 15, wherein the plasticizer is at an amount that is in the range of 5-30% by weight of the one or more chemically-modified biobased materials present.

17. The thermoplastic biobased material-containing composition of claim 15, wherein the plasticizer is selected from the group consisting of glycerol, sorbitol, glycols, mineral oils, synthetic resins, and combinations thereof.

18. A thermoplastic composition comprising a thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials:
(a) acylated biobased material comprising acyl groups (—OCR₁) where R₁ is an alkyl and having a % Acyl Content that is at least 3% and a % Weight Gain that is at least 1%, and;
(b) etherified biobased material comprising —R₂Q groups where R₂ is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and
(c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

19. The thermoplastic composition of claim 18, further comprising thermoplastics selected from the group consisting of conventional, non-biodegradable thermoplastics, biodegradable thermoplastics, and combinations thereof.

20. An article comprising a thermoplastic biobased material-containing composition, wherein the biobased material is selected from the group consisting of feathers, portions thereof, dried distillers grains, constituents thereof, previously chemically-modified versions of the foregoing, and combinations thereof, the thermoplastic biobased material-containing composition comprising one or more of the following chemically-modified biobased materials:
(a) acylated biobased material comprising acyl groups (—OCR₁) where R₁ is an alkyl and having a % Acyl Content that is at least 3% and a % Weight Gain that is at least 1%, and;
(b) etherified biobased material comprising —R₂Q groups where R₂ is an alkyl and Q is an electron withdrawing group consisting of a nitro group, a quaternary amine group, a trihalide group, a cyano group, a sulfonate group, a carboxylic acid group, an ester group, an aldehyde group, and a ketone group, and having a % Weight Gain that is at least 2%; and
(c) graft polymerized biobased material comprising a polymer grafted to the biobased material, wherein the polymer comprises residues of a monomer that comprises a functional group selected from the group consisting of an alkenyl, an alkynyl, an aryl, or combinations thereof, and having a % Monomer Conversion that is at least 40%, a % Grafting Efficiency that is at least 30%, and a % Grafting that is at least 10%.

21. The article of claim 20, further comprising thermoplastics selected from the group consisting of conventional, non-biodegradable thermoplastics, biodegradable thermoplastics, and combinations thereof.

22. A process for chemically modifying a biobased material to impart thermoplasticity to, or modify one or more thermoplastic properties of the biobased material, wherein the biobased material is selected from the group consisting of feathers, portions thereof, dried distillers grains, constituents thereof, previously chemically-modified versions of the foregoing, and combinations thereof, the process comprising performing one or more of the following chemical modifications to the biobased material:
(a) acylation of the biobased material by a process comprising reacting the biobased material with an acylating agent until the acylated biobased material has a % Acyl Content that is at least 3% and a % Weight Gain that is at least 1%, wherein the acylating agent is selected from the group consisting of one or more aliphatic acid anhydrides, one or more aromatic acid anhydrides, and combinations thereof;
(b) etherification of the biobased material by a process comprising a nucleophillic addition reaction in which the biobased material is reacted with an etherifying agent until the etherified biobased material has a % Weight Gain that is at least 2%, wherein the etherifying agent is one or more saturated molecules having an electron withdrawing group selected from the group consisting of a nitro group, a quaternary amine group, a trihalide group, a cyano group, a sulfonate group, a carboxylic acid group, an ester group, an aldehyde group, and a ketone group; and
(c) graft polymerization of the biobased material via free radical polymerization of a monomer so that the graft polymerized biobased material has % Monomer Conversion that is at least 10%, a % Grafting Efficiency that is at least 10%, and a % Grafting that is at least 10%, wherein the monomer comprises a functional group selected from the group consisting of an alkenyl, an alkynyl, an aryl, or combinations thereof.

23. The process of claim 22, wherein the acylation reaction is carried out in the presence of a acylation catalyst at an amount that is in the range of 0.5-25% by weight of the biobased material at an acylation temperature that is in the range of 0-120° C. for an acylation duration that is in the range of 10-150 minutes using a weight ratio of acylating agent to biobased material that is in the range of 1:1 to 10:1, wherein the acylation catalyst is selected from the group consisting of one or more mineral acids, acetic acid, and combinations thereof, and wherein the acylating agent is one or more organic acid anhydrides, and
wherein the etherification reaction is carried out in the presence of an etherification catalyst at an amount that is in the range of 1-25% by weight of the biobased material at an etherification temperature that is in the range of 10-120° C. for an etherification duration that is in the range 10-180 minutes using a weight ratio of etherifying agent to biobased material that is in the range of 1:1 to 15:1, wherein the etherification catalyst is selected from the group consisting of carbonates, hydroxides, and combinations thereof, and wherein the etherifying agent is selected from the group consisting of acrylonitrile, benzyl chloride, propyl bromide, and combinations thereof, and
wherein the graft polymerization reaction is carried out at a polymerization temperature that is in the range of 20-120° C. and at a pH that is in the range of 2-13 for a polymerization duration that is in the range 0.1-24 hours, wherein the unsaturated monomer is a concentration that is in the range of 10-200% based on the weight of the biobased material, and wherein the graft polymerization reaction is initiated by reacting an oxidant and a reductant, wherein the molar ratio of reductant to oxidant is in the range of 0.1-5.0, and the concentration of oxidant is in the range of 0.1-10 mol/L, wherein the oxidant is selected from the group consisting of persulfates, permanganates, and combinations thereof, and the reductant is selected from the group consisting of sulfates, sulfites, peroxides, and combinations thereof, and wherein the monomer is one or more acrylates.

24. The process of claim 23, wherein the monomer is selected from the group consisting of methyl methacrylate, ethyl methacrylate, butyl methacrylate, methyl acrylate, ethyl acrylate, butyl acrylate, and combinations thereof.

25. The process of claim 23, wherein the biobased material is selected from the group consisting of feathers, portions thereof and previously chemically-modified versions of the foregoing, and
wherein the acylating agent is acetic anhydride, the amount of acylation catalyst is in the range of 5-20% by weight of the biobased material, the acylation temperature is in the range of 50-90° C., the acylation duration is in the range of 10-60 minutes, the weight ratio of acylating agent to biobased material that is in the range of 2:1 to 5:1, the % Acyl Content that is in the range of 3-10% and the % Weight Gain of the acylated biobased material that is in the range of 2-10%, and
wherein the etherifying agent is acrylonitrile, the amount of etherification catalyst is in the range of 5-20% by weight of the biobased material, the etherification temperature is in the range of 10-50° C., the etherification duration is in the range of 20-60 minutes, the weight ratio of etherifying agent to biobased material that is in the range of 5:1 to 10:1, and the % Weight Gain of the etherified biobased material is in the range of 2-4%, and
wherein the monomer is methyl methacrylate, the oxidant is potassium persulfate, and the reductant is sodium bisulfite, and the polymerization temperature is in the range of 40-70° C., pH is in the range of 4.5-6.5, the polymerization duration that is in the range of 1-5 hours, the concentration of the unsaturated monomer is in the range of 10-60% based on the weight of the biobased material, the molar ratio of reductant to oxidant is in the range of 0.01:1 to 1:10, the oxidant concentration is in the range of 0.005-0.020 mol/L, the % Monomer Conversion is at least 75%, the % Grafting Efficiency is in the range of 50-80%, and the % Grafting is in the range of 20-50%.

26. The process of claim 23, wherein the biobased material is selected from the group consisting of feathers, portions thereof, and previously chemically-modified versions of the foregoing, and
wherein the acylating agent is acetic anhydride, the amount of acylation catalyst is in the range from 7-10% by weight of the biobased material, the acylation temperature is in the range of from 60-70° C., the acylation duration is in the range from 30-60 minutes, the weight ratio of acylating agent to biobased material that is in the range of 3:1 to 4:1, the % Acyl Content is in the range of 3-8%, and the % Weight Gain of the acylated biobased material is in the range of 4-10%, and
wherein the etherifying agent is acrylonitrile, the amount of etherification catalyst is in the range of 10-20% by weight of the biobased material, the etherification temperature is in the range of 30-50° C., the etherification duration is in the range of 30-40 minutes, the weight ratio of etherifying agent to biobased material is in the range of 6:1 to 8:1, and the % Weight Gain of the etherified biobased material is in the range of 2-4%, and
wherein the monomer is methyl methacrylate, the oxidant is potassium persulfate, and the reductant is sodium bisulfite, polymerization temperature is in the range of 50-70° C., the pH is in the range of 5.0-5.5, the polymerization duration is in the range of 2-4 hours, the concentration of the unsaturated monomer is in the range of 30-60% based on the weight of the biobased material, the molar ratio of reductant to oxidant is in the range of 0.1:1.5 to 1.5:5.0, the oxidant concentration is in the range of 0.005-0.015 mol/L, the % Monomer Conversion is at least 85%, the % Grafting Efficiency is in the range of 50-80%, and the % Grafting is in the range of 25-35%.

27. The process of claim 23, wherein the biobased material is selected from the group consisting of dried distillers grains, constituents thereof, and previously chemically-modified versions of the foregoing, and
wherein the acylating agent is acetic anhydride, the amount of the acylation catalyst is in the range of 2-10% by weight of the biobased material, the acylation temperature is in the range of 80-120° C., the acylation duration is in the range of 10-60 minutes, the weight ratio of acylating agent to biobased material is in the range of 1:1 to 5:1, the % Acyl Content that is in the range of 10-50% and a % Weight Gain of the acylated biobased material ss in the range of 10-60%, and
wherein the etherifying agent is acrylonitrile, the amount of the etherification catalyst is in the range of 5-20% by weight of the biobased material, the etherification temperature is in the range of 10-50° C., the etherification duration is in the range of 20-80 minutes, the weight ratio of etherifying agent to biobased material is in the range of 4:1 to 8:1, and % Weight Gain of the etherified biobased material is in the range of 10-45%, and
wherein the monomer is methyl methacrylate, the oxidant is potassium persulfate, and the reductant is sodium bisulfite, and wherein the polymerization temperature that is in the range of 50-90° C., the pH is in the range of 4.0-7.0, the polymerization duration is in the range of 0.5-8 hours, the concentration of the unsaturated monomer is in the range of 10-75% based on the weight of the biobased material, the molar ratio of reductant to oxidant is in the range of 0.1:1 to 1:5, the oxidant concentration is in the range of 0.005-0.015 mol/L, the % Monomer Conversion is at least 80%, the % Grafting Efficiency is in the range of 50-90%, and the % Grafting is in the range of 20-40%.

28. The process of claim 23, wherein the biobased material is selected from the group consisting of dried distillers grains, constituents thereof, and previously chemically-modified versions of the foregoing, and
wherein the acylating agent is acetic anhydride, the amount of acylation catalyst is in the range of 3-7% by weight of the biobased material, the acylation temperature is in the range of 90-110° C., the acylation duration is in the range of 10-30 minutes, the weight ratio of acylating agent to biobased material is in the range of 1:1 to 2:1, the % Acyl Content is in the range of 20-40%, and the % Weight Gain of the acylated biobased material is in the range of 20-50%, and
wherein the etherifying agent is acrylonitrile, the amount of etherification catalyst is in the range of 10-20% by weight of the biobased material, the etherification temperature is in the range of 30-50° C., the etherification duration is in the range of 100-120 minutes, the weight ratio of etherifying agent to biobased material is in the range of 3:1 to 5:1, and the % Weight Gain of the etherified biobased material is in the range of 25-45%, and
wherein the monomer is methyl methacrylate, the oxidant is potassium persulfate, and the reductant is sodium bisulfite, and wherein the polymerization temperature that is in the range of 40-90° C., the pH is in the range of 4.5-6.5, the polymerization duration is in the range of 0.5-12 hours, the concentration of the unsaturated monomer is in the range of 20-70% based on the weight of the biobased material, the molar ratio of reductant to oxidant is in the range of 0.1:1.5 to 1.5:4.0, the oxidant concentration is in the range of 0.005-0.1 mol/L, the % Monomer Conversion is at least 90%, the % Grafting Efficiency is in the range of 50-90%, and the % Grafting is in the range of 40-80%.
